(19) United States
(12) Patent Application Publication
(10) Pub. No.: US 2025/0189766 A1
(43) Pub. Date: Jun. 12, 2025

(54) IMAGING LENS AND IMAGING APPARATUS

(71) Applicant: FUJIFILM Corporation, Tokyo (JP)

(72) Inventor: Masato KONDO, Saitama (JP)

(73) Assignee: FUJIFILM Corporation, Tokyo (JP)

(21) Appl. No.: 18/960,755

(22) Filed: Nov. 26, 2024

(30) Foreign Application Priority Data
Dec. 11, 2023 (JP) 2023-208702

(51) Int. Cl. G02B 13/00

(52) U.S. Cl. CPC G02B 13/0045; G02B 13/006

(57) ABSTRACT

An imaging lens consists of, in order from an object side to an image side, a front group, an aperture stop, and a rear group. The rear group includes one or two focus lens groups that move along an optical axis during focusing. A distance on the optical axis from a lens surface of the front group closest to the object side to an image plane is invariant during the focusing. The imaging lens satisfies a predetermined conditional expression.

### CROSS-REFERENCE TO RELATED APPLICATIONS

This application claims priority from Japanese Patent Application No. 2023-208702, filed on Dec. 11, 2023, the entire disclosure of which is incorporated herein by reference.

### BACKGROUND

### Technical Field

The disclosed technology relates to an imaging lens and an imaging apparatus.

### Related Art

In the related art, an imaging optical system according to WO2017/168603A has been known as an imaging lens usable in an imaging apparatus such as a digital camera.

### SUMMARY

There has been a demand for an imaging lens that is configured to be reduced in size with a small F-number and a wide angle and that maintains favorable optical performance. A level of such a demand is increasing every year.

The present disclosure provides an imaging lens that is configured to be reduced in size with a small F-number and a wide angle and that maintains favorable optical performance, and an imaging apparatus comprising the imaging lens.

According to a first aspect of the present disclosure, there is provided an imaging lens consisting of, in order from an object side to an image side, a front group, an aperture stop, and a rear group, in which the rear group includes one or two focus lens groups that move along an optical axis during focusing, a distance on the optical axis from a lens surface of the front group closest to the object side to an image plane is invariant during the focusing, and Conditional Expressions (1), (2), and (3) are satisfied, which are represented by

$$2.3 < TL / ( f \times tan ω m ) < 7 \qquad ( 1 )$$

$$1.15 < Fno / tan ω m < 3.5 \qquad ( 2 )$$

$$0.3 < Bf / ( f \times tan ω m ) < 1.5 . \qquad ( 3 )$$

A sum of a back focus of an entire system as an air conversion distance and a distance on the optical axis from the lens surface of the front group closest to the object side to a lens surface of the rear group closest to the image side in a state where an infinite distance object is in focus is denoted by TL. A focal length of the entire system in the state where the infinite distance object is in focus is denoted by f. A maximum half angle of view in the state where the infinite distance object is in focus is denoted by ωm. An open F-number in the state where the infinite distance object is in focus is denoted by Fno. The back focus of the entire system as the air conversion distance in the state where the infinite distance object is in focus is denoted by Bf.

According to a second aspect of the present disclosure, in the imaging lens of the first aspect, in a case where a distance on the optical axis from the lens surface of the front group closest to the object side to the aperture stop in the state where the infinite distance object is in focus is denoted by dFSt, Conditional Expression (4) is satisfied, which is represented by

$$0.43 < dFSt / TL < 0.75 . \qquad ( 4 )$$

According to a third aspect of the present disclosure, in the imaging lens of the first aspect, in a case where a focal length of the front group in the state where the infinite distance object is in focus is denoted by fF, and a focal length of the rear group in the state where the infinite distance object is in focus is denoted by fR, Conditional Expression (5) is satisfied, which is represented by

$$- 2 < fR / fF < 4. \qquad ( 5 )$$

According to a fourth aspect of the present disclosure, in the imaging lens of the first aspect, in a case where a focal length of the front group in the state where the infinite distance object is in focus is denoted by fF, Conditional Expression (6) is satisfied, which is represented by

$$- 1 < f / fF < 2. \qquad ( 6 )$$

According to a fifth aspect of the present disclosure, in the imaging lens of the first aspect, Conditional Expression (7) is satisfied, which is represented by

$$6 < ( TL \times Fno ) / ( f \times tan ω m ) < 11. \qquad ( 7 )$$

According to a sixth aspect of the present disclosure, in the imaging lens of the first aspect, the front group includes one focus lens group that moves along the optical axis during the focusing.

According to a seventh aspect of the present disclosure, in the imaging lens of the first aspect, the rear group includes two focus lens groups that move by changing a mutual spacing during the focusing.

According to an eighth aspect of the present disclosure, in the imaging lens of the first aspect, at least one lens that has a convex surface facing the object side in a paraxial region and that has, on a lens surface on the object side, an inflection point at which a convex or concave shape changes in a middle of the lens surface from a position on the optical axis to an edge part is disposed in the rear group.

According to a ninth aspect of the present disclosure, in the imaging lens of the first aspect, at least one lens that has a concave surface facing the object side in a paraxial region and that has, on a lens surface on the object side, an inflection point at which a convex or concave shape changes in a middle of the lens surface from a position on the optical axis to an edge part is disposed in the rear group.

According to a tenth aspect of the present disclosure, in the imaging lens of the first aspect, at least one lens that has a convex surface facing the image side in a paraxial region and that has, on a lens surface on the image side, an inflection point at which a convex or concave shape changes in a middle of the lens surface from a position on the optical axis to an edge part is disposed in the rear group.

According to an eleventh aspect of the present disclosure, in the imaging lens of the first aspect, at least one lens that has a concave surface facing the image side in a paraxial region and that has, on a lens surface on the image side, an inflection point at which a convex or concave shape changes in a middle of the lens surface from a position on the optical axis to an edge part is disposed in the rear group.

According to a twelfth aspect of the present disclosure, in the imaging lens of the first aspect, the imaging lens includes a three-piece cemented lens in which a first positive lens, a second positive lens, and a negative lens are cemented in this order.

According to a thirteenth aspect of the present disclosure, in the imaging lens of the twelfth aspect, a surface of the second positive lens on a side closer to the first positive lens has a concave surface facing the side closer to the first positive lens.

According to a fourteenth aspect of the present disclosure, in the imaging lens of the first aspect, Conditional Expression (1-1) is satisfied, which is represented by

$$3.5 < TL / ( f \times tan ω m ) < 5.6 . \qquad ( 1 - 1 )$$

According to a fifteenth aspect of the present disclosure, in the imaging lens of the first aspect, Conditional Expression (2-1) is satisfied, which is represented by

$$1.3 < Fno / tan ω m < 2.7 . \qquad ( 2 - 1 )$$

According to a sixteenth aspect of the present disclosure, in the imaging lens of the fifteenth aspect, Conditional Expression (1-1) is satisfied, which is represented by

$$3.5 < TL / ( f \times tan ω m ) < 5.6 . \qquad ( 1 - 1 )$$

According to a seventeenth aspect of the present disclosure, in the imaging lens of the sixteenth aspect, Conditional Expression (7) is satisfied, which is represented by

$$6 < ( TL \times Fno ) / ( f \times tan ω m ) < 11. \qquad ( 7 )$$

According to an eighteenth aspect of the present disclosure, in the imaging lens of the seventeenth aspect, the imaging lens includes a three-piece cemented lens in which a first positive lens, a second positive lens, and a negative lens are cemented in this order.

According to a nineteenth aspect of the present disclosure, in the imaging lens of the eighteenth aspect, a surface of the second positive lens on a side closer to the first positive lens has a concave surface facing the side closer to the first positive lens.

According to a twentieth aspect of the present disclosure, in the imaging lens of the seventeenth aspect, the front group includes one focus lens group that moves along the optical axis during the focusing.

According to a twenty-first aspect of the present disclosure, in the imaging lens of the twentieth aspect, at least one lens that has a convex surface facing the object side in a paraxial region and that has, on a lens surface on the object side, an inflection point at which a convex or concave shape changes in a middle of the lens surface from a position on the optical axis to an edge part is disposed in the rear group.

According to a twenty-second aspect of the present disclosure, in the imaging lens of the seventeenth aspect, the rear group includes two focus lens groups that move by changing a mutual spacing during the focusing.

According to a twenty-third aspect of the present disclosure, in the imaging lens of the twenty-second aspect, at least one lens that has a convex surface facing the object side in a paraxial region and that has, on a lens surface on the object side, an inflection point at which a convex or concave shape changes in a middle of the lens surface from a position on the optical axis to an edge part is disposed in the rear group.

According to a twenty-fourth aspect of the present disclosure, in the imaging lens of the seventeenth aspect, at least one lens that has a concave surface facing the object side in a paraxial region and that has, on a lens surface on the object side, an inflection point at which a convex or concave shape changes in a middle of the lens surface from a position on the optical axis to an edge part is disposed in the rear group.

According to a twenty-fifth aspect of the present disclosure, in the imaging lens of the seventeenth aspect, Conditional Expression (1-2) is satisfied, which is represented by

$$4.4 < TL / ( f \times tan ω m ) < 5.2 . \qquad ( 1 - 2 )$$

According to a twenty-sixth aspect of the present disclosure, in the imaging lens of the twenty-fifth aspect, Conditional Expression (7-1) is satisfied, which is represented by

$$6.3 < ( TL \times Fno ) / ( f \times tan ω m ) < 9.5 . \qquad ( 7 - 1 )$$

According to a twenty-seventh aspect of the present disclosure, in the imaging lens of the twenty-sixth aspect, at least one lens that has a convex surface facing the image side in a paraxial region and that has, on a lens surface on the image side, an inflection point at which a convex or concave shape changes in a middle of the lens surface from a position on the optical axis to an edge part is disposed in the rear group.

According to a twenty-eighth aspect of the present disclosure, in the imaging lens of the seventeenth aspect, at least one lens that has a concave surface facing the image side in a paraxial region and that has, on a lens surface on the image side, an inflection point at which a convex or concave shape changes in a middle of the lens surface from a position on the optical axis to an edge part is disposed in the rear group.

According to a twenty-ninth aspect of the present disclosure, in the imaging lens of the first aspect, the rear group includes at least one aspherical lens, and in a case where an aspherical lens closest to the image side among aspherical lenses included in the rear group is referred to as a most image side aspherical lens, Conditional Expression (8) is satisfied, which is represented by

$$0.2 < \vert ( 1 / Rcf - 1 / Rcr ) / ( 1 / Ryf - 1 / Ryr ) \vert < 4. \qquad ( 8 )$$

A paraxial curvature radius of a surface, on the object side, of the most image side aspherical lens is denoted by Rcf.

A curvature radius, at a position of a maximum effective diameter, of the surface, on the object side, of the most image side aspherical lens is denoted by Ryf. A paraxial curvature radius of a surface, on the image side, of the most image side aspherical lens is denoted by Rcr. A curvature radius, at a position of a maximum effective diameter, of the surface, on the image side, of the most image side aspherical lens is denoted by Ryr.

According to a thirtieth aspect of the present disclosure, in the imaging lens of the first aspect, the number of focus lens groups included in the imaging lens is two, and Conditional Expression (9) is satisfied, which is represented by

$$0.2 < \vert ff 1 / ff 2 \vert < 5. \qquad ( 9 )$$

A focal length of the focus lens group on the object side out of the two focus lens groups included in the imaging lens is denoted by ff1. A focal length of the focus lens group on the image side out of the two focus lens groups included in the imaging lens is denoted by ff2.

According to a thirty-first aspect of the present disclosure, in the imaging lens of the first aspect, in a case where a combined focal length of all lenses closer to the image side than the focus lens group closest to the image side among the focus lens groups included in the imaging lens is denoted by ffR, Conditional Expression (10) is satisfied, which is represented by

$$- 1.5 < f / ffR < 1.5 . \qquad ( 10 )$$

According to a thirty-second aspect of the present disclosure, there is provided an imaging apparatus comprising the imaging lens according to any one of the first to thirty-first aspects.

In the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the illustrated constituents.

The term “group having a positive refractive power” in the present specification means that the entire group has a positive refractive power. The term “group having a negative refractive power” means that the entire group has a negative refractive power. The term “lens having a positive refractive power” and the term “positive lens” are synonymous with each other. The term “lens having a negative refractive power” and the term “negative lens” are synonymous with each other. The term “group” in the present specification is not limited to a configuration consisting of a plurality of lenses and may be a configuration consisting of only one lens.

The term “entire system” in the present specification means the imaging lens. The term “focal length” used in the conditional expressions is a paraxial focal length. Unless otherwise specified, the term “distance on the optical axis” used in the conditional expressions is a geometrical distance. Unless otherwise specified, values used in the conditional expressions are values based on the d line in the state where the infinite distance object is in focus.

Unless otherwise specified, a curvature radius, a sign of a refractive power, and a surface shape related to a lens including an aspherical surface in a paraxial region are used. For a sign of the curvature radius, a sign of the curvature radius of a surface having a convex shape facing the object side is positive, and a sign of the curvature radius of a surface having a convex shape facing the image side is negative.

The terms “d line”, “C line”, and “F line” according to the present specification are bright lines. A wavelength of the d line is 587.56 nanometers (nm). A wavelength of the C line is 656.27 nanometers (nm). A wavelength of the F line is 486.13 nanometers (nm).

According to the present disclosure, an imaging lens that is configured to be reduced in size with a small F-number and a wide angle and that maintains favorable optical performance, and an imaging apparatus comprising the imaging lens can be provided.

### BRIEF DESCRIPTION OF THE DRAWINGS

FIG. 1 is a cross-sectional view that illustrates a configuration of an imaging lens according to one embodiment and that corresponds to an imaging lens of Example 1.

FIG. 2 is a cross-sectional view illustrating a configuration and luminous fluxes in each state of the imaging lens in FIG. 1.

FIG. 3 is a diagram for describing symbols of conditional expressions.

FIG. 4 is a diagram for describing a position of a maximum effective diameter.

FIG. 5 is each aberration diagram of the imaging lens of Example 1.

FIG. 6 is a cross-sectional view illustrating a configuration of an imaging lens of Example 2.

FIG. 7 is each aberration diagram of the imaging lens of Example 2.

FIG. 8 is a cross-sectional view illustrating a configuration of an imaging lens of Example 3.

FIG. 9 is each aberration diagram of the imaging lens of Example 3.

FIG. 10 is a cross-sectional view illustrating a configuration of an imaging lens of Example 4.

FIG. 11 is each aberration diagram of the imaging lens of Example 4.

FIG. 12 is a cross-sectional view illustrating a configuration of an imaging lens of Example 5.

FIG. 13 is each aberration diagram of the imaging lens of Example 5.

FIG. 14 is a cross-sectional view illustrating a configuration of an imaging lens of Example 6.

FIG. 15 is each aberration diagram of the imaging lens of Example 6.

FIG. 16 is a cross-sectional view illustrating a configuration of an imaging lens of Example 7.

FIG. 17 is each aberration diagram of the imaging lens of Example 7.

FIG. 18 is a cross-sectional view illustrating a configuration of an imaging lens of Example 8.

FIG. 19 is each aberration diagram of the imaging lens of Example 8.

FIG. 20 is a cross-sectional view illustrating a configuration of an imaging lens of Example 9.

FIG. 21 is each aberration diagram of the imaging lens of Example 9.

FIG. 22 is a cross-sectional view illustrating a configuration of an imaging lens of Example 10.

FIG. 23 is each aberration diagram of the imaging lens of Example 10.

FIG. 24 is a cross-sectional view illustrating a configuration of an imaging lens of Example 11.

FIG. 25 is each aberration diagram of the imaging lens of Example 11.

FIG. 26 is a cross-sectional view illustrating a configuration of an imaging lens of Example 12.

FIG. 27 is each aberration diagram of the imaging lens of Example 12.

FIG. 28 is a cross-sectional view illustrating a configuration of an imaging lens of Example 13.

FIG. 29 is each aberration diagram of the imaging lens of Example 13.

FIG. 30 is a cross-sectional view illustrating a configuration of an imaging lens of Example 14.

FIG. 31 is each aberration diagram of the imaging lens of Example 14.

FIG. 32 is a cross-sectional view illustrating a configuration of an imaging lens of Example 15.

FIG. 33 is each aberration diagram of the imaging lens of Example 15.

FIG. 34 is a cross-sectional view illustrating a configuration of an imaging lens of Example 16.

FIG. 35 is each aberration diagram of the imaging lens of Example 16.

FIG. 36 is a perspective view of a front surface side of an imaging apparatus according to one embodiment.

FIG. 37 is a perspective view of a rear surface side of the imaging apparatus according to one embodiment.

### DESCRIPTION OF EMBODIMENTS

Hereinafter, an embodiment of the present disclosure will be described with reference to the drawings.

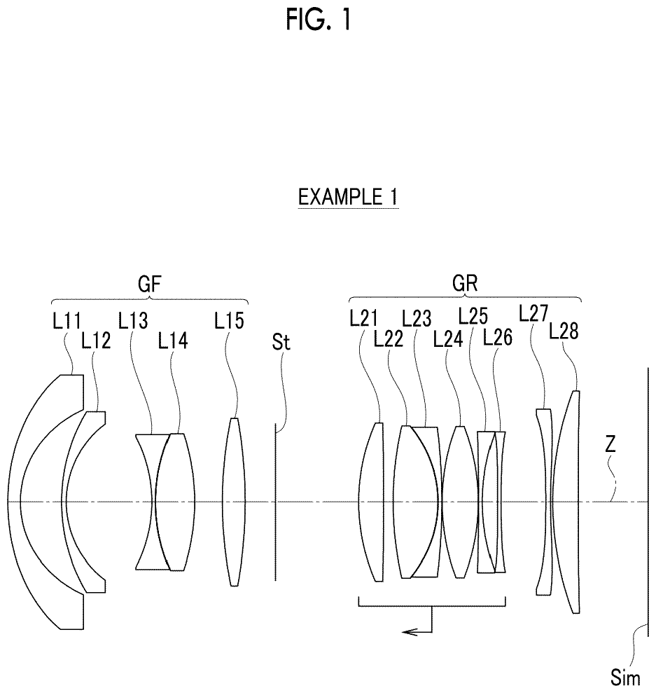

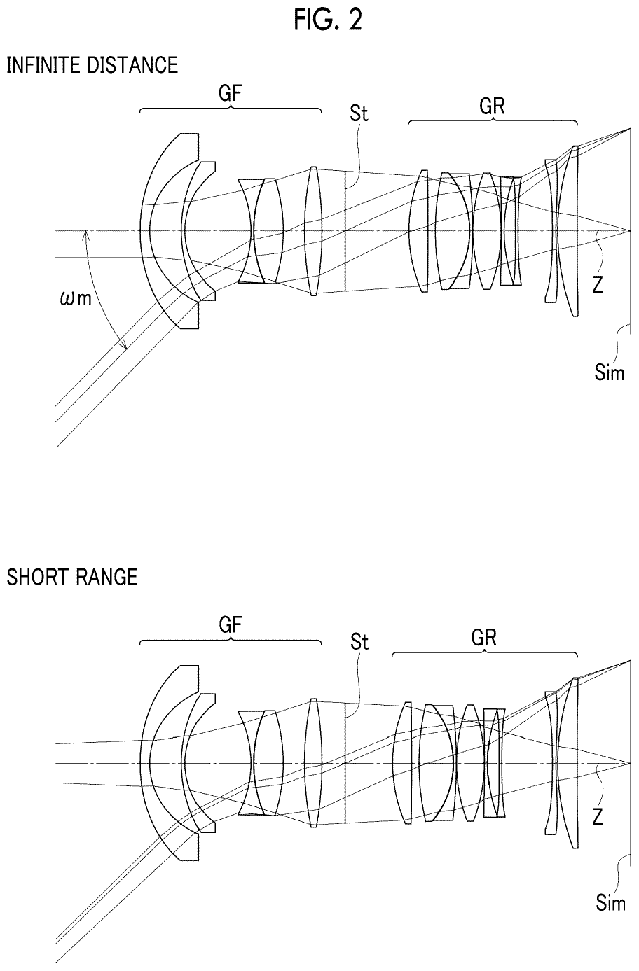

FIG. 1 illustrates a cross-sectional view of a configuration of an imaging lens according to one embodiment of the present disclosure. FIG. 2 is a cross-sectional view of a configuration and luminous fluxes of the imaging lens in FIG. 1. In FIG. 2, a state where an infinite distance object is in focus is illustrated in an upper part labeled “INFINITE DISTANCE”, and a state where a short range object is in focus is illustrated in a lower part labeled “SHORT RANGE”. The state in the lower part of FIG. 2 is a state where an absolute value of an imaging magnification is 0.16 times the original imaging magnification. In FIG. 2, an on-axis luminous flux and a luminous flux at a maximum half angle of view ωm in the state where the infinite distance object is in focus, and an on-axis luminous flux and a luminous flux at the maximum half angle of view in the state where the short range object is in focus are illustrated as the luminous fluxes. In FIGS. 1 and 2, a left side is an object side, and a right side is an image side. The examples illustrated in FIGS. 1 and 2 correspond to an imaging lens of Example 1 described later. Hereinafter, description will be mainly provided with reference to FIG. 1.

The imaging lens of the present disclosure consists of, along an optical axis Z, in order from the object side to the image side, the front group GF, the aperture stop St, and the rear group GR. Each of the front group GF and the rear group GR includes one or more lenses.

For example, each group of the imaging lens in FIG. 1 is configured as follows. The front group GF consists of five lenses including lenses L11 to L15 in order from the object side to the image side. The rear group GR consists of eight lenses including lenses L21 to L28 in order from the object side to the image side. The aperture stop St in FIG. 1 does not indicate a size or a shape and indicates a position in an optical axis direction. This illustration method of the aperture stop St also applies to other cross-sectional views.

A negative meniscus lens having a convex surface facing the object side may be configured to be disposed closest to the object side in the front group GF. Doing so achieves an advantage in achieving a wide angle.

A positive lens may be configured to be disposed closest to the image side in the front group GF. Doing so achieves an advantage in correcting a spherical aberration. In this case, the positive lens closest to the image side in the front group GF may be configured to have a biconvex shape. Doing so achieves a further advantage in correcting the spherical aberration.

The imaging lens of the present disclosure has a focusing function. However, in the imaging lens of the present disclosure, a distance on the optical axis from a lens surface of the front group GF closest to the object side to an image plane Sim is invariant during focusing. According to this configuration, fluctuation in a centroid during the focusing can be suppressed. Thus, convenience of use during imaging can be increased.

Hereinafter, a lens group that moves along the optical axis Z during the focusing will be referred to as a focus lens group. The rear group GR of the present disclosure includes one or two focus lens groups that move along the optical axis Z during the focusing. By moving a lens group of the rear group GR during the focusing, fluctuation in an angle of view during the focusing can be suppressed.

For example, the rear group GR of the imaging lens in the example in FIG. 1 includes one focus lens group. The focus lens group of the example in FIG. 1 consists of the lenses L21 to L26. A bracket under the imaging lens in FIG. 1 indicates the focus lens group, and an arrow provided to the bracket indicates a moving direction during the focusing from the infinite distance object to the short range object.

The example illustrated in FIG. 1 is merely an example, and various modifications can be made to the imaging lens of the present disclosure without departing from the gist of the disclosed technology.

For example, the front group GF may be configured to include one focus lens group that moves along the optical axis Z during the focusing. Doing so facilitates suppression of fluctuation in a field curvature and fluctuation in the spherical aberration during the focusing.

The rear group GR may be configured to include two focus lens groups that move by changing a mutual spacing during the focusing. By moving the two focus lens groups by different moving amounts, fluctuation in aberrations caused by fluctuation in an imaging distance can be favorably suppressed. In addition, disposing the two focus lens groups in the rear group GR facilitates suppression of fluctuation in the angle of view during the focusing.

The rear group GR may be configured to include an aspherical lens. For example, at least one aspherical lens that has a concave surface facing the image side in a paraxial region and that has, on a lens surface on the image side, an inflection point at which a convex or concave shape changes in the middle of the lens surface from a position on the optical axis to an edge part may be configured to be disposed in the rear group GR. The expression “has a concave surface facing the image side in the paraxial region” means that the lens surface on the image side has a concave shape in the paraxial region. The inflection point is a point at which a surface shape changes from a convex shape to a concave shape or from a concave shape to a convex shape, that is, a point at which a sign of a curvature radius changes. Causing the lens surface to have the inflection point enables a refractive power in the edge part of the lens to be determined independently of a refractive power in the paraxial region. Causing the rear group GR to include an aspherical surface having the above shape can reduce an incidence angle of a ray emitted from the imaging lens on the image plane Sim. In a case where an imaging element is disposed on the image plane Sim in an imaging apparatus, the incidence angle on the imaging element can be reduced. For example, in the example in FIG. 1, the lens L27 corresponds to the aspherical lens.

In a case where the rear group GR includes an aspherical lens, a shape of the aspherical lens is not limited to the above example. For example, at least one lens that has a convex surface facing the image side in the paraxial region and that has, on a lens surface on the image side, the inflection point at which the convex or concave shape changes in the middle of the lens surface from the position on the optical axis to the edge part may be configured to be disposed in the rear group GR. The expression “has a convex surface facing the image side in the paraxial region” means that the lens surface on the image side has a convex shape in the paraxial region. This configuration achieves an advantage in favorably correcting the field curvature and a distortion while suppressing an increase in a total optical length.

At least one lens that has a concave surface facing the object side in the paraxial region and that has, on a lens surface on the object side, the inflection point at which the convex or concave shape changes in the middle of the lens surface from the position on the optical axis to the edge part may be configured to be disposed in the rear group GR. The expression “has a concave surface facing the object side in the paraxial region” means that the lens surface on the object side has a concave shape in the paraxial region. This configuration achieves an advantage in favorably correcting the field curvature and the distortion while securing a back focus.

At least one lens that has a convex surface facing the object side in the paraxial region and that has, on a lens surface on the object side, the inflection point at which the convex or concave shape changes in the middle of the lens surface from the position on the optical axis to the edge part may be configured to be disposed in the rear group GR. The expression “has a convex surface facing the object side in the paraxial region” means that the lens surface on the object side has a convex shape in the paraxial region. This configuration achieves an advantage in correcting an astigmatism without deterioration in the spherical aberration.

At least one of the aspherical lenses included in the imaging lens may be a compound aspherical lens in which a resin of which a surface in contact with air has an aspherical shape is formed on a spherical surface of a lens made of glass. Doing so enables the aspherical surface to be attached to the lens surface while suppressing a manufacturing cost and thus, can establish both of reduction in cost and favorable correction of various aberrations. In the present specification, a compound aspherical lens is not regarded as a cemented lens and is regarded as one non-cemented lens, that is, a single lens.

The imaging lens preferably includes a cemented lens. While the cemented lens included in the imaging lens in FIG. 1 is a two-piece cemented lens, the imaging lens of the present disclosure may be configured to include a three-piece cemented lens. The three-piece cemented lens may be a cemented lens in which a first positive lens, a second positive lens, and a negative lens are cemented in this order. In this case, the first positive lens, the second positive lens, and the negative lens may be cemented in order from the object side to the image side, or the first positive lens, the second positive lens, and the negative lens may be cemented in order from the image side to the object side. Using the three-piece cemented lens achieves an advantage in suppressing a lateral chromatic aberration.

In a case where the imaging lens includes a three-piece cemented lens in which the first positive lens, the second positive lens, and the negative lens are cemented in this order, a surface of the second positive lens on a side closer to the first positive lens may be configured to have a concave surface facing the side closer to the first positive lens. Doing so achieves an advantage in suppressing the lateral chromatic aberration.

Hereinafter, preferable configurations of the imaging lens of the present disclosure related to conditional expressions will be described. In the following description of conditional expressions, in order to avoid redundancy, the same symbol will be used for the same definition to omit duplicate descriptions of the symbol. Hereinafter, the “imaging lens of the present disclosure” will be simply referred to as the “imaging lens” in order to avoid redundancy.

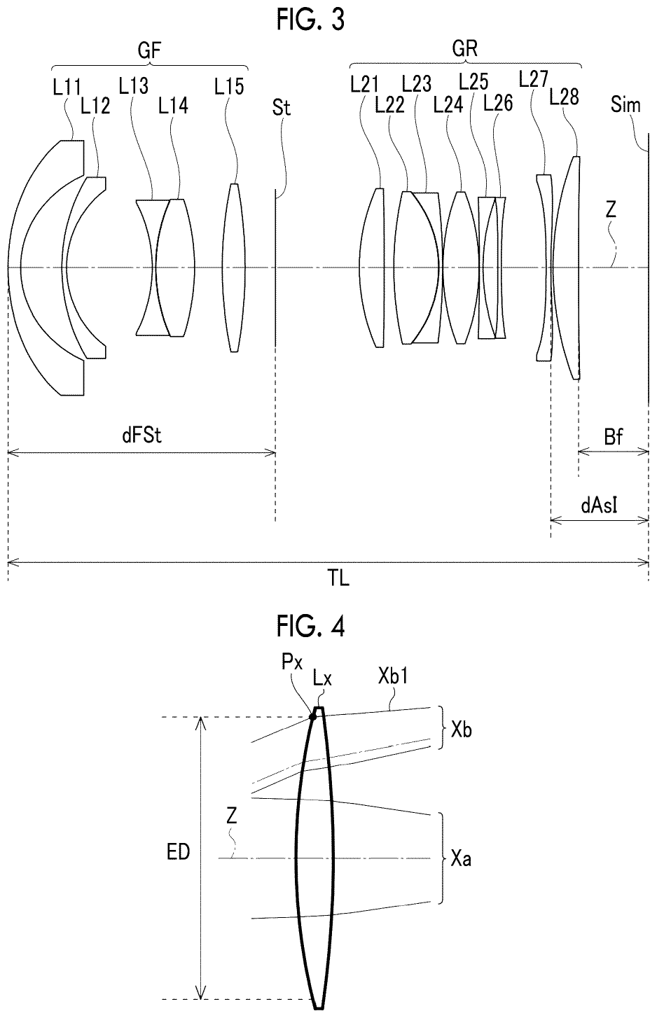

The imaging lens preferably satisfies Conditional Expression (1). A sum of the back focus of the entire system as an air conversion distance and a distance on the optical axis from a lens surface of the front group GF closest to the object side to a lens surface of the rear group GR closest to the image side in the state where the infinite distance object is in focus is denoted by TL. A focal length of the entire system in the state where the infinite distance object is in focus is denoted by f. Here, tan denotes a tangent. A maximum half angle of view in the state where the infinite distance object is in focus is denoted by ωm. TL denotes the total length in the state where the infinite distance object is in focus. For example, the total length TL is illustrated in FIG. 3, and the maximum half angle of view ωm is illustrated in FIG. 2. FIG. 3 is a diagram illustrating the symbols and the like used in the conditional expressions on the cross-sectional view of the imaging lens in FIG. 1. Ensuring that a corresponding value of Conditional Expression (1) is not less than or equal to its lower limit value achieves an advantage in maintaining favorable optical performance. Ensuring that the corresponding value of Conditional Expression (1) is not greater than or equal to its upper limit value achieves an advantage in reducing a lens system in size.

$$2.3 < TL / ( f \times tan ω m ) < 7 \qquad ( 1 )$$

In order to obtain more favorable characteristics, the lower limit value of Conditional Expression (1) is more preferably 2.7, further preferably 3.1, further preferably 3.5, further preferably 3.9, and further preferably 4.4. In order to obtain more favorable characteristics, the upper limit value of Conditional Expression (1) is more preferably 6.5, further preferably 6, further preferably 5.6, further preferably 5.3, and further preferably 5.2. For example, the imaging lens more preferably satisfies Conditional Expression (1-1) and further preferably satisfies Conditional Expression (1-2).

$$3.5 < TL / ( f \times tan ω m ) < 5.6 \qquad ( 1 - 1 )$$

$$4.4 < TL / ( f \times tan ω m ) < 5.2 \qquad ( 1 - 2 )$$

In a case where an open F-number in the state where the infinite distance object is in focus is denoted by Fno, the imaging lens preferably satisfies Conditional Expression (2). Ensuring that a corresponding value of Conditional Expression (2) is not less than or equal to its lower limit achieves an advantage in suppressing an increase in the number of lenses and suppressing an increase in a size of the lens system while obtaining favorable optical performance. Ensuring that the corresponding value of Conditional Expression (2) is not greater than or equal to its upper limit value facilitates reduction of the open F-number while increasing the angle of view.

$$1.15 < Fno / tan ω m < 3.5 \qquad ( 2 )$$

In order to obtain more favorable characteristics, the lower limit value of Conditional Expression (2) is more preferably 1.2, further preferably 1.25, further preferably 1.3, further preferably 1.35, and further preferably 1.5. In order to obtain more favorable characteristics, the upper limit value of Conditional Expression (2) is more preferably 3.2, further preferably 2.9, further preferably 2.7, further preferably 2.5, and further preferably 2.3. For example, the imaging lens more preferably satisfies Conditional Expression (2-1).

$$1.3 < Fno / tan ω m < 2.7 \qquad ( 2 - 1 )$$

The imaging lens preferably satisfies Conditional Expression (3). The back focus of the entire system as the air conversion distance in the state where the infinite distance object is in focus is denoted by Bf. The back focus Bf of the entire system as the air conversion distance is an air conversion distance on the optical axis from a lens surface of the imaging lens closest to the image side to the image plane Sim. For example, the back focus Bf is illustrated in FIG. 3. Ensuring that a corresponding value of Conditional Expression (3) is not less than or equal to its lower limit value can suppress an increase in a diameter of a lens closest to the image side in the imaging lens. Ensuring that the corresponding value of Conditional Expression (3) is not greater than or equal to its upper limit value can suppress an increase in the total optical length.

$$0.3 < Bf / ( f \times tan ω m ) < 1.5 \qquad ( 3 )$$

In order to obtain more favorable characteristics, the lower limit value of Conditional Expression (3) is more preferably 0.35, further preferably 0.4, further preferably 0.43, and further preferably 0.45. In order to obtain more favorable characteristics, the upper limit value of Conditional Expression (3) is more preferably 1.3, further preferably 1.2, further preferably 1.1, and further preferably 1.

The imaging lens preferably satisfies Conditional Expression (4). A distance on the optical axis from the lens surface of the front group GF closest to the object side to the aperture stop St in the state where the infinite distance object is in focus is denoted by dFSt. For example, the distance dFSt is illustrated in FIG. 3. Ensuring that a corresponding value of Conditional Expression (4) is not less than or equal to its lower limit value can secure a sufficient space on the object side with respect to the aperture stop St. Thus, by disposing an appropriate number of lenses, the imaging lens can be configured without unnecessarily reducing an absolute value of a curvature radius of the lens. This facilitates suitable correction of various aberrations. Ensuring that the corresponding value of Conditional Expression (4) is not greater than or equal to its upper limit value can prevent a position of the aperture stop St from being excessively close to the image plane Sim and thus, can prevent an excessively large incidence angle of an off-axis principal ray incident on the imaging element disposed on the image plane Sim in the imaging apparatus.

$$0.43 < dFSt / TL < 0.75 \qquad ( 4 )$$

In order to obtain more favorable characteristics, the lower limit value of Conditional Expression (4) is more preferably 0.45, further preferably 0.47, further preferably 0.49, further preferably 0.51, further preferably 0.53, and further preferably 0.55. In order to obtain more favorable characteristics, the upper limit value of Conditional Expression (4) is more preferably 0.71, further preferably 0.69, further preferably 0.67, further preferably 0.65, further preferably 0.63, and further preferably 0.61.

The imaging lens preferably satisfies Conditional Expression (5). A focal length of the front group GF in the state where the infinite distance object is in focus is denoted by fF. A focal length of the rear group GR in the state where the infinite distance object is in focus is denoted by fR. Conditional Expression (5) is a conditional expression for appropriately setting a ratio between a refractive power of the front group GF and a refractive power of the rear group GR. The front group GF can act as a wide converter that ensures a sufficient back focus while increasing the angle of view in the entire system. Ensuring that a corresponding value of Conditional Expression (5) is not less than or equal to its lower limit value can suppress various aberrations such as the spherical aberration. Ensuring that the corresponding value of Conditional Expression (5) is not greater than or equal to its upper limit value achieves an advantage in achieving a wide angle of view.

$$- 2 < fR / fF < 4 \qquad ( 5 )$$

In order to obtain more favorable characteristics, the lower limit value of Conditional Expression (5) is more preferably −1.5, further preferably −1, and further preferably −0.7. In order to obtain more favorable characteristics, the upper limit value of Conditional Expression (5) is more preferably 3.5, further preferably 3, and further preferably 2.5.

The imaging lens preferably satisfies Conditional Expression (6). Ensuring that a corresponding value of Conditional Expression (6) is not less than or equal to its lower limit value can prevent an excessively strong negative refractive power of the front group GF and thus, achieves an advantage in reducing the total optical length. Ensuring that the corresponding value of Conditional Expression (6) is not greater than or equal to its upper limit value prevents an excessively strong positive refractive power of the front group GF and thus, achieves an advantage in correcting the distortion and the field curvature.

$$- 1 < f / fF < 2 \qquad ( 6 )$$

In order to obtain more favorable characteristics, the lower limit value of Conditional Expression (6) is more preferably −0.8, further preferably −0.6, and further preferably −0.4. In order to obtain more favorable characteristics, the upper limit value of Conditional Expression (6) is more preferably 1.3, further preferably 0.7, and further preferably 0.18.

The imaging lens preferably satisfies Conditional Expression (7). Ensuring that a corresponding value of Conditional Expression (7) is not less than or equal to its lower limit value achieves an advantage in maintaining favorable optical performance. Ensuring that the corresponding value of Conditional Expression (7) is not greater than or equal to its upper limit value achieves an advantage in reducing the lens system in size.

$$6 < ( TL \times Fno ) / ( f \times tan ω m ) < 11 \qquad ( 7 )$$

In order to obtain more favorable characteristics, the lower limit value of Conditional Expression (7) is more preferably 6.1, further preferably 6.2, further preferably 6.3, and further preferably 6.4. In order to obtain more favorable characteristics, the upper limit value of Conditional Expression (7) is more preferably 10.5, further preferably 10, further preferably 9.5, and further preferably 9. For example, the imaging lens more preferably satisfies Conditional Expression (7-1).

$$6.3 < ( TL \times Fno ) / ( f \times tan ω m ) < 9.5 \qquad ( 7 - 1 )$$

In a configuration in which the rear group GR includes at least one aspherical lens, the imaging lens preferably satisfies Conditional Expression (8). An aspherical lens closest to the image side among aspherical lenses included in the rear group GR is referred to as a most image side aspherical lens. A paraxial curvature radius of a surface, on the object side, of the most image side aspherical lens is denoted by Rcf. A curvature radius, at a position of a maximum effective diameter, of the surface, on the object side, of the most image side aspherical lens is denoted by Ryf. A paraxial curvature radius of a surface, on the image side, of the most image side aspherical lens is denoted by Rcr. A curvature radius, at a position of a maximum effective diameter, of the surface, on the image side, of the most image side aspherical lens is denoted by Ryr. Ensuring that a corresponding value of Conditional Expression (8) is not less than or equal to its lower limit value prevents an excessively strong refractive power on an edge part side of the lens and thus, achieves an advantage in correcting the field curvature and the distortion. Ensuring that the corresponding value of Conditional Expression (8) is not greater than or equal to its upper limit value prevents an excessively weak refractive power on the edge part side of the lens and thus, achieves an advantage in suppressing the astigmatism.

$$0.2 < \vert ( 1 / Rcf - 1 / Rcr ) / ( 1 / Ryf - 1 / Ryr ) \vert < 4 \qquad ( 8 )$$

In order to obtain more favorable characteristics, the lower limit value of Conditional Expression (8) is more preferably 0.25, further preferably 0.3, further preferably 0.35, and further preferably 0.4. In order to obtain more favorable characteristics, the upper limit value of Conditional Expression (8) is more preferably 3, further preferably 2, further preferably 1.4, and further preferably 0.9.

The “position of the maximum effective diameter” in the present specification will be described with reference to FIG. 4. FIG. 4 is a diagram for description. In FIG. 4, a left side is the object side, and a right side is the image side. FIG. 4 illustrates an on-axis luminous flux Xa and an off-axis luminous flux Xb passing through a lens Lx. In the example in FIG. 4, a ray Xb1 that is a ray on an upper side of the off-axis luminous flux Xb is a ray passing through an outermost side. The term “outer side” means an outer side in a diameter direction centered on the optical axis Z, that is, a side away from the optical axis Z. In the present specification, a position of an intersection between the ray passing through the outermost side and a lens surface is a position Px of the maximum effective diameter. Twice a distance from the position Px of the maximum effective diameter to the optical axis Z is an effective diameter ED of a surface of the lens Lx on the object side. While the ray on the upper side of the off-axis luminous flux Xb is the ray passing through the outermost side in the example in FIG. 4, which ray is the ray passing through the outermost side varies depending on the lens system.

In a configuration in which the imaging lens includes two focus lens groups, the imaging lens preferably satisfies Conditional Expression (9). Out of the two focus lens groups included in the imaging lens, a focal length of the focus lens group on the object side is denoted by ff1, and a focal length of the focus lens group on the image side is denoted by ff2. Ensuring that a corresponding value of Conditional Expression (9) is not less than or equal to its lower limit value prevents an excessively strong refractive power of the focus lens group on the object side and thus, facilitates correction of the astigmatism. Ensuring that the corresponding value of Conditional Expression (9) is not greater than or equal to its upper limit value prevents an excessively weak refractive power of the focus lens group on the object side and thus, facilitates correction of the field curvature.

$$0.2 < \vert ff 1 / ff 2 \vert < 5 \qquad ( 9 )$$

In order to obtain more favorable characteristics, the lower limit value of Conditional Expression (9) is more preferably 0.25, further preferably 0.3, further preferably 0.35, and further preferably 0.4. In order to obtain more favorable characteristics, the upper limit value of Conditional Expression (9) is more preferably 4, further preferably 3, further preferably 2.5, and further preferably 2.

The imaging lens preferably satisfies Conditional Expression (10). A combined focal length of all lenses closer to the image side than the focus lens group closest to the image side among the focus lens groups included in the imaging lens is denoted by ffR. Ensuring that a corresponding value of Conditional Expression (10) is not less than or equal to its lower limit value prevents an excessively strong negative combined refractive power of all lenses closer to the image side than the focus lens group closest to the image side and thus, achieves an advantage in correcting the lateral chromatic aberration. Ensuring that the corresponding value of Conditional Expression (10) is not greater than or equal to its upper limit value prevents an excessively strong positive combined refractive power of all lenses closer to the image side than the focus lens group closest to the image side and thus, achieves an advantage in correcting the distortion and the field curvature.

$$- 1.5 < f / ffR < 1.5 \qquad ( 10 )$$

In order to obtain more favorable characteristics, the lower limit value of Conditional Expression (10) is more preferably −1, further preferably −0.7, further preferably −0.5, further preferably −0.3, and further preferably −0.2. In order to obtain more favorable characteristics, the upper limit value of Conditional Expression (10) is more preferably 1, further preferably 0.7, further preferably 0.5, further preferably 0.3, and further preferably 0.2.

The imaging lens preferably satisfies Conditional Expression (11). A paraxial curvature radius of a surface, on the object side, of the lens closest to the object side in the front group GF is denoted by RL1f. A paraxial curvature radius of a surface, on the image side, of the lens closest to the object side in the front group GF is denoted by RL1r. Conditional Expression (11) defines a shape factor of the lens. Ensuring that a corresponding value of Conditional Expression (11) is not less than or equal to its lower limit value facilitates favorable correction of the astigmatism. Ensuring that the corresponding value of Conditional Expression (11) is not greater than or equal to its upper limit value facilitates favorable correction of the spherical aberration. In addition, ensuring that the corresponding value of Conditional Expression (11) is not greater than or equal to its upper limit value prevents an excessively weak refractive power of the lens closest to the object side in the front group GF and thus, facilitates achievement of a wide angle of view.

$$- 3 < ( RL 1 r - RL 1 f ) / ( RL 1 r + RL 1 f ) < 0 \qquad ( 11 )$$

In order to obtain more favorable characteristics, the lower limit value of Conditional Expression (11) is more preferably −2, further preferably −1, further preferably −0.7, and further preferably −0.5. In order to obtain more favorable characteristics, the upper limit value of Conditional Expression (11) is more preferably −0.05, further preferably −0.1, further preferably −0.11, and further preferably −0.12.

The imaging lens preferably satisfies Conditional Expression (12). Ensuring that a corresponding value of Conditional Expression (12) is not less than or equal to its lower limit value facilitates correction of various aberrations and reduction of the total optical length. Ensuring that the corresponding value of Conditional Expression (12) is not greater than or equal to its upper limit value can secure brightness of the lens system.

$$0.9 < Fno < 2.1 \qquad ( 12 )$$

In order to obtain more favorable characteristics, the lower limit value of Conditional Expression (12) is more preferably 0.95, further preferably 1, further preferably 1.05, and further preferably 1.1. In order to obtain more favorable characteristics, the upper limit value of Conditional Expression (12) is more preferably 1.9, further preferably 1.7, further preferably 1.5, and further preferably 1.3.

The imaging lens preferably satisfies Conditional Expression (13). Here, ωm is in degree units. Ensuring that a corresponding value of Conditional Expression (13) is not less than or equal to its lower limit value can secure a wide angle of view and thus, can provide a high added value as the imaging lens. Ensuring that the corresponding value of Conditional Expression (13) is not greater than or equal to its upper limit value facilitates balancing between optical performance and reduction in size.

$$29 < ω m < 50 \qquad ( 13 )$$

In order to obtain more favorable characteristics, the lower limit value of Conditional Expression (13) is more preferably 29.5, further preferably 30, further preferably 30.5, further preferably 31, and further preferably 31.5. In order to obtain more favorable characteristics, an upper limit value of Conditional Expression (13) is more preferably 47, further preferably 44, further preferably 41, further preferably 38, and further preferably 36.

In a configuration in which a negative meniscus lens having a convex surface facing the object side is disposed closest to the object side in the front group GF, the imaging lens preferably satisfies Conditional Expression (14). A focal length of the negative meniscus lens that has a convex surface facing the object side and that is disposed closest to the object side in the front group GF is denoted by fL1m. Ensuring that a corresponding value of Conditional Expression (14) is not less than or equal to its lower limit value prevents an excessively weak negative refractive power of the negative meniscus lens with respect to a refractive power of the entire system and thus, achieves an advantage in correcting various aberrations such as the distortion and the field curvature. Since a sign of the focal length of the negative meniscus lens is negative, the upper limit of Conditional Expression (14) is fL1m/f<0.

$$- 7 < fL 1 m / f < 0 \qquad ( 14 )$$

In order to obtain more favorable characteristics, the lower limit value of Conditional Expression (14) is more preferably −4, further preferably −3.5, further preferably −3, further preferably −2.5, and further preferably −2. In order to obtain more favorable characteristics, the upper limit value of Conditional Expression (14) is preferably −0.4. Ensuring that the corresponding value of Conditional Expression (14) is not greater than or equal to −0.4 can prevent an excessively strong negative refractive power of the negative meniscus lens with respect to the refractive power of the entire system and thus, achieves an advantage in favorably correcting the lateral chromatic aberration via the negative meniscus lens. In order to obtain more favorable characteristics, the upper limit value of Conditional Expression (14) is more preferably −0.6, further preferably −0.8, further preferably −0.9, and further preferably −1.

In a configuration in which a negative meniscus lens having a convex surface facing the object side is disposed closest to the object side in the front group GF, the imaging lens preferably satisfies Conditional Expression (15). An Abbe number based on a d line for the negative meniscus lens that has a convex surface facing the object side and that is disposed closest to the object side in the front group GF is denoted by vdL1m. Ensuring that a corresponding value of Conditional Expression (15) is not less than or equal to its lower limit value prevents an excessively small Abbe number of the negative meniscus lens and thus, achieves an advantage in favorably correcting the lateral chromatic aberration. Ensuring that the corresponding value of Conditional Expression (15) is not greater than or equal to its upper limit value prevents an excessively large Abbe number of the negative meniscus lens and thus, prevents an excessively low refractive index and an excessively weak refractive power of the negative meniscus lens. Accordingly, an advantage in favorably correcting the distortion and the field curvature is achieved.

$$35 < vdL 1 m < 90 \qquad ( 15 )$$

In order to obtain more favorable characteristics, the lower limit value of Conditional Expression (15) is more preferably 40, further preferably 42, further preferably 44, further preferably 46, further preferably 48, and further preferably 50. In order to obtain more favorable characteristics, the upper limit value of Conditional Expression (15) is more preferably 85, further preferably 80, further preferably 75, further preferably 70, further preferably 65, and further preferably 62.

The imaging lens preferably satisfies Conditional Expression (16). A combined focal length of all lenses closer to the object side than the focus lens group closest to the object side among the focus lens groups included in the imaging lens is denoted by ffF. Ensuring that a corresponding value of Conditional Expression (16) is not less than or equal to its lower limit value prevents an excessively strong negative combined refractive power of all lenses closer to the object side than the focus lens group closest to the object side and thus, can suppress an increase in the total optical length and further achieves an advantage in securing an edge part light quantity. Ensuring that the corresponding value of Conditional Expression (16) is not greater than or equal to its upper limit value prevents an excessively strong positive combined refractive power of all lenses closer to the object side than the focus lens group closest to the object side and thus, achieves an advantage in correcting the distortion and the field curvature.

$$- 2 < f / ffF < 1.5 \qquad ( 16 )$$

In order to obtain more favorable characteristics, the lower limit value of Conditional Expression (16) is more preferably −1.5, further preferably −1.2, further preferably −0.9, further preferably −0.7, and further preferably −0.5. In order to obtain more favorable characteristics, the upper limit value of Conditional Expression (16) is more preferably 1.2, further preferably 0.9, further preferably 0.7, further preferably 0.5, and further preferably 0.3.

The imaging lens preferably satisfies Conditional Expression (17). A focal length of a positive lens having the strongest refractive power among non-cemented positive lenses included in the rear group GR is denoted by fRp. Ensuring that a corresponding value of Conditional Expression (17) is not less than or equal to its lower limit value prevents an excessively weak refractive power of the positive lens in the rear group GR and thus, achieves an advantage in reduction in size by reducing a flange back distance. Ensuring that the corresponding value of Conditional Expression (17) is not greater than or equal to its upper limit value prevents an excessively strong refractive power of the positive lens in the rear group GR and thus, achieves an advantage in correcting various aberrations such as the spherical aberration.

$$0.4 < f / fRp < 1.3 \qquad ( 17 )$$

In order to obtain more favorable characteristics, the lower limit value of Conditional Expression (17) is more preferably 0.45, further preferably 0.5, further preferably 0.53, and further preferably 0.55. In order to obtain more favorable characteristics, the upper limit value of Conditional Expression (17) is more preferably 1.1, further preferably 1, further preferably 0.9, and further preferably 0.8.

The imaging lens preferably satisfies Conditional Expression (18). An Abbe number based on the d line for the positive lens having the strongest refractive power among the non-cemented positive lenses included in the rear group GR is denoted by vdRp. Ensuring that a corresponding value of Conditional Expression (18) is not less than or equal to its lower limit value prevents an excessively small Abbe number of the positive lens having the strongest refractive power among the non-cemented positive lenses included in the rear group GR and thus, achieves an advantage in favorably correcting the lateral chromatic aberration. Ensuring that the corresponding value of Conditional Expression (18) is not greater than or equal to its upper limit value prevents an excessively large Abbe number of the positive lens having the strongest refractive power among the non-cemented positive lenses included in the rear group GR and thus, prevents an excessively low refractive index and an excessively weak refractive power of the positive lens. Accordingly, an advantage in favorably correcting the distortion and the field curvature is achieved.

$$25 < vdRp < 90 \qquad ( 18 )$$

In order to obtain more favorable characteristics, the lower limit value of Conditional Expression (18) is more preferably 40, further preferably 50, further preferably 55, and further preferably 60. In order to obtain more favorable characteristics, the upper limit value of Conditional Expression (18) is more preferably 85, further preferably 80, further preferably 75, and further preferably 70.

In a case where a lens that has, on a lens surface, the inflection point at which the convex or concave shape changes in the middle of the lens surface from the position on the optical axis to the edge part is referred to as a specific aspherical lens, the imaging lens preferably satisfies Conditional Expression (19) in a configuration in which at least one specific aspherical lens is disposed in the rear group GR. A sum of the back focus Bf of the entire system as the air conversion distance and a distance on the optical axis from a surface, on the image side, of the specific aspherical lens closest to the image side among the specific aspherical lenses included in the rear group GR to the lens surface of the rear group GR closest to the image side in the state where the infinite distance object is in focus is denoted by dAsI. For example, the distance dAsI is illustrated in FIG. 3. Ensuring that a corresponding value of Conditional Expression (19) is not less than or equal to its lower limit value facilitates prevention of interference between the imaging lens and various optical filters installed near the image plane. Ensuring that the corresponding value of Conditional Expression (19) is not greater than or equal to its upper limit value facilitates correction of the distortion and the field curvature.

$$0.04 < dAsI / TL < 0.4 \qquad ( 19 )$$

In order to obtain more favorable characteristics, the lower limit value of Conditional Expression (19) is more preferably 0.08, further preferably 0.1, further preferably 0.11, and further preferably 0.12. In order to obtain more favorable characteristics, the upper limit value of Conditional Expression (19) is more preferably 0.35, further preferably 0.3, further preferably 0.25, and further preferably 0.2.

In a configuration in which the imaging lens includes a three-piece cemented lens in which the first positive lens, the second positive lens, and the negative lens are cemented in this order, the imaging lens preferably satisfies Conditional Expression (20). A refractive index with respect to the d line for the second positive lens is denoted by Ndp2. An Abbe number based on the d line for the second positive lens is denoted by vdp2. Ensuring that a corresponding value of Conditional Expression (20) is not less than or equal to its lower limit value enables selection of a material other than a material having a low refractive index and a small Abbe number and thus, facilitates correction of the lateral chromatic aberration. Ensuring that the corresponding value of Conditional Expression (20) is not greater than or equal to its upper limit value enables selection of a material other than a material having a high refractive index and a large Abbe number. Thus, a material of which a specific gravity is not large can be selected, and this facilitates reduction in weight.

$$1.7 < Ndp 2 + 0.01 \times vdp 2 < 2.05 \qquad ( 20 )$$

In order to obtain more favorable characteristics, the lower limit value of Conditional Expression (20) is more preferably 1.74, further preferably 1.76, further preferably 1.77, and further preferably 1.78. In order to obtain more favorable characteristics, the upper limit value of Conditional Expression (20) is more preferably 2.02, further preferably 2, further preferably 1.99, and further preferably 1.98.

The preferable configurations and available configurations described above can be combined in any manner without inconsistency and are preferably selectively adopted, as appropriate, in accordance with required specifications.

For example, according to a preferable aspect of the imaging lens of the present disclosure, the imaging lens consists of, in order from the object side to the image side, the front group GF, the aperture stop St, and the rear group GR, in which the rear group GR includes one or two focus lens groups that move along the optical axis Z during the focusing, the distance on the optical axis from the lens surface of the front group GF closest to the object side to the image plane Sim is invariant during the focusing, and Conditional Expressions (1), (2), and (3) are satisfied.

Next, examples of the imaging lens of the present disclosure will be described with reference to the drawings. Reference numerals provided to the groups and the lenses in the cross-sectional view of each example are independently used for each example in order to avoid complication of description and the drawings caused by an increasing number of digits of the reference numerals. Accordingly, even in a case where a common reference numeral is provided in the drawings of different examples, the common reference numeral does not necessarily indicate a common configuration.

### Example 1

A cross-sectional view of a configuration of the imaging lens of Example 1 is illustrated in FIG. 1, and its illustration method and configuration are the same as described above. Thus, duplicate descriptions will be partially omitted. The imaging lens of Example 1 consists of, in order from the object side to the image side, the front group GF having a positive refractive power, the aperture stop St, and the rear group GR having a positive refractive power. The imaging lens includes only one focus lens group. During the focusing from the infinite distance object to the short range object, the focus lens group moves to the object side.

For the imaging lens of Example 1, Table 1 shows basic lens data, Table 2 shows specifications and a variable surface spacing, and Table 3 shows aspherical coefficients.

The table of the basic lens data is described as follows. A column of “Sn” shows surface numbers in a case where the number is increased by one at a time toward the image side from the surface closest to the object side as a first surface. A column of “R” shows a curvature radius of each surface. A column of “D” shows a surface spacing on the optical axis between each surface and its adjacent surface on the image side. A column of “Nd” shows a refractive index with respect to the d line for each lens. A column of “vd” shows an Abbe number based on the d line for each lens.

A column of “Material” in the table of the basic lens data, including the tables of the examples described later, is described as follows. In the column of “Material”, “Plastic” indicates a lens of which a material is a resin. For a lens of a material other than a resin, a material name and a name of a manufacturing company are shown with a period mark therebetween. In the table, the name of the manufacturing company is schematically shown as follows. “OHARA” indicates OHARA INC. “CDGM” indicates Chengdu Guangming Guangdian Co., Ltd. “HOYA” indicates HOYA Corporation. “NHG” indicates Hubei New Huaguang Information Materials Co., Ltd. A column of “ED” shows an effective diameter of each surface. In the column of “ED”, a part of surfaces not related to the conditional expressions is omitted.

In the table of the basic lens data, a sign of the curvature radius of the surface having a convex shape facing the object side is positive, and a sign of the curvature radius of the surface having a convex shape facing the image side is negative. A field of the surface number of the surface corresponding to the aperture stop St has the surface number and a text (St). A value in the lowermost field of the column of D in the table indicates a spacing between the surface closest to the image side in the table and the image plane Sim. A symbol DD[ ] is used for the variable surface spacing during the focusing. A surface number on the object side of the spacing is provided in [ ] in the column of the surface spacing.

Table 2 shows the focal length, the back focus, the open F-number, a maximum full angle of view, and the variable surface spacing of the entire system based on the d line. In a field of the maximum full angle of view, [°] indicates a degree unit. In Table 2, each value in the state where the infinite distance object is in focus is shown in a column of “Infinite Distance”, and each value in the state where the nearest object is in focus is shown in a column of “Short Range”. The focal length indicates only a value in the state where the infinite distance object is in focus. In a field of “Short Range”, an absolute value of an imaging magnification in the state where the nearest object is in focus is shown with “Times”.

In the basic lens data, a surface number of an aspherical surface is marked with *, and a numerical value of a paraxial curvature radius is shown in a field of the curvature radius of the aspherical surface. In Table 3, the column of Sn shows the surface number of the aspherical surface, and columns of KA and Am show a numerical value of the aspherical coefficient for each aspherical surface. Here, m of Am is an integer greater than or equal to 3 and varies depending on the surface. For example, for the first surface of Example 1, m=4, 6, 8, 10, and 12 is established. In the numerical value of the aspherical coefficient in Table 3, “E±n” (n: integer) means “x10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ Am \times {h}^{m}$$

where
Zd: an aspherical depth (a length of a perpendicular line drawn from a point on an aspherical surface at a height h to a plane that is in contact with an aspherical surface apex and that is perpendicular to the optical axis Z)
h: a height (a distance from the optical axis Z to a lens surface)
C: a reciprocal of a paraxial curvature radius
KA and Am: aspherical coefficients
Σ in the aspheric equation means a sum total with respect to m.

In the data of each table, a degree unit is used for angles, and a millimeter (mm) unit is used for lengths. However, since the optical system can also be proportionally enlarged or proportionally reduced to be used, other appropriate units can also be used. Numerical values rounded to predetermined digits are described in each table shown below.

TABLE 1
Example 1

| Sn | R | D | Nd | νd | Material | ED |
|---|---|---|---|---|---|---|
| *1 | 36.9114 | 2.0002 | 1.51633 | 64.06 | L-BSL7.OHARA | |
| *2 | 16.0546 | 6.5972 | | | | |
| 3 | 28.4756 | 0.7514 | 1.49700 | 81.54 | S-FPL51.OHARA | |
| 4 | 15.7915 | 13.7278 | | | | |
| 5 | −22.8236 | 0.5634 | 1.89286 | 20.36 | S-NPH4.OHARA | |
| 6 | 27.0898 | 6.2064 | 1.88300 | 39.22 | H-ZLAF68N.CDGM | |
| 7 | −35.6195 | 4.4441 | | | | |
| 8 | 66.6436 | 3.6612 | 1.95906 | 17.47 | S-NPH3.OHARA | |
| 9 | −76.3070 | 4.8313 | | | | |
| 10 (St) | ∞ | DD[10] | | | | |
| 11 | 31.6590 | 3.9924 | 1.49700 | 81.54 | S-FPL51.OHARA | |
| 12 | −653.8511 | 1.5295 | | | | |
| 13 | 54.7953 | 7.1980 | 1.49700 | 81.54 | S-FPL51.OHARA | |
| 14 | −19.0274 | 0.6239 | 1.69895 | 30.13 | S-TIM35.OHARA | |
| 15 | −98.4522 | 0.0500 | | | | |
| 16 | 34.8118 | 5.7847 | 1.49700 | 81.54 | S-FPL51.OHARA | |
| 17 | −33.9389 | 0.0500 | | | | |
| 18 | −362.8038 | 0.5887 | 2.00100 | 29.14 | S-LAH99.OHARA | |
| 19 | 32.4455 | 2.3525 | | | | |
| *20 | −19082.0007 | 0.5832 | 1.88202 | 37.22 | MC-TAFD307.HOYA | 22.11 |
| *21 | 239.1593 | DD[21] | | | | 22.60 |
| *22 | −284.7229 | 0.7499 | 1.76450 | 49.10 | L-LAH91.OHARA | 27.90 |
| *23 | 83.3333 | 0.3628 | | | | 30.00 |
| 24 | 51.0834 | 4.0723 | 1.64000 | 60.08 | S-BSM81.OHARA | |
| 25 | 806.1847 | 11.2200 | | | | |

TABLE 2
Example 1

| | | Short Range |
|---|---|---|
| | Infinite Distance | 0.16 Times |
| Focal Length | 20.93 | — |
| Back Focus | 11.22 | 11.22 |
| Open F-Number | 1.85 | 1.98 |
| Maximum Full Angle of View [°] | 92.0 | 89.0 |
| DD[10] | 13.37 | 9.96 |
| DD[21] | 7.16 | 10.58 |

TABLE 3
Example 1

| Sn | 1 | 2 |
|---|---|---|
| KA | 1.0000000E+00 | 1.0000000E+00 |
| A4 | 2.7581553E−05 | 2.3977919E−05 |
| A6 | −1.3476994E−07 | −1.0873318E−07 |
| A8 | 4.5680464E−10 | −2.3607650E−10 |
| A10 | −8.0666844E−13 | 2.6111995E−12 |
| A12 | 6.6120989E−16 | −6.8994378E−15 |

| Sn | 20 | 21 | 22 | 23 |
|---|---|---|---|---|
| KA | 1.0000000E+00 | 1.0000000E+00 | 1.0000000E+00 | 1.0000000E+00 |
| A4 | −2.0721333E−05 | 1.9583400E−05 | −4.5890634E−05 | −4.6451990E−05 |
| A6 | 8.2411291E−08 | 1.3488726E−07 | 1.5193795E−07 | 1.8099821E−07 |
| A8 | −1.4162671E−09 | −1.1232077E−09 | −2.9358963E−10 | −5.0500218E−10 |
| A10 | 3.4540512E−12 | 3.1943252E−12 | −4.7523559E−13 | 3.2040402E−13 |

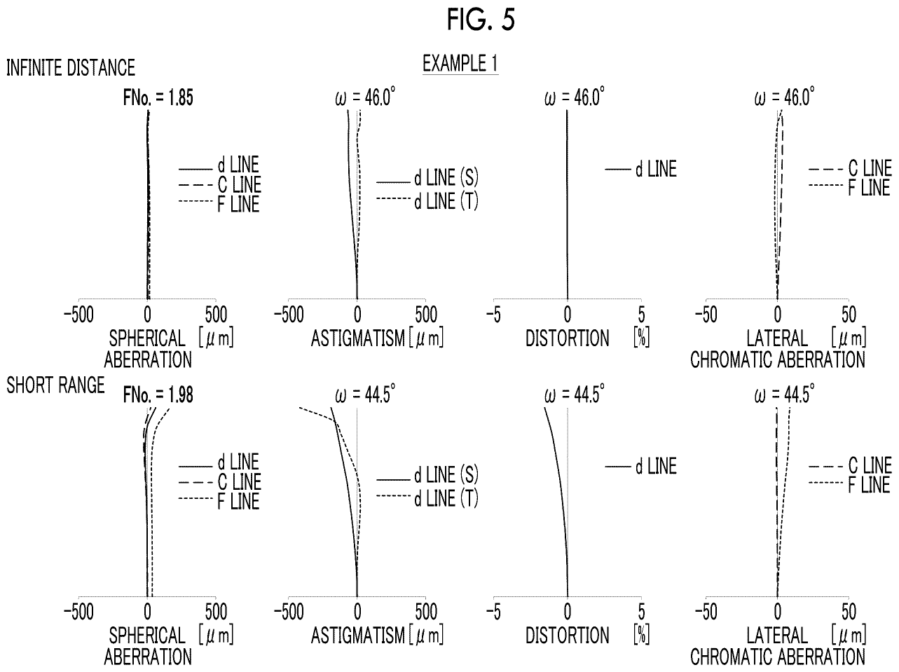

Each aberration diagram of the imaging lens of Example 1 is illustrated in FIG. 5. In FIG. 5, the spherical aberration, the astigmatism, the distortion, and the lateral chromatic aberration are illustrated in this order from the left. In FIG. 5, each aberration diagram in the state where the infinite distance object is in focus is illustrated in an upper part labeled “INFINITE DISTANCE”, and each aberration diagram in the state where the nearest object is in focus is illustrated in a lower part labeled “SHORT RANGE”. In the spherical aberration diagram, aberrations on the d line, a C line, and an F line are illustrated by a solid line, a long broken line, and a short broken line, respectively. In the astigmatism diagram, an aberration on the d line in a sagittal direction is illustrated by a solid line, and an aberration on the d line in a tangential direction is illustrated by a short broken line. In the distortion diagram, an aberration on the d line is illustrated by a solid line. In the lateral chromatic aberration diagram, aberrations on the C line and the F line are illustrated by a long broken line and a short broken line, respectively. In the spherical aberration diagram, a value of the open F-number is shown after “FNo.=”. In other aberration diagrams, a value of the maximum half angle of view is shown after “ω=”.

Symbols, meanings, description methods, and illustration methods of each data related to Example 1 are basically the same for the following examples unless otherwise specified. Thus, duplicate descriptions will be omitted below.

### Example 2

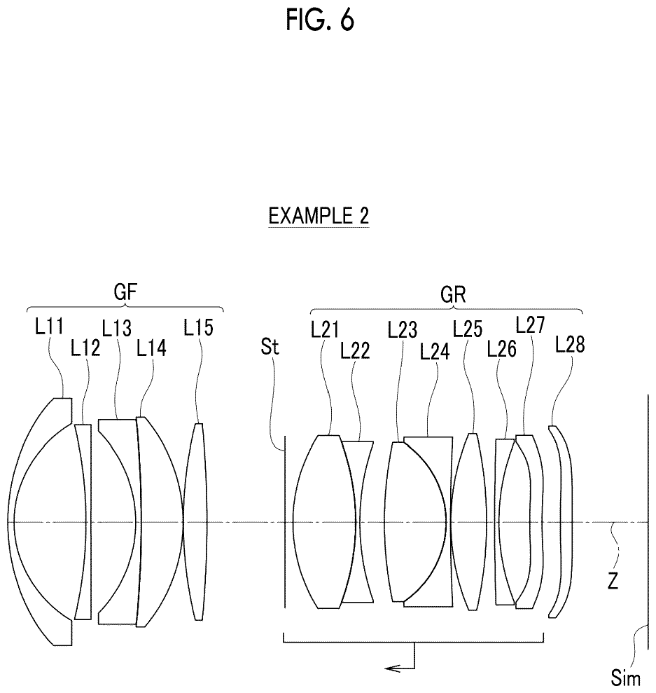

A cross-sectional view of a configuration of an imaging lens of Example 2 is illustrated in FIG. 6. The imaging lens of Example 2 consists of, in order from the object side to the image side, the front group GF having a positive refractive power, the aperture stop St, and the rear group GR having a positive refractive power. The front group GF consists of five lenses including the lenses L11 to L15 in order from the object side to the image side. The rear group GR consists of eight lenses including the lenses L21 to L28 in order from the object side to the image side. The imaging lens includes only one focus lens group. The focus lens group consists of the aperture stop St and the lenses L21 to L27. During the focusing from the infinite distance object to the short range object, the focus lens group moves to the object side.

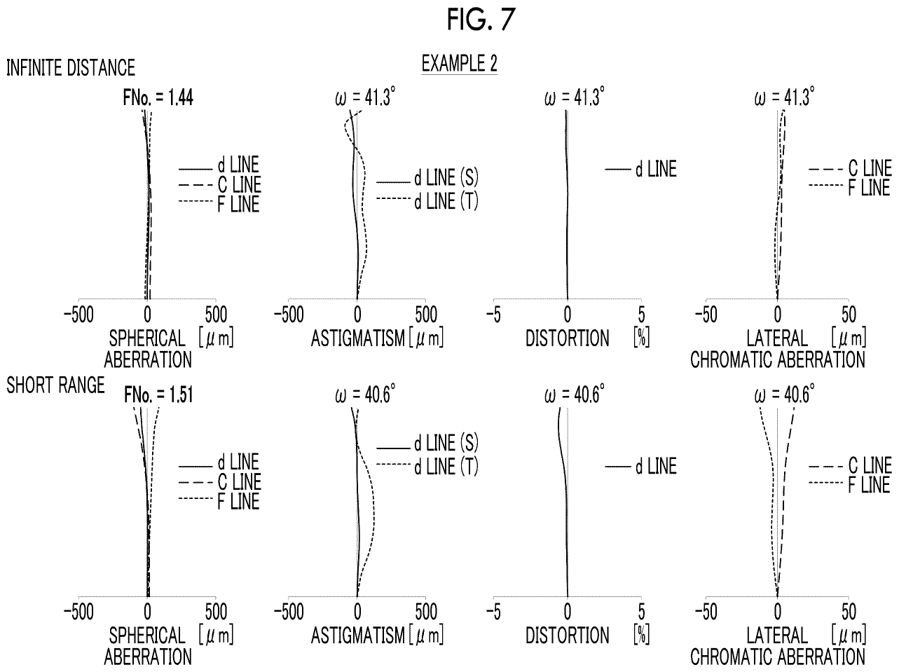

For the imaging lens of Example 2, Table 4 shows basic lens data, Table 5 shows specifications and a variable surface spacing, Table 6 shows aspherical coefficients, and FIG. 7 illustrates each aberration diagram.

TABLE 4
Example 2

| Sn | R | D | Nd | νd | Material | ED |
|---|---|---|---|---|---|---|
| *1 | 34.3737 | 1.0499 | 1.76450 | 49.10 | L-LAH91.OHARA | |
| *2 | 18.5811 | 12.1644 | | | | |
| 3 | −71.1188 | 0.8502 | 1.43875 | 94.66 | S-FPL55.OHARA | |
| 4 | 46536.5390 | 7.5598 | | | | |
| 5 | −22.1444 | 0.9367 | 1.92286 | 18.90 | S-NPH2.OHARA | |
| 6 | −182.5386 | 7.0767 | 1.88300 | 39.22 | H-ZLAF68N.CDGM | |
| 7 | −27.7575 | 0.0450 | | | | |
| 8 | 69.4910 | 3.9879 | 2.10420 | 17.02 | E-FDS3-W.HOYA | |
| 9 | −178.6752 | DD[9] | | | | |
| 10 (St) | ∞ | 1.3527 | | | | |
| 11 | 27.7565 | 10.5021 | 1.53775 | 74.70 | S-FPM3.OHARA | |
| 12 | −39.9397 | 0.7055 | 1.84666 | 23.78 | S-TIH53W.OHARA | |
| 13 | 40.6823 | 4.1563 | | | | |
| 14 | 65.7769 | 10.4351 | 1.59522 | 67.73 | S-FPM2.OHARA | |
| 15 | −16.3640 | 0.7446 | 1.62004 | 36.26 | S-TIM2.OHARA | |
| 16 | 276.0848 | 0.0493 | | | | |
| 17 | 38.4466 | 6.0507 | 2.00069 | 25.46 | TAFD40-W.HOYA | |
| 18 | −67.8398 | 1.3628 | | | | |
| 19 | 435.5640 | 0.7278 | 1.84666 | 23.78 | S-TIH53W.OHARA | |
| 20 | 36.7912 | 5.2162 | | | | |
| *21 | 71.9820 | 2.0766 | 2.00178 | 19.32 | MC-FDS2.HOYA | 27.25 |
| *22 | 68.3846 | DD[22] | | | | 29.43 |
| *23 | 146.9050 | 2.0000 | 1.51633 | 64.06 | L-BSL7.OHARA | 31.47 |
| *24 | 1636.9338 | 12.8300 | | | | 32.60 |

TABLE 5
Example 2

| | | Short Range |
|---|---|---|
| Example | Infinite Distance | 0.08 Times |
| Focal Length | 24.68 | — |
| Back Focus | 12.83 | 12.83 |
| Open F-Number | 1.44 | 1.51 |
| Maximum Full Angle of View [°] | 82.6 | 81.2 |
| DD[9] | 13.20 | 10.86 |
| DD[22] | 3.10 | 5.44 |

TABLE 6
Example 2

| Sn | 1 | 2 | 21 | 22 |
|---|---|---|---|---|
| KA | 1.0000000E+00 | 1.0000000E+00 | 1.0000000E+00 | 1.0000000E+00 |
| A4 | 3.9651598E−06 | 1.5421722E−06 | −8.7627274E−05 | −7.0131011E−05 |
| A6 | −3.4032600E−08 | −7.2935457E−08 | −3.5752457E−07 | −3.5428099E−07 |
| A8 | 1.6140338E−10 | 3.3564210E−10 | 1.3987961E−09 | 2.6244808E−09 |
| A10 | −3.6712115E−13 | −1.0852169E−12 | 1.2636917E−12 | −4.9700906E−12 |
| A12 | 3.7583680E−16 | 9.8754650E−16 | −6.8824360E−15 | 2.3455090E−15 |

| Sn | 23 | 24 |
|---|---|---|
| KA | 1.0000000E+00 | 1.0000000E+00 |
| A4 | −1.7440095E−05 | −1.6297372E−05 |
| A6 | −1.6142211E−07 | −9.3751148E−08 |
| A8 | 8.7291140E−11 | −2.0945795E−10 |
| A10 | 3.8579220E−13 | 8.1033927E−13 |

### Example 3

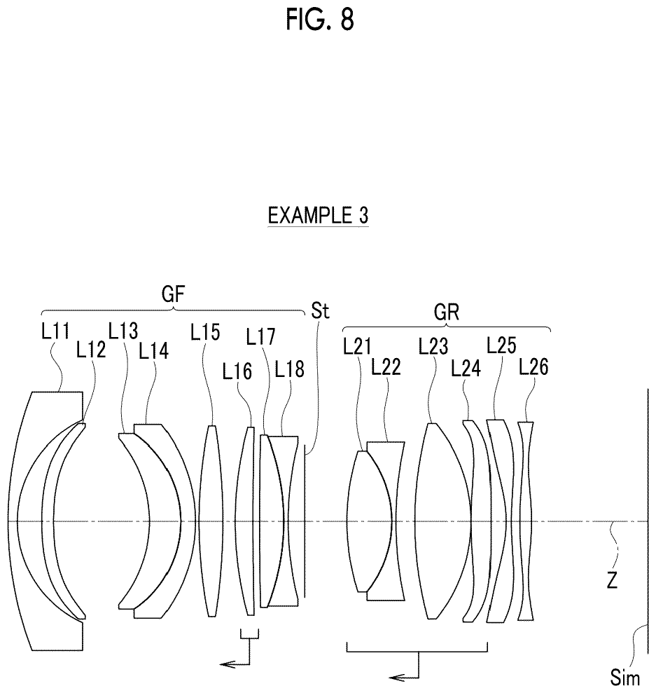

A cross-sectional view of a configuration of an imaging lens of Example 3 is illustrated in FIG. 8. The imaging lens of Example 3 consists of, in order from the object side to the image side, the front group GF having a positive refractive power, the aperture stop St, and the rear group GR having a positive refractive power. The front group GF consists of eight lenses including lenses L11 to L18 in order from the object side to the image side. The rear group GR consists of six lenses including the lenses L21 to L26 in order from the object side to the image side. The imaging lens includes only two focus lens groups. Out of the two focus lens groups, the focus lens group on the object side consists of the lens L16, and the focus lens group on the image side consists of the lenses L21 to L24. During the focusing from the infinite distance object to the short range object, the focus lens group on the object side and the focus lens group on the image side move to the object side by changing the mutual spacing.

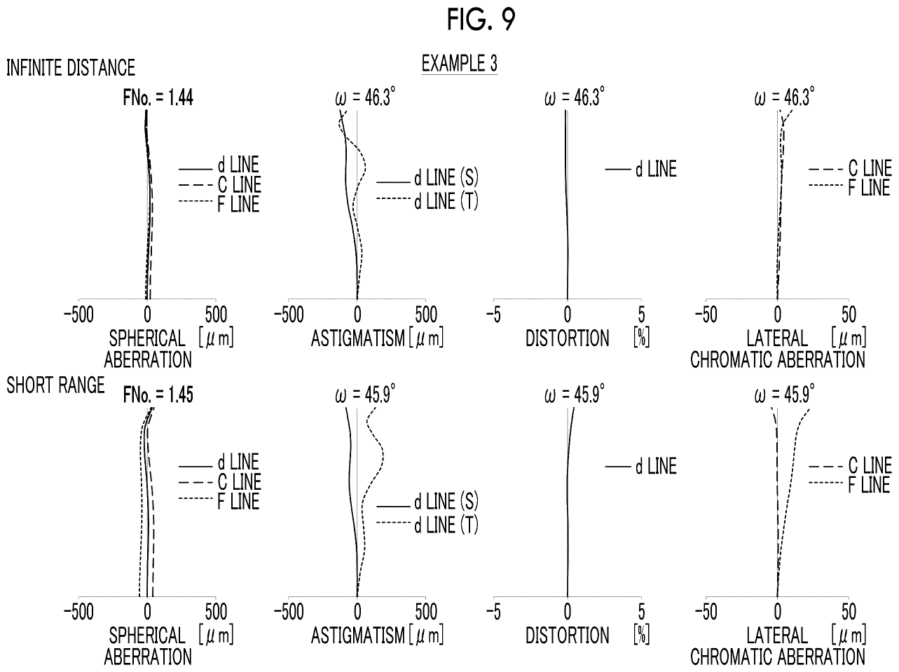

For the imaging lens of Example 3, Table 7 shows basic lens data, Table 8 shows specifications and a variable surface spacing, Table 9 shows aspherical coefficients, and FIG. 9 illustrates each aberration diagram.

TABLE 7
Example 3

| Sn | R | D | Nd | νd | Material | ED |
|---|---|---|---|---|---|---|
| 1 | 59.1009 | 1.5000 | 1.70154 | 41.24 | S-BAH27.OHARA | |
| 2 | 18.2637 | 4.0069 | | | | |
| *3 | 47.4546 | 1.9115 | 1.49700 | 81.54 | S-FPL51.OHARA | |
| *4 | 41.9443 | 15.6437 | | | | |
| 5 | −20.9747 | 5.0348 | 1.88300 | 39.22 | H-ZLAF68N.CDGM | |
| 6 | −17.4859 | 2.3879 | 1.95906 | 17.47 | S-NPH3.OHARA | |
| 7 | −25.5776 | 0.5712 | | | | |
| 8 | 79.3332 | 3.8821 | 2.00272 | 19.32 | E-FDS2.HOYA | |
| 9 | −102.4210 | DD[9] | | | | |
| 10 | 58.6602 | 2.8963 | 1.59522 | 67.73 | S-FPM2.OHARA | |
| 11 | 652.7056 | DD[11] | | | | |
| 12 | 595.1146 | 3.9433 | 1.88300 | 39.22 | H-ZLAF68N.CDGM | |
| 13 | −38.3774 | 0.7280 | 1.69895 | 30.13 | S-TIM35.OHARA | |
| 14 | 52.1707 | 2.7038 | | | | |
| 15 (St) | ∞ | DD[15] | | | | |
| 16 | 37.7870 | 7.3332 | 1.43875 | 94.66 | S-FPL55.OHARA | |
| 17 | −18.3756 | 0.6702 | 1.69895 | 30.13 | S-TIM35.OHARA | |
| 18 | 60.0602 | 3.0768 | | | | |
| 19 | 60.6869 | 9.1569 | 1.53775 | 74.70 | S-FPM3.OHARA | |
| 20 | −25.4158 | 0.0186 | | | | |
| *21 | 68.3245 | 3.1947 | 1.95150 | 29.83 | MP-TAFD405.HOYA | 31.81 |
| *22 | −380.6295 | DD[22] | | | | 32.93 |
| *23 | −20.4370 | 0.8533 | 1.68948 | 31.02 | L-TIM28.OHARA | 32.82 |
| *24 | 52.6820 | 1.3942 | | | | 33.22 |
| *25 | 65.8334 | 1.9043 | 1.85400 | 40.38 | L-LAH85V.OHARA | 32.16 |
| *26 | −38.1344 | 19.0000 | | | | 32.46 |

TABLE 8
Example 3

| | | Short Range |
|---|---|---|
| | Infinite Distance | 0.11 Times |
| Focal Length | 20.70 | — |
| Back Focus | 19.00 | 19.00 |
| Open F-Number | 1.44 | 1.45 |
| Maximum Full Angle of View [°] | 92.6 | 91.8 |
| DD[9] | 2.02 | 0.63 |
| DD[11] | 1.07 | 2.46 |
| DD[15] | 6.87 | 5.62 |
| DD[22] | 2.43 | 3.67 |

TABLE 9
Example 3

| Sn | 3 | 4 | 21 | 22 |
|---|---|---|---|---|
| KA | 1.0000000E+00 | 1.0000000E+00 | 1.0000000E+00 | 1.0000000E+00 |
| A4 | 6.1752805E−05 | 6.0751817E−05 | −2.2248673E−05 | −1.2315307E−05 |
| A6 | −1.0744654E−07 | −1.2773482E−07 | −5.1778727E−08 | −6.5095362E−08 |
| A8 | 3.4964370E−10 | 3.9442521E−10 | −4.1881846E−10 | −2.1532037E−10 |
| A10 | −5.1763098E−13 | −9.6101897E−13 | 7.7327800E−13 | 5.3483700E−13 |
| Sn | 23 | 24 | 25 | 26 |
| KA | 1.0000000E+00 | 1.0000000E+00 | 1.0000000E+00 | 1.0000000E+00 |
| A4 | 1.0318407E−04 | −6.6892480E−05 | −1.2136085E−05 | 9.5189950E−05 |
| A6 | −1.0432371E−07 | 6.0800247E−08 | −1.4147008E−07 | −8.7588854E−08 |
| A8 | −3.2588517E−10 | −4.3111851E−11 | 1.9651026E−10 | −4.9430378E−10 |
| A10 | 1.0236074E−12 | 6.7398241E−14 | 6.7215050E−14 | 1.0178137E−12 |

### Example 4

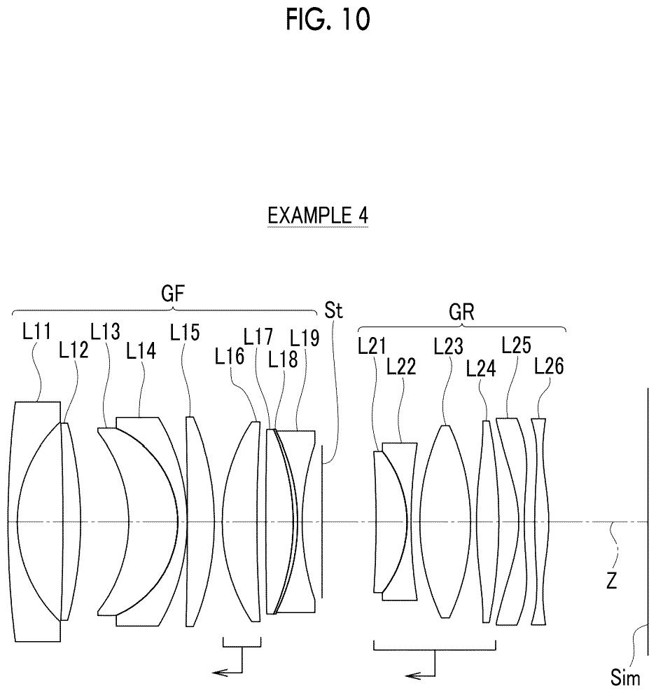

A cross-sectional view of a configuration of an imaging lens of Example 4 is illustrated in FIG. 10. The imaging lens of Example 4 consists of, in order from the object side to the image side, the front group GF having a positive refractive power, the aperture stop St, and the rear group GR having a positive refractive power. The front group GF consists of nine lenses including lenses L11 to L19 in order from the object side to the image side. The rear group GR consists of six lenses including the lenses L21 to L26 in order from the object side to the image side. The imaging lens includes only two focus lens groups. Out of the two focus lens groups, the focus lens group on the object side consists of the lens L16, and the focus lens group on the image side consists of the lenses L21 to L24. During the focusing from the infinite distance object to the short range object, the focus lens group on the object side and the focus lens group on the image side move to the object side by changing the mutual spacing.

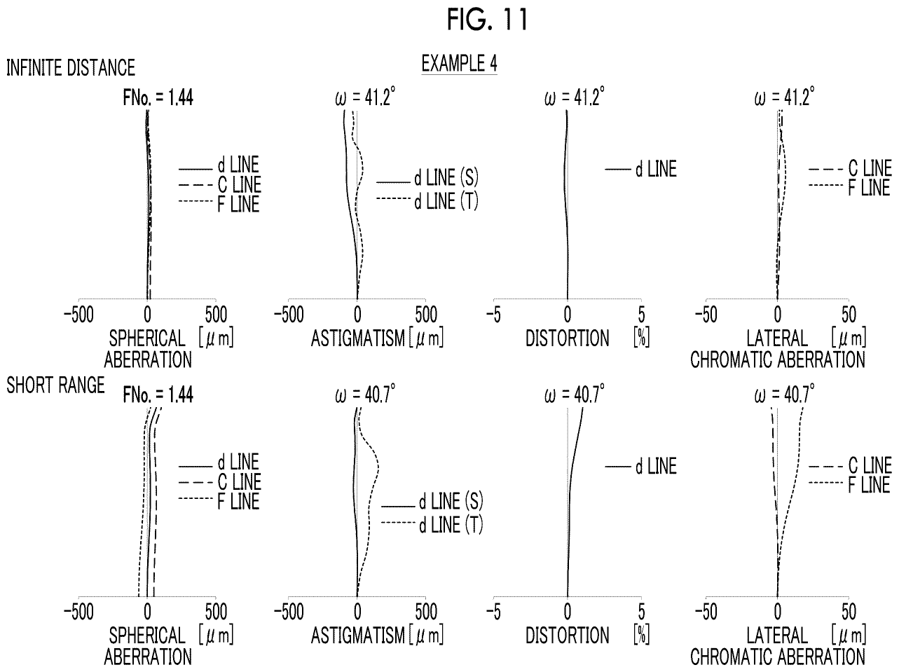

For the imaging lens of Example 4, Table 10 shows basic lens data, Table 11 shows specifications and a variable surface spacing, Table 12 shows aspherical coefficients, and FIG. 11 illustrates each aberration diagram.

TABLE 10
Example 4

| Sn | R | D | Nd | νd | Material | ED |
|---|---|---|---|---|---|---|
| 1 | 160.8912 | 1.5000 | 1.75500 | 52.32 | S-LAH97.OHARA | |
| 2 | 22.3836 | 7.3718 | | | | |
| 3 | −372.9846 | 2.8483 | 1.49700 | 81.54 | S-FPL51.OHARA | |
| 4 | −61.9592 | 7.7695 | | | | |
| 5 | −23.6638 | 7.8936 | 1.83400 | 37.21 | S-LAH60V.OHARA | |
| 6 | −16.5454 | 1.5108 | 1.89286 | 20.36 | S-NPH4.OHARA | |
| 7 | −33.2588 | 0.0438 | | | | |
| 8 | −700.6876 | 4.3567 | 2.00272 | 19.32 | E-FDS2.HOYA | |
| 9 | −44.4116 | DD[9] | | | | |
| 10 | 29.9106 | 5.5935 | 1.59522 | 67.73 | S-FPM2.OHARA | |
| 11 | 252.0535 | DD[11] | | | | |
| 12 | 792.8870 | 4.4069 | 1.88300 | 39.22 | H-ZLAF68N.CDGM | |
| 13 | −36.9360 | 0.7000 | 1.54493 | 25.30 | Plastic | |
| 14 | −33.1026 | 0.7481 | 1.69895 | 30.13 | S-TIM35.OHARA | |
| 15 | 39.9513 | 3.2130 | | | | |
| 16 (St) | ∞ | DD[16] | | | | |
| 17 | −183.5674 | 4.9898 | 1.43875 | 94.66 | S-FPL55.OHARA | |
| 18 | −18.6198 | 0.6613 | 1.71736 | 29.52 | S-TIH1.OHARA | |
| 19 | 83.3789 | 1.4081 | | | | |
| 20 | 36.5670 | 8.1886 | 1.49700 | 81.54 | S-FPL51.OHARA | |
| 21 | −37.1213 | 0.9562 | | | | |
| *22 | 65.3328 | 3.6128 | 1.95150 | 29.83 | MP-TAFD405.HOYA | 32.56 |
| *23 | −76.1045 | DD[23] | | | | 32.71 |
| *24 | −20.0457 | 0.8631 | 1.68948 | 31.02 | L-TIM28.OHARA | 32.80 |
| *25 | 50.6701 | 1.6993 | | | | 33.50 |
| *26 | 97.4740 | 2.2663 | 1.85135 | 40.10 | MC-TAFD305.HOYA | 33.05 |
| *27 | −31.9256 | 16.0100 | | | | 33.39 |

TABLE 11
Example 4

| | | Short Range |
|---|---|---|
| | Infinite Distance | 0.11 Times |
| Focal Length | 24.70 | — |
| Back Focus | 16.02 | 16.02 |
| Open F-Number | 1.44 | 1.44 |
| Maximum Full Angle of View [°] | 82.4 | 81.4 |
| DD[9] | 1.27 | 0.18 |
| DD[11] | 1.45 | 2.54 |
| DD[16] | 8.62 | 7.33 |
| DD[23] | 3.22 | 4.51 |

TABLE 12
Example 4

| Sn | 22 | 23 | 24 |
|---|---|---|---|
| KA | 1.0000000E+00 | 1.0000000E+00 | 1.0000000E+00 |
| A4 | −8.1438024E−06 | 1.3270138E−05 | 7.8523701E−05 |
| A6 | 7.3102741E−09 | −5.3230147E−08 | −4.2453112E−09 |
| A8 | −3.2572464E−10 | −8.1963245E−11 | −4.2342072E−10 |
| A10 | 7.7327800E−13 | 5.3483700E−13 | 1.0718953E−12 |
| Sn | 25 | 26 | 27 |
| KA | 1.0000000E+00 | 1.0000000E+00 | 1.0000000E+00 |
| A4 | −6.6885439E−05 | −1.7810027E−06 | 7.6183267E−05 |
| A6 | 5.4226654E−08 | −1.7532824E−07 | −1.4050322E−08 |
| A8 | −8.2283279E−11 | 2.9819180E−10 | −4.3115424E−10 |
| A10 | 3.1347448E−13 | 8.4424958E−14 | 7.0981077E−13 |

### Example 5

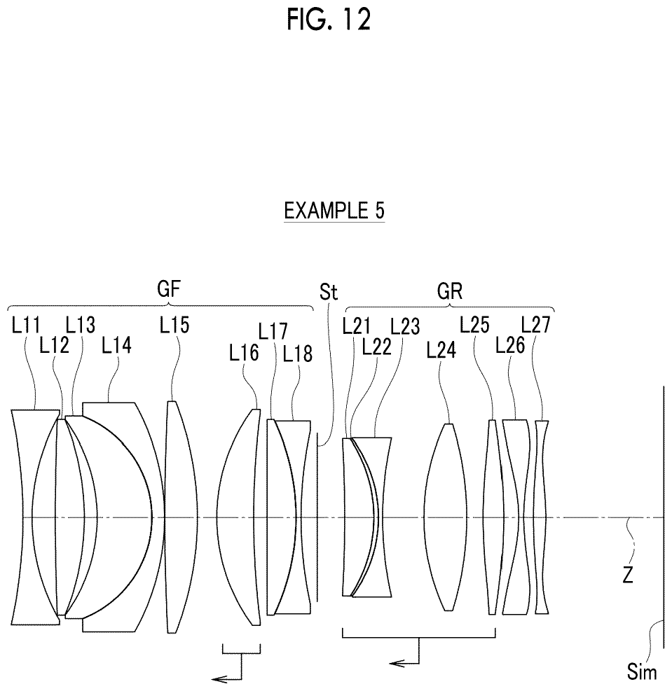

A cross-sectional view of a configuration of an imaging lens of Example 5 is illustrated in FIG. 12. The imaging lens of Example 5 consists of, in order from the object side to the image side, the front group GF having a positive refractive power, the aperture stop St, and the rear group GR having a positive refractive power. The front group GF consists of eight lenses including the lenses L11 to L18 in order from the object side to the image side. The rear group GR consists of seven lenses including the lenses L21 to L27 in order from the object side to the image side. The imaging lens includes only two focus lens groups. Out of the two focus lens groups, the focus lens group on the object side consists of the lens L16, and the focus lens group on the image side consists of the lenses L21 to L25. During the focusing from the infinite distance object to the short range object, the focus lens group on the object side and the focus lens group on the image side move to the object side by changing the mutual spacing.

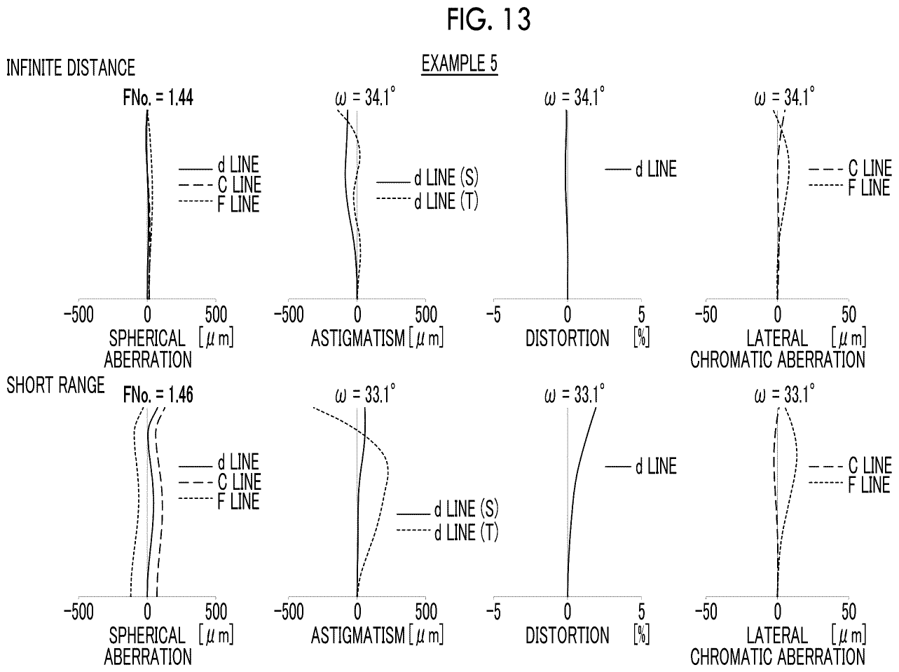

For the imaging lens of Example 5, Table 13 shows basic lens data, Table 14 shows specifications and a variable surface spacing, Table 15 shows aspherical coefficients, and FIG. 13 illustrates each aberration diagram.

TABLE 13
Example 5

| Sn | R | D | Nd | νd | Material | ED |
|---|---|---|---|---|---|---|
| 1 | −82.7197 | 1.5000 | 1.75500 | 52.32 | S-LAH97.OHARA | |
| 2 | 34.3240 | 3.8217 | | | | |
| 3 | 380.4064 | 4.7679 | 1.49700 | 81.54 | S-FPL51.OHARA | |
| 4 | −42.7072 | 2.1172 | | | | |
| 5 | −27.5468 | 9.0102 | 1.83400 | 37.21 | S-LAH60V.OHARA | |
| 6 | −18.0047 | 2.0757 | 1.89286 | 20.36 | S-NPH4.OHARA | |
| 7 | −38.8908 | 0.0377 | | | | |
| 8 | 377.4398 | 5.2665 | 2.00272 | 19.32 | E-FDS2.HOYA | |
| 9 | −52.9366 | DD[9] | | | | |
| 10 | 30.1394 | 6.0644 | 1.43875 | 94.66 | S-FPL55.OHARA | |
| 11 | 138.3520 | DD[11] | | | | |
| 12 | 2889.2481 | 4.7910 | 1.88300 | 39.22 | H-ZLAF68N.CDGM | |
| 13 | −37.9151 | 0.8290 | 1.69895 | 30.13 | S-TIM35.OHARA | |
| 14 | 68.4762 | 2.6514 | | | | |
| 15 (St) | ∞ | DD[15] | | | | |
| 16 | −235.0120 | 4.8037 | 1.53775 | 74.70 | S-FPM3.OHARA | |
| 17 | −23.6731 | 0.7498 | 1.60401 | 20.80 | Plastic | |
| 18 | −21.8239 | 0.6824 | 1.69895 | 30.13 | S-TIM35.OHARA | |
| 19 | 59.1574 | 6.8024 | | | | |
| 20 | 36.5314 | 7.0330 | 1.49700 | 81.54 | S-FPL51.OHARA | |
| 21 | −52.1414 | 2.6983 | | | | |
| *22 | 81.6968 | 3.3102 | 1.95150 | 29.83 | MP-TAFD405.HOYA | 32.08 |
| *23 | −78.8553 | DD[23] | | | | 32.11 |
| *24 | −25.0861 | 0.8289 | 1.68948 | 31.02 | L-TIM28.OHARA | 31.94 |
| *25 | 37.1974 | 1.6105 | | | | 32.19 |
| *26 | 109.6147 | 2.0189 | 1.85135 | 40.10 | MC-TAFD305.HOYA | 31.82 |
| *27 | −42.3928 | 19.3900 | | | | 31.86 |

TABLE 14
Example 5

| | Infinite | Short Range |
|---|---|---|
| | Distance | 0.17 Times |
| Focal Length | 32.01 | — |
| Back Focus | 19.39 | 19.39 |
| Open F-Number | 1.44 | 1.46 |
| Maximum Full Angle of View [°] | 68.2 | 66.2 |
| DD[9] | 3.19 | 0.04 |
| DD[11] | 2.18 | 5.33 |
| DD[15] | 4.51 | 2.47 |
| DD[23] | 2.44 | 4.48 |

TABLE 15
Example 5

| Sn | 22 | 23 | 24 |
|---|---|---|---|
| KA | 1.0000000E+00 | 1.0000000E+00 | 1.0000000E+00 |
| A4 | −8.9520200E−06 | 9.9315096E−06 | 5.7714345E−05 |
| A6 | 3.6566802E−08 | −1.9210191E−08 | 3.8219751E−09 |
| A8 | −3.4456559E−10 | −1.3482245E−10 | −2.8979993E−10 |
| A10 | 7.7327800E−13 | 5.3483700E−13 | 4.6815282E−13 |

| Sn | 25 | 26 | 27 |
|---|---|---|---|
| KA | 1.0000000E+00 | 1.0000000E+00 | 1.0000000E+00 |
| A4 | −4.4991230E−05 | 2.0851230E−05 | 7.0378888E−05 |
| A6 | −1.3341281E−08 | −2.2010739E−07 | −9.1329591E−09 |
| A8 | −1.2268936E−10 | 3.1614401E−10 | −3.0068501E−10 |
| A10 | 5.1543693E−13 | 7.3312094E−14 | 3.8726005E−13 |

### Example 6

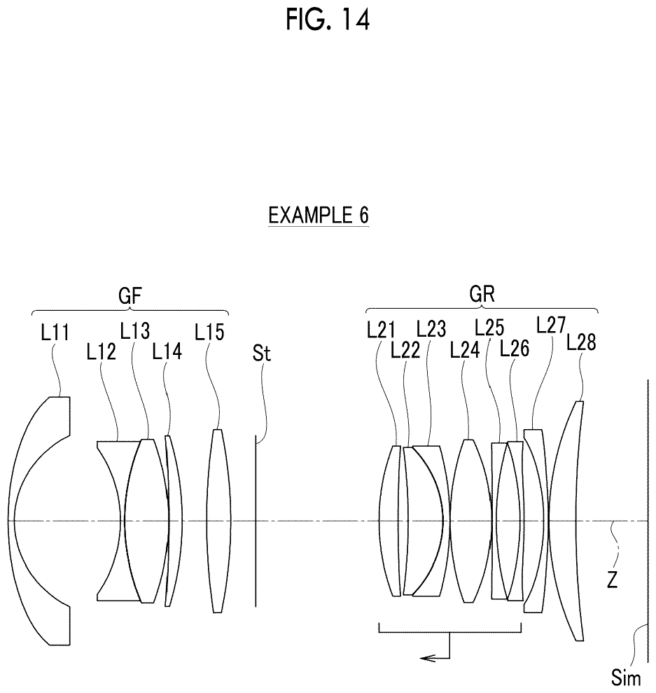

A cross-sectional view of a configuration of an imaging lens of Example 6 is illustrated in FIG. 14. The imaging lens of Example 6 consists of, in order from the object side to the image side, the front group GF having a positive refractive power, the aperture stop St, and the rear group GR having a positive refractive power. The front group GF consists of five lenses including the lenses L11 to L15 in order from the object side to the image side. The rear group GR consists of eight lenses including the lenses L21 to L28 in order from the object side to the image side. The imaging lens includes only one focus lens group. The focus lens group consists of the lenses L21 to L26. During the focusing from the infinite distance object to the short range object, the focus lens group moves to the object side.

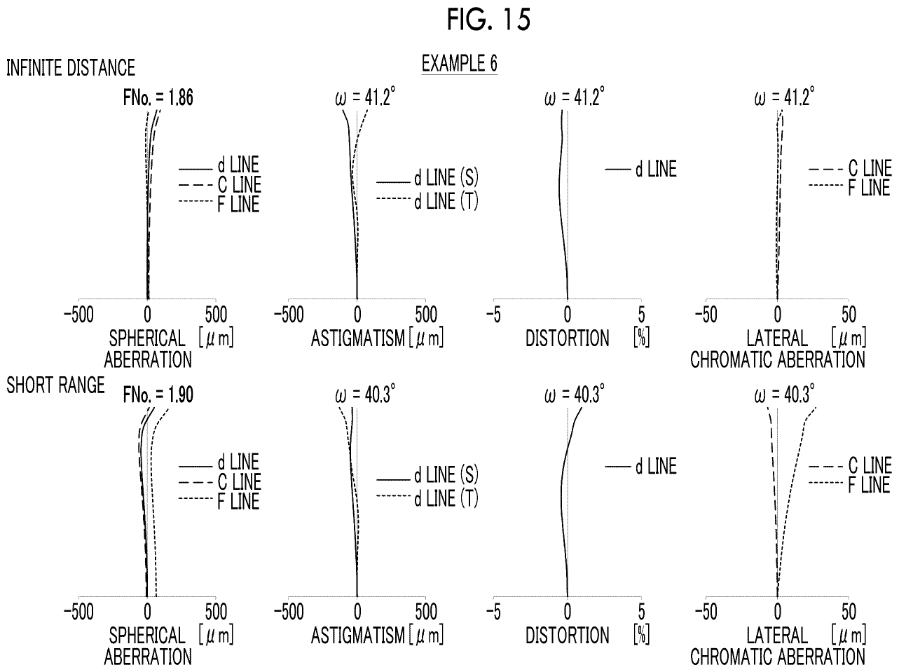

For the imaging lens of Example 6, Table 16 shows basic lens data, Table 17 shows specifications and a variable surface spacing, Table 18 shows aspherical coefficients, and FIG. 15 illustrates each aberration diagram.

TABLE 16
Example 6

| Sn | R | D | Nd | νd | Material | ED |
|---|---|---|---|---|---|---|
| *1 | 42.7283 | 0.9497 | 1.51633 | 64.06 | L-BSL7.OHARA | |
| *2 | 14.0986 | 16.1551 | | | | |
| 3 | −19.5119 | 0.6320 | 1.92286 | 18.90 | S-NPH2.OHARA | |
| 4 | 31.8054 | 6.6330 | 1.88300 | 39.22 | H-ZLAF68N.CDGM | |
| 5 | −35.8913 | 0.0396 | | | | |
| 6 | −168.6659 | 1.9999 | 1.60300 | 65.44 | S-PHM53.OHARA | |
| 7 | −44.7623 | 3.7224 | | | | |
| 8 | 93.4441 | 3.6667 | 2.10420 | 17.02 | E-FDS-W.HOYA | |
| 9 | −68.7959 | 3.7998 | | | | |
| 10 (St) | ∞ | DD[10] | | | | |
| 11 | 32.5539 | 2.8853 | 1.49700 | 81.54 | S-FPL51.OHARA | |
| 12 | 176.2760 | 1.5455 | | | | |
| 13 | −85.6752 | 5.2920 | 1.49700 | 81.54 | S-FPL51.OHARA | |
| 14 | −15.9635 | 1.0643 | 1.69895 | 30.13 | S-TIM35.OHARA | |
| 15 | −42.8118 | 0.0313 | | | | |
| 16 | 37.9463 | 6.2634 | 1.49700 | 81.54 | S-FPL51.OHARA | |
| 17 | −29.3977 | 0.0514 | | | | |
| 18 | −1027.5874 | 0.6195 | 1.84666 | 23.78 | S-TIH53W.OHARA | |
| 19 | 43.1440 | 3.6132 | | | | |
| *20 | −36.1465 | 0.6302 | 1.66121 | 20.35 | Plastic | 34.29 |
| *21 | −65.4365 | DD[21] | | | | 26.21 |
| *22 | −29.9494 | 0.6998 | 1.86100 | 37.10 | L-LAH94.OHARA | 23.46 |
| *23 | −72.8582 | 0.0999 | | | | 24.32 |
| 24 | 42.8112 | 4.0841 | 1.64000 | 60.08 | S-BSM81.OHARA | |
| 25 | 143.8830 | 10.9900 | | | | |

TABLE 17
Example 6

| | Infinite | Short Range |
|---|---|---|
| | Distance | 0.1 Times |
| Focal Length | 24.77 | — |
| Back Focus | 10.99 | 10.99 |
| Open F-Number | 1.86 | 1.90 |
| Maximum Full Angle of View [°] | 82.4 | 80.6 |
| DD[10] | 18.77 | 15.94 |
| DD[21] | 2.98 | 5.82 |

TABLE 18
Example 6

| Sn | 1 | 2 |
|---|---|---|
| KA | 1.0000000E+00 | 1.0000000E+00 |
| A4 | 1.5777886E−05 | 5.7798046E−06 |
| A6 | −8.3327236E−08 | −6.2735003E−08 |
| A8 | 4.1877997E−10 | −5.1624651E−10 |
| A10 | −1.0699444E−12 | 4.1638675E−12 |
| A12 | 1.4379269E−15 | −1.8844459E−14 |

| Sn | 20 | 21 | 22 | 23 |
|---|---|---|---|---|
| KA | 1.0000000E+00 | 1.0000000E+00 | 1.0000000E+00 | 1.0000000E+00 |
| A4 | 1.3227111E−05 | 5.0550915E−05 | 1.4330973E−05 | 1.6522092E−05 |
| A6 | 1.0592029E−07 | 7.0415213E−08 | −1.3545777E−08 | 6.6094779E−08 |
| A8 | −1.4586433E−09 | −1.0083235E−09 | −6.7183726E−10 | −8.3657843E−10 |
| A10 | 2.1639264E−12 | 1.8218409E−12 | 1.6641741E−14 | 1.5851383E−12 |

### Example 7

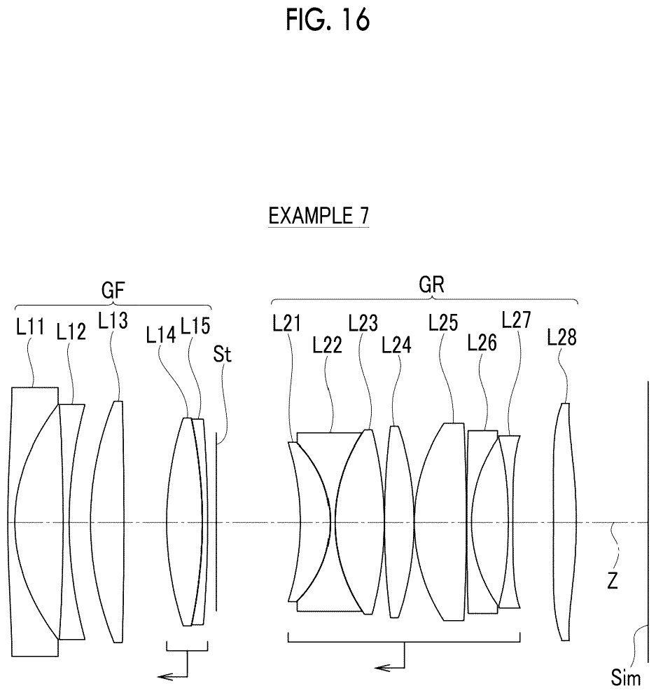

A cross-sectional view of a configuration of an imaging lens of Example 7 is illustrated in FIG. 16. The imaging lens of Example 7 consists of, in order from the object side to the image side, the front group GF having a positive refractive power, the aperture stop St, and the rear group GR having a positive refractive power. The front group GF consists of five lenses including the lenses L11 to L15 in order from the object side to the image side. The rear group GR consists of eight lenses including the lenses L21 to L28 in order from the object side to the image side. The imaging lens includes only two focus lens groups. Out of the two focus lens groups, the focus lens group on the object side consists of the lenses L14 and L15, and the focus lens group on the image side consists of the lenses L21 to L27. During the focusing from the infinite distance object to the short range object, the focus lens group on the object side and the focus lens group on the image side move to the object side by changing the mutual spacing.

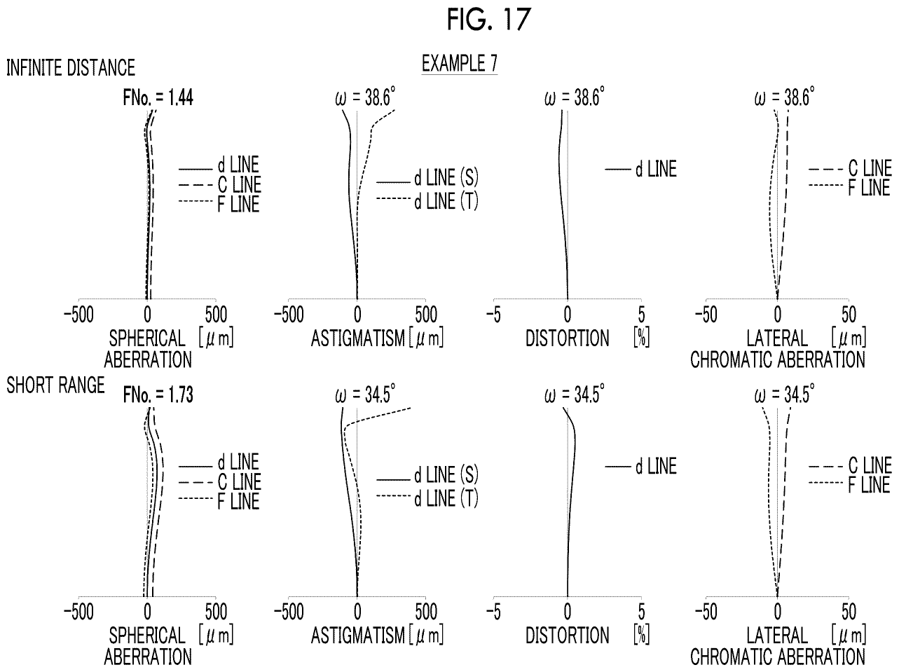

For the imaging lens of Example 7, Table 19 shows basic lens data, Table 20 shows specifications and a variable surface spacing, Table 21 shows aspherical coefficients, and FIG. 17 illustrates each aberration diagram.

TABLE 19
Example 7

| Sn | R | D | Nd | νd | Material | ED |
|---|---|---|---|---|---|---|
| *1 | 175.1904 | 1.0619 | 1.86100 | 37.10 | L-LAH94.OHARA | |
| *2 | 25.5845 | 7.4067 | | | | |
| 3 | −286.4481 | 0.9311 | 1.43875 | 94.66 | S-FPL55.OHARA | |
| 4 | 68.6068 | 3.2721 | | | | |
| 5 | 49.5354 | 5.1290 | 2.00100 | 29.14 | S-LAH99W.OHARA | |
| 6 | −682.3641 | DD[6] | | | | |
| 7 | 51.7823 | 5.4613 | 1.72916 | 54.68 | S-LAL18.OHARA | |
| 8 | −76.9544 | 0.8164 | 1.84666 | 23.78 | S-TIH53W.OHARA | |
| 9 | −187.9183 | DD[9] | | | | |
| 10 (St) | ∞ | DD[10] | | | | |
| 11 | −41.1903 | 4.5386 | 1.43875 | 94.66 | S-FPL55.OHARA | |
| 12 | −17.1984 | 0.7105 | 1.84666 | 23.78 | S-TIH53W.OHARA | |
| 13 | 24.7571 | 7.5119 | 1.77535 | 50.31 | H-LAK77.NHG | |
| 14 | −55.1330 | 0.0495 | | | | |
| 15 | 118.5984 | 4.5278 | 2.10420 | 17.02 | E-FDS3-W.HOYA | |
| 16 | −46.3807 | 0.0490 | | | | |
| 17 | 27.8054 | 7.9699 | 1.88300 | 39.22 | H-ZLAF68N.CDGM | |
| 18 | −298.5494 | 0.0695 | | | | |
| 19 | 486.6578 | 0.7280 | 1.89286 | 20.36 | S-NPH4.OHARA | |
| 20 | 22.5641 | 5.6326 | | | | |
| *21 | −86.6609 | 0.6856 | 1.68948 | 31.02 | L-TIM28.OHARA | 25.59 |
| *22 | 362.0051 | DD[22] | | | | 26.50 |
| *23 | −850.1384 | 3.4999 | 1.51633 | 64.06 | L-BSL7.OHARA | 36.20 |
| *24 | −79.6058 | 11.0000 | | | | 36.57 |

TABLE 20
Example 7

| | Infinite | Short Range |
|---|---|---|
| | Distance | 0.2 Times |
| Focal Length | 27.20 | — |
| Back Focus | 11.00 | 11.00 |
| Open F-Number | 1.44 | 1.73 |
| Maximum Full Angle of View [°] | 77.2 | 69.0 |
| DD[6] | 6.55 | 0.80 |
| DD[9] | 1.33 | 7.08 |
| DD[10] | 12.88 | 5.81 |
| DD[22] | 6.23 | 13.30 |

TABLE 21
Example 7

| Sn | 1 | 2 |
|---|---|---|
| KA | 1.0000000E+00 | 1.0000000E+00 |
| A4 | −4.2168810E−06 | −5.3446475E−06 |
| A6 | 2.6904566E−09 | −6.2277244E−09 |
| A8 | 1.7060065E−12 | 3.3893822E−13 |
| A10 | −1.0190040E−14 | −2.0359707E−14 |
| A12 | 9.9405200E−18 | 0.0000000E+00 |

| Sn | 21 | 22 | 23 | 24 |
|---|---|---|---|---|
| KA | 1.0000000E+00 | 1.0000000E+00 | 1.0000000E+00 | 1.0000000E+00 |
| A4 | −2.9644179E−05 | 7.7719185E−06 | 3.4385589E−06 | 1.0481518E−06 |
| A6 | 1.2507619E−07 | 1.7009736E−07 | 4.1275567E−08 | 3.3063347E−08 |
| A8 | −3.9306515E−10 | −3.1792882E−10 | −3.2394873E−11 | −2.4676171E−11 |
| A10 | 3.2230400E−13 | 0.0000000E+00 | 0.0000000E+00 | 0.0000000E+00 |

### Example 8

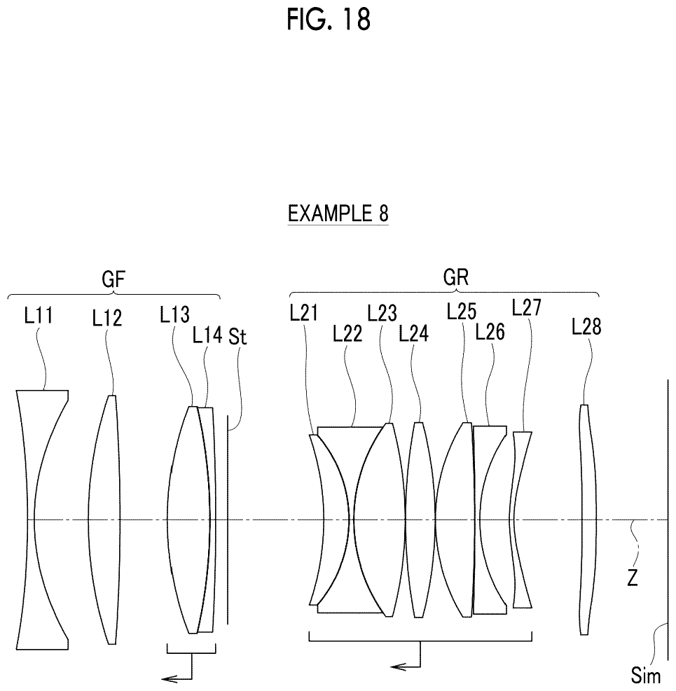

A cross-sectional view of a configuration of an imaging lens of Example 8 is illustrated in FIG. 18. The imaging lens of Example 8 consists of, in order from the object side to the image side, the front group GF having a positive refractive power, the aperture stop St, and the rear group GR having a positive refractive power. The front group GF consists of four lenses including the lenses L11 to L14 in order from the object side to the image side. The rear group GR consists of eight lenses including the lenses L21 to L28 in order from the object side to the image side. The imaging lens includes only two focus lens groups. Out of the two focus lens groups, the focus lens group on the object side consists of the lenses L13 and L14, and the focus lens group on the image side consists of the lenses L21 to L27. During the focusing from the infinite distance object to the short range object, the focus lens group on the object side and the focus lens group on the image side move to the object side by changing the mutual spacing.

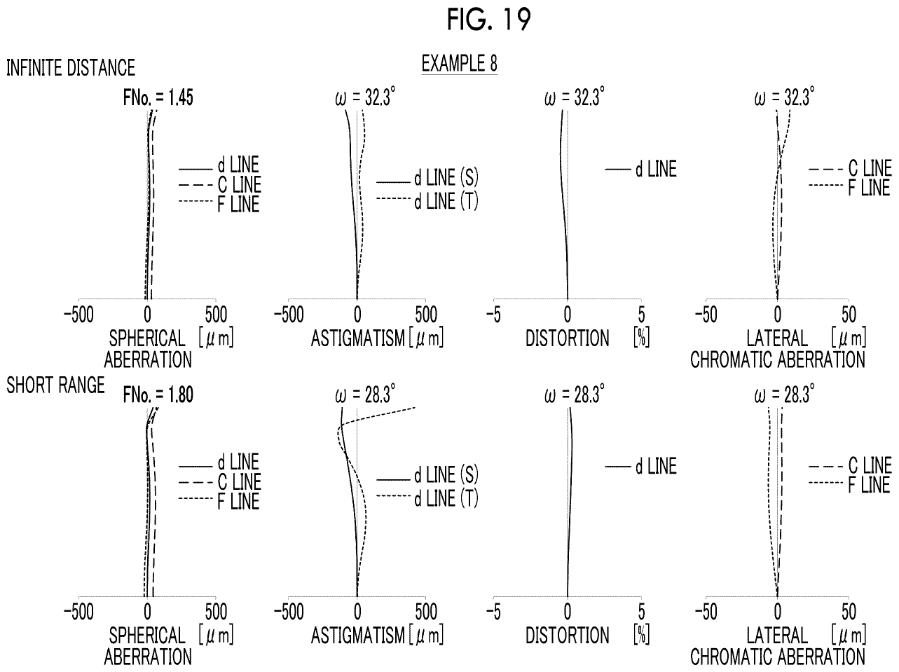

For the imaging lens of Example 8, Table 22 shows basic lens data, Table 23 shows specifications and a variable surface spacing, Table 24 shows aspherical coefficients, and FIG. 19 illustrates each aberration diagram.

TABLE 22
Example 8

| Sn | R | D | Nd | νd | Material | ED |
|---|---|---|---|---|---|---|
| *1 | −125.4742 | 1.0251 | 1.86100 | 37.10 | L-LAH94.OHARA | |
| *2 | 33.2176 | 8.2914 | | | | |
| 3 | 60.9089 | 4.8654 | 2.00330 | 28.27 | S-LAH79.OHARA | |
| 4 | −270.1556 | DD[4] | | | | |
| 5 | 49.1999 | 6.4585 | 1.77535 | 50.31 | H-LAK77.NHG | |
| 6 | −78.7894 | 0.8907 | 1.84666 | 23.78 | S-TIH53W.OHARA | |
| 7 | −313.8274 | DD[7] | | | | |
| 8 (St) | ∞ | DD[8] | | | | |
| 9 | −39.9515 | 3.8708 | 1.43875 | 94.66 | S-FPL55.OHARA | |
| 10 | −20.1136 | 0.7394 | 1.84666 | 23.78 | S-TIH53W.OHARA | |
| 11 | 25.0947 | 7.8772 | 1.77535 | 50.31 | H-LAK77.NHG | |
| 12 | −58.2342 | 0.0499 | | | | |
| 13 | 80.8761 | 4.5443 | 2.10420 | 17.02 | E-FDS3-W.HOYA | |
| 14 | −59.6385 | 0.0494 | | | | |
| 15 | 28.8601 | 5.9989 | 1.83481 | 42.74 | S-LAH55VS.OHARA | |
| 16 | −238.1937 | 0.0485 | | | | |
| 17 | −465.8417 | 0.7498 | 1.84666 | 23.78 | S-TIH53W.OHARA | |
| 18 | 23.6474 | 4.4539 | | | | |
| *19 | 26.3713 | 0.7020 | 1.68948 | 31.02 | L-TIM28.OHARA | 26.50 |
| *20 | 19.7818 | DD[20] | | | | 27.14 |
| *21 | −2499.9999 | 2.1803 | 1.51633 | 64.06 | L-BSL7.OHARA | 35.00 |
| *22 | −272.8006 | 11.0000 | | | | 35.47 |

TABLE 23
Example 8

| | Infinite | Short Range |
|---|---|---|
| | Distance | 0.2 Times |
| Focal Length | 34.30 | — |
| Back Focus | 11.00 | 11.00 |
| Open F-Number | 1.45 | 1.80 |
| Maximum Full Angle of View [°] | 64.6 | 56.6 |
| DD[4] | 7.24 | 0.80 |
| DD[7] | 1.83 | 8.27 |
| DD[8] | 14.74 | 6.42 |
| DD[20] | 10.44 | 18.76 |

TABLE 24
Example 8

| Sn | 1 | 2 |
|---|---|---|
| KA | 1.0000000E+00 | 1.0000000E+00 |
| A4 | −5.0727765E−07 | −2.2266630E−06 |
| A6 | −2.0389507E−09 | −5.5366476E−09 |
| A8 | 7.3171674E−12 | 5.5967335E−12 |
| A10 | −1.3591213E−14 | −6.6003787E−15 |
| A12 | 9.9405200E−18 | 0.0000000E+00 |

| Sn | 19 | 20 | 21 | 22 |
|---|---|---|---|---|
| KA | 1.0000000E+00 | 1.0000000E+00 | 1.0000000E+00 | 1.0000000E+00 |
| A4 | −1.4026830E−04 | −1.2790154E−04 | −2.7930862E−05 | −2.9942083E−05 |
| A6 | 3.3986280E−07 | 3.8206818E−07 | 1.1404824E−07 | 8.8063721E−08 |
| A8 | −5.8686250E−10 | −6.0511434E−10 | −8.9600446E−11 | −4.9322212E−11 |
| A10 | 3.2230400E−13 | 0.0000000E+00 | 0.0000000E+00 | 0.0000000E+00 |

### Example 9

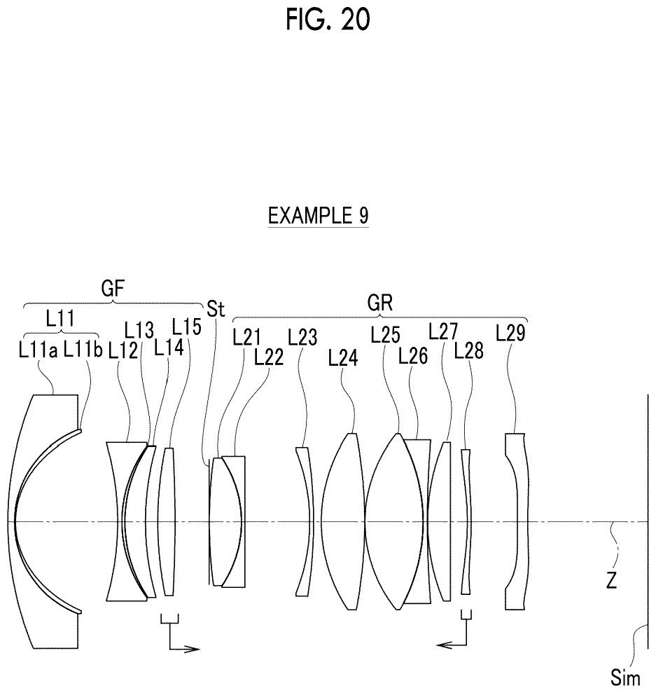

A cross-sectional view of a configuration of an imaging lens of Example 9 is illustrated in FIG. 20. The imaging lens of Example 9 consists of, in order from the object side to the image side, the front group GF having a negative refractive power, the aperture stop St, and the rear group GR having a positive refractive power. The front group GF consists of five lenses including the lenses L11 to L15 in order from the object side to the image side. The lens L11 is a compound aspherical lens in which a resin L11b of which a surface in contact with air has an aspherical shape is formed on a spherical surface of a lens L11a made of glass. The rear group GR consists of nine lenses including lenses L21 to L29 in order from the object side to the image side. The imaging lens includes only two focus lens groups. Out of the two focus lens groups, the focus lens group on the object side consists of the lens L15, and the focus lens group on the image side consists of the lens L28. During the focusing from the infinite distance object to the short range object, the focus lens group on the object side moves to the image side, and the focus lens group on the image side moves to the object side.

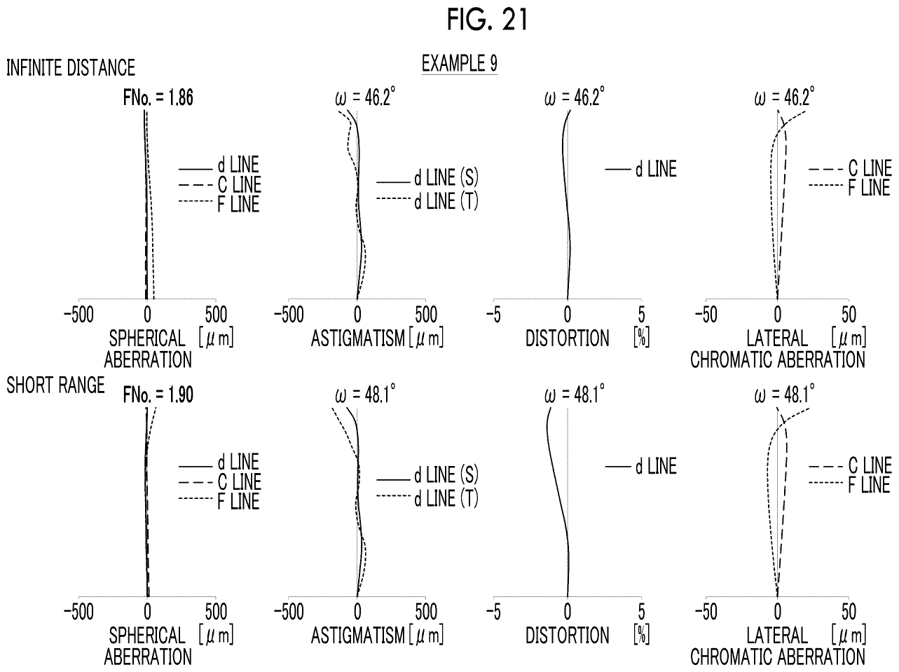

For the imaging lens of Example 9, Table 25 shows basic lens data, Table 26 shows specifications and a variable surface spacing, Tables 27A and 27B show aspherical coefficients, and FIG. 21 illustrates each aberration diagram.

TABLE 25
Example 9

| Sn | R | D | Nd | νd | Material | ED |
|---|---|---|---|---|---|---|
| 1 | 56.1178 | 1.1322 | 1.48749 | 70.24 | S-FSL5.OHARA | |
| 2 | 16.8026 | 0.1498 | 1.51380 | 52.97 | Plastic | |
| *3 | 13.8605 | 17.3645 | | | | |
| 4 | −47.7839 | 0.7241 | 1.59522 | 67.73 | S-FPM2.OHARA | |
| 5 | 21.7990 | 0.5000 | 1.54493 | 25.30 | Plastic | |
| 6 | 23.4073 | 3.4904 | 1.84666 | 23.78 | S-TIH53W.OHARA | |
| 7 | 46.9097 | DD[7] | | | | |
| 8 | 63.8350 | 2.8230 | 1.88300 | 39.22 | H-ZLAF68N.CDGM | |
| 9 | −225.3367 | DD[9] | | | | |
| 10 (St) | ∞ | 0.0488 | | | | |
| 11 | 81.0878 | 5.4595 | 1.59522 | 67.73 | S-FPM2.OHARA | |
| 12 | −19.6610 | 0.5823 | 1.59551 | 39.24 | S-TIM8.OHARA | |
| 13 | 11946.3618 | 11.0041 | | | | |
| 14 | −32.9614 | 0.6576 | 1.92286 | 18.90 | S-NPH2.OHARA | |
| 15 | −81.1320 | 1.3131 | | | | |
| 16 | 27.2582 | 7.3674 | 1.53775 | 74.70 | S-FPM3.OHARA | |
| 17 | −79.2484 | 0.0493 | | | | |
| 18 | 23.8626 | 9.8668 | 1.43875 | 94.66 | S-FPL55.OHARA | |
| 19 | −30.6089 | 0.7211 | 1.85478 | 24.80 | S-NBH56.OHARA | |
| 20 | 172.7749 | 0.0494 | | | | |
| 21 | 35.3861 | 3.8796 | 1.98613 | 16.48 | FDS16-W.HOYA | |
| 22 | 4978.3170 | DD[22] | | | | |
| *23 | −44.3241 | 0.6410 | 1.85135 | 40.10 | M-TAFD305.HOYA | 24.69 |
| *24 | −60.8714 | DD[24] | | | | 24.00 |
| *25 | 3917.3322 | 1.7418 | 1.95150 | 29.83 | M-TAFD405.HOYA | 22.91 |
| *26 | 91.4402 | 20.4000 | | | | 24.90 |

TABLE 26
Example 9

| | Infinite | Short Range |
|---|---|---|
| | Distance | 0.18 Times |
| Focal Length | 20.69 | — |
| Back Focus | 20.40 | 20.40 |
| Open F-Number | 1.86 | 1.90 |
| Maximum Full Angle of View [°] | 92.4 | 96.2 |
| DD[7] | 2.10 | 5.77 |
| DD[9] | 5.77 | 2.10 |
| DD[22] | 2.86 | 2.10 |
| DD[24] | 7.77 | 8.54 |

TABLE 27A
Example 9

| Sn | 3 | 23 | 24 |
|---|---|---|---|
| KA | −1.0000000E+00 | 1.0000000E+00 | 1.0000000E+00 |
| A3 | 0.0000000E+00 | 0.0000000E+00 | 0.0000000E+00 |
| A4 | 7.3312727E−05 | 2.9446252E−05 | 5.1026223E−05 |
| A5 | 4.6207035E−07 | 1.6600992E−07 | 1.5045373E−06 |
| A6 | −8.6372566E−08 | −8.5661731E−08 | −3.4402415E−07 |
| A7 | 1.2934027E−09 | −1.2119114E−09 | −1.4311993E−09 |
| A8 | 1.1761842E−10 | 1.6601734E−09 | 3.1619262E−09 |
| A9 | 7.2353185E−12 | 4.3177961E−12 | −2.4989833E−13 |
| A10 | 3.5433586E−13 | −8.8883406E−12 | −1.6078442E−11 |
| A11 | 8.4182226E−15 | 2.4681852E−14 | 4.0646297E−14 |
| A12 | 1.4644189E−16 | 1.3646500E−15 | 5.3561641E−15 |
| A13 | −1.0395564E−17 | 1.3639435E−16 | 7.7428370E−16 |
| A14 | −1.0593020E−18 | 1.1013994E−17 | 7.4115468E−17 |
| A15 | −7.6793480E−20 | 1.8344398E−18 | 4.4715818E−18 |
| A16 | −4.9469129E−21 | 2.3964514E−19 | 2.1795990E−19 |
| A17 | −2.6545553E−22 | 1.1797722E−20 | −2.3676864E−20 |
| A18 | −2.0841156E−24 | −5.8730683E−22 | −1.9856838E−22 |
| A19 | 1.7792975E−24 | −8.3518930E−23 | −3.6727551E−22 |
| A20 | 3.2399484E−25 | 6.0968698E−26 | 2.0934204E−23 |

TABLE 27B
Example 9

| Sn | 25 | 26 |
|---|---|---|
| KA | 1.0000000E+00 | 1.0000000E+00 |
| A3 | 0.0000000E+00 | 0.0000000E+00 |
| A4 | −7.3263743E−05 | −2.7800878E−05 |
| A5 | 7.9265345E−07 | −3.6035532E−06 |
| A6 | −8.2046620E−07 | −3.4128977E−07 |
| A7 | −8.2031628E−10 | 1.0633774E−08 |
| A8 | 3.8629679E−09 | 2.9397392E−09 |
| A9 | 1.4998760E−11 | 7.3874950E−12 |
| A10 | −9.5828930E−12 | −6.6163481E−12 |
| A11 | 1.0573106E−13 | −3.2974352E−14 |
| A12 | 6.5599552E−15 | −5.3842408E−16 |
| A13 | 3.3227060E−16 | 1.8084089E−16 |
| A14 | −2.5206052E−18 | 2.3061609E−17 |
| A15 | −3.4526280E−18 | 6.2862022E−19 |
| A16 | −4.5746628E−19 | 2.5580398E−19 |
| A17 | −1.6626000E−20 | −1.8051245E−21 |
| A18 | 1.5446186E−20 | −5.4414372E−21 |
| A19 | −8.6894860E−22 | 2.3207668E−22 |
| A20 | 5.2390937E−24 | 2.6457697E−24 |

### Example 10

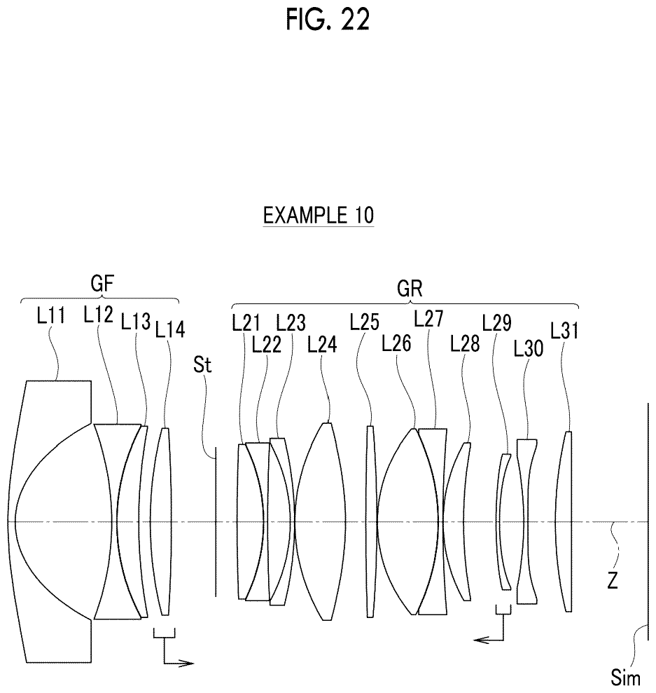

A cross-sectional view of a configuration of an imaging lens of Example 10 is illustrated in FIG. 22. The imaging lens of Example 10 consists of, in order from the object side to the image side, the front group GF having a negative refractive power, the aperture stop St, and the rear group GR having a positive refractive power. The front group GF consists of four lenses including the lenses L11 to L14 in order from the object side to the image side. The rear group GR consists of 11 lenses including lenses L21 to L31 in order from the object side to the image side. The imaging lens includes only two focus lens groups. Out of the two focus lens groups, the focus lens group on the object side consists of the lens L14, and the focus lens group on the image side consists of the lens L29. During the focusing from the infinite distance object to the short range object, the focus lens group on the object side moves to the image side, and the focus lens group on the image side moves to the object side.

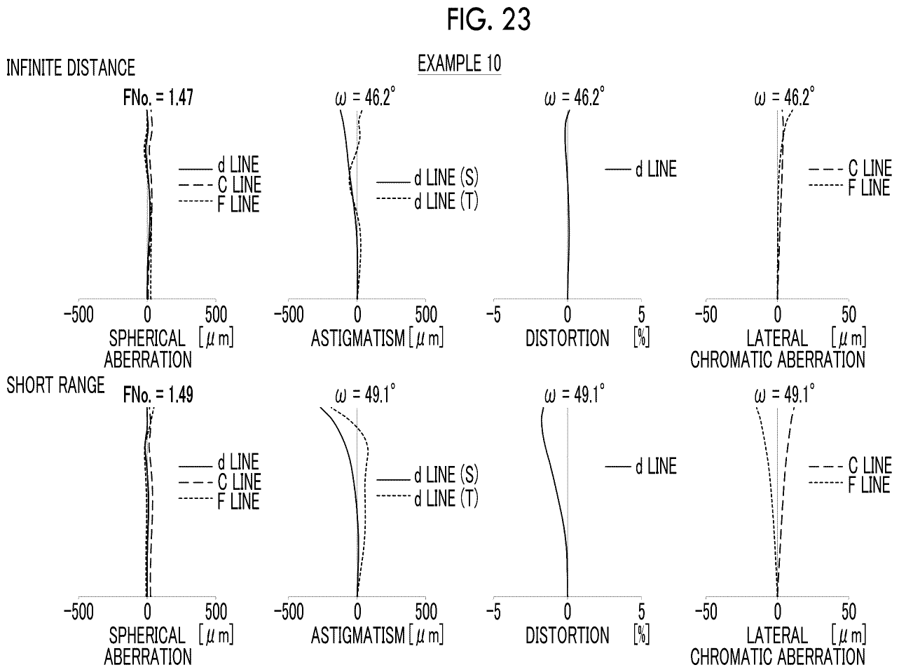

For the imaging lens of Example 10, Table 28 shows basic lens data, Table 29 shows specifications and a variable surface spacing, Tables 30A and 30B show aspherical coefficients, and FIG. 23 illustrates each aberration diagram.

TABLE 28
Example 10

| Sn | R | D | Nd | νd | Material | ED |
|---|---|---|---|---|---|---|
| *1 | 68.2641 | 1.3175 | 1.48749 | 70.24 | S-FSL5.OHARA | |
| *2 | 14.2401 | 17.5820 | | | | |
| 3 | −50.6826 | 0.9285 | 1.52841 | 76.45 | S-FPM4.OHARA | |
| 4 | 36.8736 | 3.9824 | 1.84666 | 23.78 | S-TIH53W.OHARA | |
| 5 | 92.5960 | DD[5] | | | | |
| 6 | 69.4795 | 3.8479 | 1.88300 | 39.22 | H-ZLAF68N.CDGM | |
| 7 | −280.5204 | DD[7] | | | | |
| 8 (St) | ∞ | 3.8453 | | | | |
| 9 | 347.2648 | 4.8224 | 1.49700 | 81.54 | S-FPL51.OHARA | |
| 10 | −32.2103 | 0.7554 | 1.54814 | 45.78 | S-TIL1.OHARA | |
| 11 | 319.3595 | 4.1106 | | | | |
| 12 | −30.3399 | 0.7878 | 1.92286 | 18.90 | S-NPH2.OHARA | |
| 13 | −63.0056 | 0.0481 | | | | |
| *14 | 33.4729 | 9.1076 | 1.53775 | 74.70 | S-FPM3.OHARA | 36.00 |
| *15 | −55.6320 | 3.7203 | | | | 36.09 |
| 16 | 563.6059 | 2.0000 | 1.48749 | 70.24 | S-FSL5.OHARA | |
| 17 | −223.1874 | 0.1000 | | | | |
| 18 | 26.3230 | 11.0751 | 1.49700 | 81.54 | S-FPL51.OHARA | |
| 19 | −37.3974 | 0.8499 | 1.84666 | 23.78 | S-TIH53W.OHARA | |
| 20 | 199.8996 | 0.0463 | | | | |
| 21 | 29.3852 | 3.7228 | 1.98613 | 16.48 | FDS16-W.HOYA | |
| 22 | 77.9687 | DD[22] | | | | |
| *23 | 78.7017 | 0.6459 | 1.85135 | 40.10 | M-TAFD305.HOYA | 24.89 |
| *24 | 50.2911 | DD[24] | | | | 24.00 |
| *25 | −51.2655 | 0.7499 | 1.95150 | 29.83 | M-TAFD405.HOYA | 24.00 |
| *26 | −1034.0353 | 5.0000 | | | | 24.66 |
| 27 | 71.3953 | 2.9596 | 1.75500 | 52.32 | S-LAH97.OHARA | |
| 28 | ∞ | 13.9400 | | | | |

TABLE 29
Example 10

| | Infinite | Short Range |
|---|---|---|
| | Distance | 0.18 Times |
| Focal Length | 20.70 | — |
| Back Focus | 13.94 | 13.94 |
| Open F-Number | 1.47 | 1.49 |
| Maximum Full Angle of View [°] | 92.4 | 98.2 |
| DD[5] | 2.10 | 8.12 |
| DD[7] | 8.12 | 2.10 |
| DD[22] | 5.91 | 4.48 |
| DD[24] | 4.41 | 5.84 |

TABLE 30A
Example 10

| Sn | 1 | 14 | 15 |
|---|---|---|---|
| KA | 1.0000000E+00 | 1.0000000E+00 | 1.0000000E+00 |
| A4 | −5.2788977E−06 | −2.0866833E−06 | 3.2405509E−06 |
| A6 | 3.5049683E−09 | 3.9715645E−09 | 2.8148398E−09 |
| A8 | −2.6569393E−12 | −1.1274417E−11 | −2.4076003E−12 |
| A10 | 1.0865570E−15 | 1.1787285E−14 | −5.0230490E−17 |
| Sn | 2 | 23 | 24 |
| KA | −1.0000000E+00 | 1.0000000E+00 | 1.0000000E+00 |
| A3 | 0.0000000E+00 | 0.0000000E+00 | 0.0000000E+00 |
| A4 | 6.0710948E−05 | 1.0538366E−05 | 2.6152233E−05 |
| A5 | −2.1865468E−07 | −6.8517198E−07 | 6.1710934E−07 |
| A6 | −5.7707817E−08 | −1.2074727E−07 | −2.8141456E−07 |
| A7 | 3.3193302E−10 | 1.0876923E−09 | 4.8425499E−10 |
| A8 | 3.0820569E−11 | 1.8239582E−09 | 3.1862990E−09 |
| A9 | 2.3211016E−12 | 1.2857339E−11 | −2.3501830E−12 |
| A10 | 1.4539812E−13 | −8.4086713E−12 | −1.6138262E−11 |
| A11 | 2.8261000E−15 | 4.5831405E−14 | 7.1673305E−14 |
| A12 | 1.3617395E−16 | 1.6329110E−15 | 1.1078300E−14 |
| A13 | −1.0350937E−17 | 6.9037779E−17 | 1.3660950E−15 |
| A14 | −1.9244641E−18 | 6.7409202E−19 | 1.1431772E−16 |
| A15 | −1.0751223E−19 | 8.6094181E−19 | 5.5288955E−18 |
| A16 | −9.6258759E−24 | 1.6041994E−19 | 2.0210367E−20 |
| A17 | 3.2234659E−22 | 5.2019219E−21 | −6.6413800E−20 |
| A18 | 1.7769211E−23 | −1.1249032E−21 | −4.6918925E−21 |
| A19 | 8.3975387E−26 | 7.2891520E−24 | −5.1840799E−22 |
| A20 | −4.1811153E−26 | 2.1544895E−24 | 6.8007581E−23 |

TABLE 30B
Example 10

| Sn | 25 | 26 |
|---|---|---|
| KA | 1.0000000E+00 | 1.0000000E+00 |
| A3 | 0.0000000E+00 | 0.0000000E+00 |
| A4 | 3.8562362E−05 | 7.6038643E−05 |
| A5 | 2.1904653E−06 | −3.7092395E−07 |
| A6 | −7.2434140E−07 | −4.5102151E−07 |
| A7 | 1.4982789E−10 | 5.2039214E−09 |
| A8 | 3.7498834E−09 | 2.7826738E−09 |
| A9 | 6.0291605E−12 | −4.4002924E−13 |
| A10 | −1.0260445E−11 | −7.3576115E−12 |
| A11 | 3.6651658E−14 | −9.6485861E−14 |
| A12 | −7.0019885E−16 | −3.7596068E−15 |
| A13 | −2.8559269E−16 | 3.7285836E−17 |
| A14 | −2.9718033E−17 | 1.3906202E−17 |
| A15 | −1.2040584E−18 | −3.5828383E−19 |
| A16 | 4.9099743E−20 | 1.3436978E−19 |
| A17 | −2.2457930E−20 | 9.0532000E−21 |
| A18 | 9.4493643E−21 | −2.3742058E−22 |
| A19 | −1.6819586E−22 | 1.6732116E−22 |
| A20 | −1.8641945E−23 | −1.3818491E−23 |

### Example 11

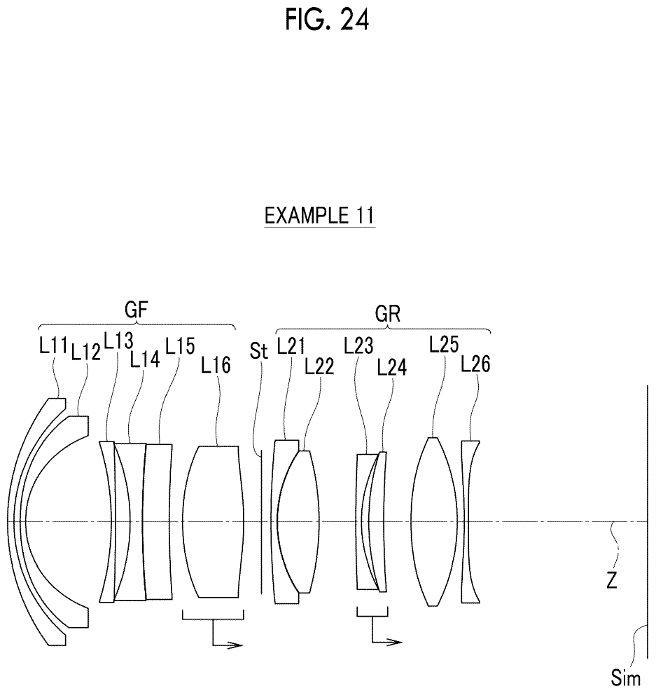

A cross-sectional view of a configuration of an imaging lens of Example 11 is illustrated in FIG. 24. The imaging lens of Example 11 consists of, in order from the object side to the image side, the front group GF having a positive refractive power, the aperture stop St, and the rear group GR having a positive refractive power. The front group GF consists of six lenses including the lenses L11 to L16 in order from the object side to the image side. The rear group GR consists of six lenses including the lenses L21 to L26 in order from the object side to the image side. The imaging lens includes only two focus lens groups. Out of the two focus lens groups, the focus lens group on the object side consists of the lens L16, and the focus lens group on the image side consists of the lenses L23 and L24. During the focusing from the infinite distance object to the short range object, the focus lens group on the object side and the focus lens group on the image side move to the image side by changing the mutual spacing.

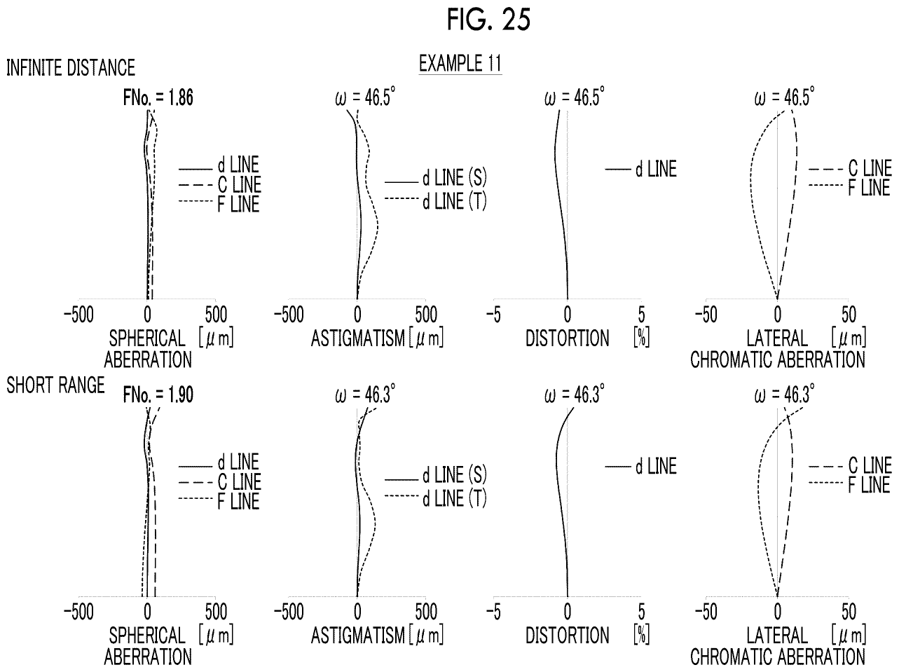

For the imaging lens of Example 11, Table 31 shows basic lens data, Table 32 shows specifications and a variable surface spacing, Table 33 shows aspherical coefficients, and FIG. 25 illustrates each aberration diagram.

TABLE 31
Example 11

| Sn | R | D | Nd | νd | Material | ED |
|---|---|---|---|---|---|---|
| 1 | 32.8862 | 0.9965 | 1.64000 | 60.08 | S-BSM81.OHARA | |
| 2 | 23.9001 | 1.0002 | | | | |
| *3 | 30.1350 | 0.8568 | 1.58913 | 61.15 | L-BAL35.OHARA | |
| *4 | 14.9975 | 13.5582 | | | | |
| 5 | −43.1199 | 0.6471 | 1.75500 | 52.32 | S-LAH97.OHARA | |
| 6 | −347.4126 | 2.3193 | | | | |
| 7 | −31.3951 | 1.9512 | 1.43875 | 94.66 | S-FPL55.OHARA | |
| 8 | 132.4578 | 4.1511 | 1.92286 | 18.90 | S-NPH2.OHARA | |
| 9 | 162.8618 | DD[9] | | | | |
| *10 | 31.2033 | 9.6529 | 1.80625 | 40.91 | L-LAH53.OHARA | |
| *11 | −47.8764 | DD[11] | | | | |
| 12 (St) | ∞ | 1.5066 | | | | |
| 13 | 128.5801 | 0.9998 | 1.76182 | 26.52 | S-TIH14.OHARA | |
| 14 | 20.3394 | 6.6146 | 1.60300 | 65.44 | S-PHM53.OHARA | |
| 15 | −42.4421 | DD[15] | | | | |
| *16 | 232.4429 | 0.8985 | 1.54436 | 56.03 | Plastic | |
| *17 | 21.8127 | 1.1536 | | | | |
| 18 | 36.6186 | 2.3682 | 1.49700 | 81.54 | S-FPL51.OHARA | |
| 19 | 146.3089 | DD[19] | | | | |
| *20 | 44.1573 | 7.3105 | 1.59522 | 67.73 | S-FPM2.OHARA | 26.40 |
| *21 | −30.3584 | 1.1122 | | | | 26.72 |
| *22 | −77.8622 | 0.6644 | 1.83220 | 40.10 | L-LAH90.OHARA | 25.66 |
| *23 | −1375.5304 | 28.2300 | | | | 25.14 |

TABLE 32
Example 11

| | Infinite | Short Range |
|---|---|---|
| Example | Distance | 0.12 Times |
| Focal Length | 20.64 | — |
| Back Focus | 28.23 | 28.23 |
| Open F-Number | 1.86 | 1.90 |
| Maximum Full Angle of View [°] | 93.0 | 92.6 |
| DD[9] | 2.10 | 2.82 |
| DD[11] | 2.82 | 2.09 |
| DD[15] | 5.80 | 8.03 |
| DD[19] | 4.32 | 2.09 |

TABLE 33
Example 11

| Sn | 3 | 4 | 10 | 11 |
|---|---|---|---|---|
| KA | 1.0000000E+00 | 1.0000000E+00 | 1.0000000E+00 | 1.0000000E+00 |
| A4 | 5.6909317E−05 | 4.7264012E−05 | −9.3286606E−07 | 2.2602025E−05 |
| A6 | −3.0754992E−07 | −1.7823746E−07 | 4.0069148E−08 | 4.3682444E−08 |
| A8 | 1.1773011E−09 | −9.6480784E−10 | 3.0684128E−10 | 3.2532462E−10 |
| A10 | −2.2353698E−13 | 1.4418647E−11 | −1.3908300E−12 | −1.9127404E−12 |
| A12 | −8.7976431E−15 | −3.9084767E−14 | 5.0407317E−15 | 1.3034678E−14 |
| A14 | 1.6274400E−17 | −4.5572300E−18 | 0.0000000E+00 | 0.0000000E+00 |

| Sn | 16 | 17 | 22 | 23 |
|---|---|---|---|---|
| KA | 1.0000000E+00 | 1.0000000E+00 | 1.0000000E+00 | 1.0000000E+00 |
| A4 | 5.5664368E−06 | 6.6373084E−07 | 2.2576476E−05 | 5.9576899E−05 |
| A6 | −4.1051770E−08 | −8.6997376E−08 | 7.5274177E−08 | 1.2991654E−07 |
| A8 | −3.5852275E−10 | −5.6470715E−11 | −7.5423623E−10 | −3.6525689E−10 |
| A10 | 1.2399108E−12 | 2.9074549E−13 | 2.1861255E−12 | −2.2089161E−14 |

| Sn | 20 | 21 |
|---|---|---|
| KA | 1.0000000E+00 | 1.0000000E+00 |
| A4 | 3.3652232E−05 | 2.4657630E−06 |
| A6 | −2.4049388E−08 | −7.8886673E−08 |
| A8 | −3.4914607E−10 | 4.9645680E−10 |
| A10 | 7.2138749E−13 | −1.0184865E−12 |
| A12 | −1.0236769E−15 | −2.8940752E−16 |

### Example 12

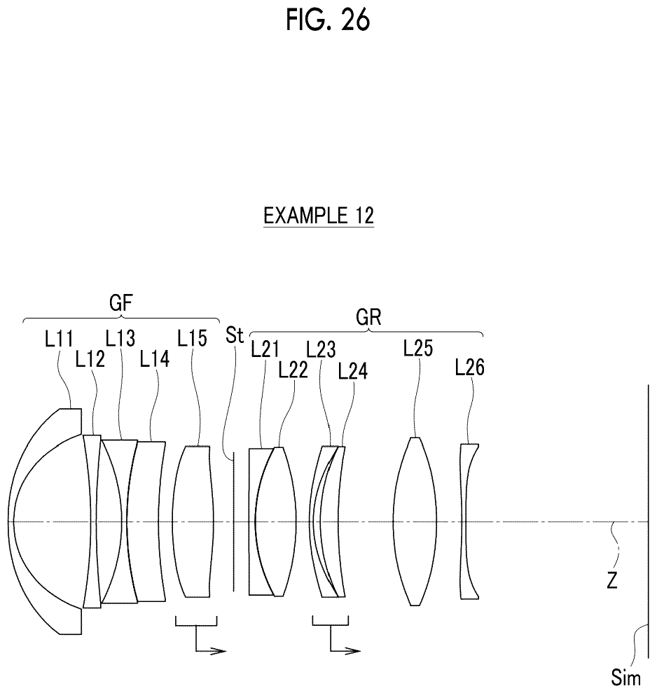

A cross-sectional view of a configuration of an imaging lens of Example 12 is illustrated in FIG. 26. The imaging lens of Example 12 consists of, in order from the object side to the image side, the front group GF having a negative refractive power, the aperture stop St, and the rear group GR having a positive refractive power. The front group GF consists of five lenses including the lenses L11 to L15 in order from the object side to the image side. The rear group GR consists of six lenses including the lenses L21 to L26 in order from the object side to the image side. The imaging lens includes only two focus lens groups. Out of the two focus lens groups, the focus lens group on the object side consists of the lens L15, and the focus lens group on the image side consists of the lenses L23 and L24. During the focusing from the infinite distance object to the short range object, the focus lens group on the object side and the focus lens group on the image side move to the image side by changing the mutual spacing.

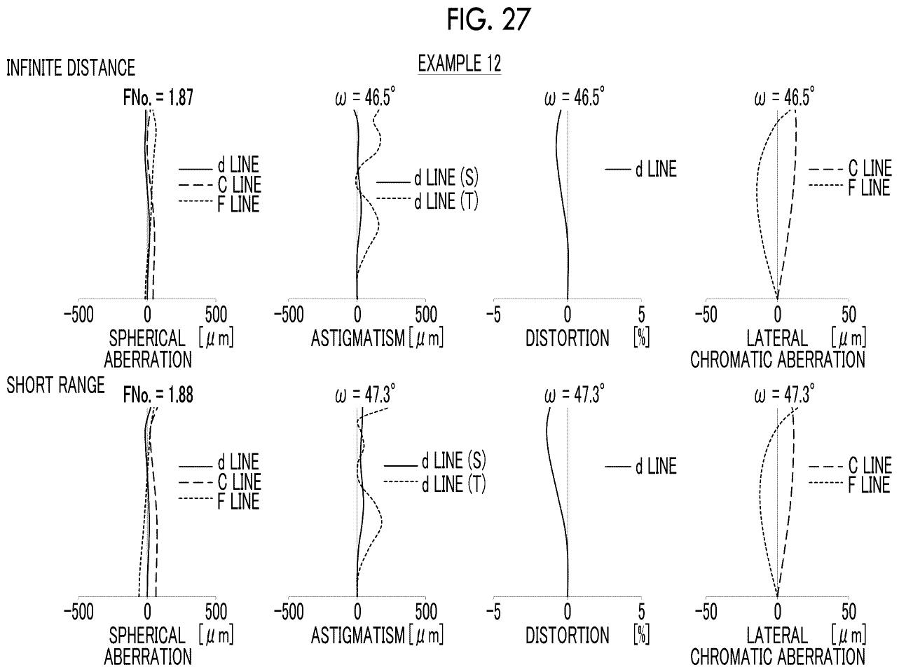

For the imaging lens of Example 12, Table 34 shows basic lens data, Table 35 shows specifications and a variable surface spacing, Table 36 shows aspherical coefficients, and FIG. 27 illustrates each aberration diagram.

TABLE 34
Example 12

| Sn | R | D | Nd | νd | Material | ED |
|---|---|---|---|---|---|---|
| *1 | 32.0417 | 0.8939 | 1.58913 | 61.15 | L-BAL35.OHARA | |
| *2 | 14.7008 | 12.1603 | | | | |
| 3 | −78.0374 | 0.8783 | 1.75500 | 52.32 | S-LAH97.OHARA | |
| 4 | 119.8448 | 4.0100 | | | | |
| 5 | −28.1974 | 0.8061 | 1.43875 | 94.66 | S-FPL55.OHARA | |
| 6 | 48.2057 | 5.0002 | 1.92286 | 18.90 | S-NPH2.OHARA | |
| 7 | 69.8906 | DD[7] | | | | |
| *8 | 43.7161 | 6.4932 | 1.80625 | 40.91 | L-LAH53.OHARA | |
| *9 | −50.9990 | DD[9] | | | | |
| 10 (St) | ∞ | 2.4001 | | | | |
| 11 | 1879.4090 | 0.9998 | 1.76182 | 26.52 | S-TIH14.OHARA | |
| 12 | 24.6185 | 6.4498 | 1.60300 | 65.44 | S-PHM53.OHARA | |
| 13 | −35.1119 | DD[13] | | | | |
| *14 | 33.2437 | 0.6184 | 1.54436 | 56.03 | Plastic | 24.00 |
| *15 | 18.2822 | 1.1181 | | | | 23.86 |
| 16 | 27.5636 | 2.7256 | 1.49700 | 81.54 | S-FPL51.OHARA | |
| 17 | 65.9665 | DD[17] | | | | |
| *18 | 37.9271 | 6.8377 | 1.59522 | 67.73 | S-FPM2.OHARA | 26.40 |
| *19 | −38.4686 | 3.9984 | | | | 26.61 |
| *20 | −86.2778 | 0.6379 | 1.83220 | 40.10 | L-LAH90.OHARA | 24.60 |
| *21 | 434.5357 | 28.8200 | | | | 23.89 |

TABLE 35
Example 12

| | Infinite | Short Range |
|---|---|---|
| | Distance | 0.12 Times |
| Focal Length | 20.64 | — |
| Back Focus | 28.82 | 28.82 |
| Open F-Number | 1.87 | 1.88 |
| Maximum Full Angle of View [°] | 93.0 | 94.6 |
| DD[7] | 2.20 | 3.30 |
| DD[9] | 3.20 | 2.10 |
| DD[13] | 2.09 | 5.57 |
| DD[17] | 8.70 | 5.22 |

TABLE 36
Example 12

| Sn | 1 | 2 | 8 | 9 |
|---|---|---|---|---|
| KA | 1.0000000E+00 | 1.0000000E+00 | 1.0000000E+00 | 1.0000000E+00 |
| A4 | 5.6375374E−05 | 4.3674990E−05 | 3.3919008E−06 | 2.2850559E−05 |
| A6 | −3.1042048E−07 | 3.4829007E−08 | 8.8794531E−08 | 9.4301199E−08 |
| A8 | 9.2150056E−10 | −4.0463092E−09 | 3.0389341E−10 | 2.2355726E−10 |
| A10 | 9.2863501E−13 | 3.1907432E−11 | −1.4866663E−12 | −3.3204657E−13 |
| A12 | −1.0523397E−14 | −7.6904208E−14 | 5.3224960E−15 | 6.1629912E−15 |
| A14 | 1.6274400E−17 | −4.5572300E−18 | 0.0000000E+00 | 0.0000000E+00 |

| Sn | 14 | 15 | 20 | 21 |
|---|---|---|---|---|
| KA | 1.0000000E+00 | 1.0000000E+00 | 1.0000000E+00 | 1.0000000E+00 |
| A4 | −1.2143153E−05 | −1.9584757E−05 | 2.1281487E−05 | 7.1942123E−05 |
| A6 | 3.6167083E−08 | −4.5693477E−08 | 1.4224257E−07 | 1.7163705E−07 |
| A8 | 4.8802846E−11 | 3.1954329E−10 | −4.4022959E−10 | 1.9716929E−10 |
| A10 | −1.9990106E−12 | −2.9622557E−12 | −8.9746378E−14 | −3.4004113E−12 |

| Sn | 18 | 19 |
|---|---|---|
| KA | 1.0000000E+00 | 1.0000000E+00 |
| A4 | 2.7388688E−05 | −7.9574204E−06 |
| A6 | −7.2104849E−08 | −6.8176946E−08 |
| A8 | −3.4164999E−10 | 4.7245419E−10 |
| A10 | 1.9028101E−12 | −8.5937913E−13 |
| A12 | −2.9167461E−15 | 2.0760774E−17 |

### Example 13

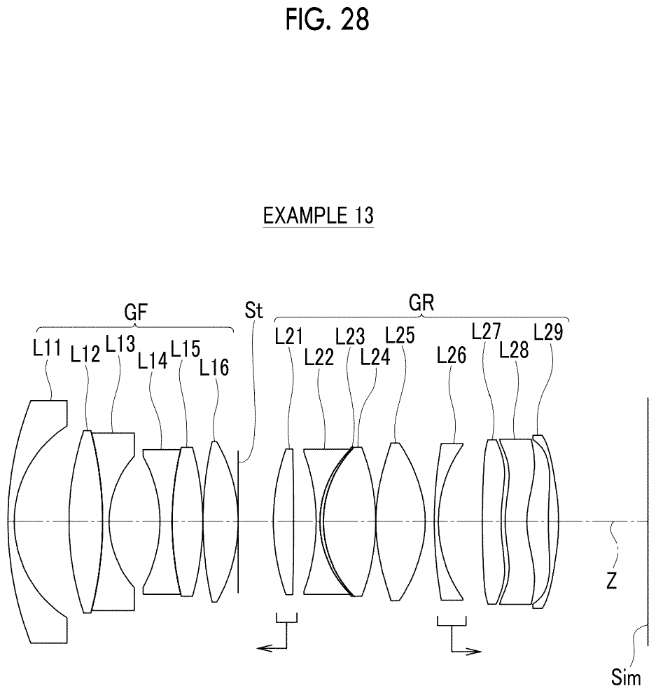

A cross-sectional view of a configuration of an imaging lens of Example 13 is illustrated in FIG. 28. The imaging lens of Example 13 consists of, in order from the object side to the image side, the front group GF having a positive refractive power, the aperture stop St, and the rear group GR having a positive refractive power. The front group GF consists of six lenses including the lenses L11 to L16 in order from the object side to the image side. The rear group GR consists of nine lenses including the lenses L21 to L29 in order from the object side to the image side. The imaging lens includes only two focus lens groups. Out of the two focus lens groups, the focus lens group on the object side consists of the lens L21, and the focus lens group on the image side consists of the lens L26. During the focusing from the infinite distance object to the short range object, the focus lens group on the object side moves to the object side, and the focus lens group on the image side moves to the image side.

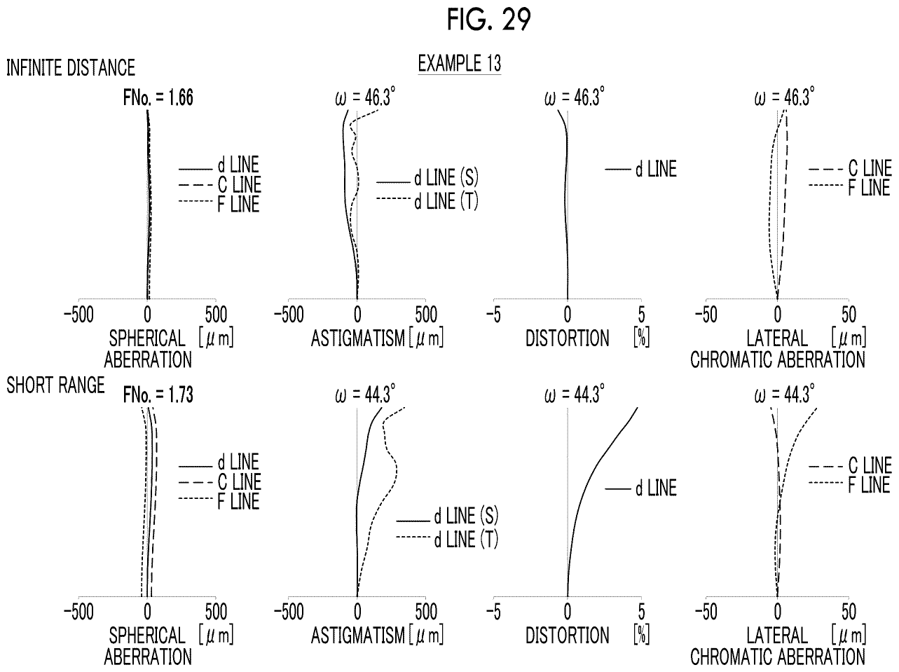

For the imaging lens of Example 13, Table 37 shows basic lens data, Table 38 shows specifications and a variable surface spacing, Table 39 shows aspherical coefficients, and FIG. 29 illustrates each aberration diagram.

TABLE 37
Example 13

| Sn | R | D | Nd | νd | Material | ED |
|---|---|---|---|---|---|---|
| 1 | 58.4795 | 1.0866 | 1.75500 | 52.32 | S-LAH97.OHARA | |
| 2 | 19.8738 | 9.5330 | | | | |
| 3 | 50.7145 | 5.8462 | 2.00330 | 28.27 | S-LAH79.OHARA | |
| 4 | −63.2055 | 1.1454 | 1.53775 | 74.70 | S-FPM3.OHARA | |
| 5 | 17.2714 | 8.8414 | | | | |
| 6 | −23.6353 | 2.0102 | 1.67270 | 32.10 | S-TIM25.OHARA | |
| 7 | 53.5613 | 5.3327 | 1.75500 | 52.32 | S-LAH97.OHARA | |
| 8 | −48.3836 | 0.0418 | | | | |
| 9 | 63.0122 | 6.1031 | 1.43875 | 94.66 | S-FPL55.OHARA | |
| 10 | −28.2361 | 0.0353 | | | | |
| 11 (St) | ∞ | DD[11] | | | | |
| 12 | 38.0442 | 3.5314 | 1.48749 | 70.24 | S-FSL5.OHARA | |
| 13 | −498.3927 | DD[13] | | | | |
| 14 | −35.5338 | 0.6553 | 1.65100 | 56.24 | S-LAL54Q.OHARA | |
| 15 | 17.6263 | 0.6000 | 1.54493 | 25.30 | Plastic | |
| 16 | 18.5812 | 9.0866 | 1.49700 | 81.54 | S-FPL51.OHARA | |
| 17 | −36.2663 | 0.0438 | | | | |
| *18 | 31.2518 | 8.5793 | 1.43875 | 94.66 | S-FPL55.OHARA | 27.00 |
| *19 | −19.4358 | DD[19] | | | | 27.57 |
| 20 | 77.6113 | 0.7078 | 1.48749 | 70.24 | S-FSL5.OHARA | |
| 21 | 23.2586 | DD[21] | | | | |
| *22 | 129.9990 | 3.1760 | 1.53409 | 55.87 | Plastic | 28.60 |
| *23 | 31.4437 | 0.7077 | | | | 28.75 |
| *24 | 22.7116 | 3.7821 | 1.53409 | 55.87 | Plastic | 28.60 |
| *25 | 16.2290 | 3.7475 | | | | 28.83 |
| *26 | 88.5379 | 1.7620 | 1.61881 | 63.85 | M-PCD4.HOYA | 28.80 |
| *27 | −34.5575 | 15.5400 | | | | 30.23 |

TABLE 38
Example 13

| | Infinite | Short Range |
|---|---|---|
| | Distance | 0.2 Times |
| Focal Length | 20.83 | — |
| Back Focus | 15.54 | 15.54 |
| Open F-Number | 1.66 | 1.73 |
| Maximum Full Angle of View [°] | 92.6 | 88.6 |
| DD[11] | 6.11 | 2.25 |
| DD[13] | 3.92 | 7.78 |
| DD[19] | 1.59 | 4.55 |
| DD[21] | 7.64 | 4.68 |

TABLE 39
Example 13

| Sn | 18 | 19 | 22 | 23 |
|---|---|---|---|---|
| KA | 1.0000000E+00 | 1.0000000E+00 | 1.0000000E+00 | 1.0000000E+00 |
| A4 | −1.3257656E−05 | 4.1233831E−05 | −2.2577852E−05 | −9.9988266E−05 |
| A6 | −8.7971135E−09 | −6.5090536E−08 | 1.0080730E−07 | −2.6343211E−07 |
| A8 | 3.7148305E−12 | 1.7495933E−10 | 2.9218675E−10 | 1.1521839E−09 |
| A10 | −6.1665272E−14 | −2.3458527E−13 | −7.0516617E−13 | 5.1531731E−13 |
| A12 | 0.0000000E+00 | 0.0000000E+00 | 0.0000000E+00 | −4.4448000E−16 |

| Sn | 24 | 25 | 26 | 27 |
|---|---|---|---|---|
| KA | 1.0000000E+00 | 1.0000000E+00 | 1.0000000E+00 | 1.0000000E+00 |
| A4 | −1.9752354E−04 | −2.5990785E−04 | −2.2083547E−05 | 4.8854843E−05 |
| A6 | 9.3686177E−08 | 5.6460969E−07 | −2.8860872E−07 | −1.1209309E−07 |
| A8 | 7.4712093E−10 | −1.2996974E−09 | −1.1860070E−09 | −1.2336979E−10 |
| A10 | −8.6147411E−13 | 4.3522714E−12 | 1.1822128E−11 | −1.2826789E−12 |
| A12 | 6.0254836E−15 | −1.3725302E−14 | −3.3820867E−14 | 3.9951483E−15 |

### Example 14

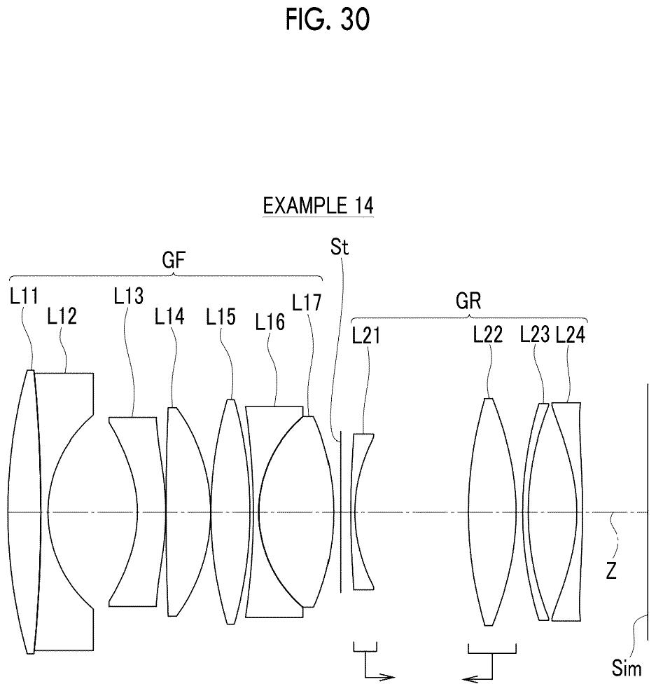

A cross-sectional view of a configuration of an imaging lens of Example 14 is illustrated in FIG. 30. The imaging lens of Example 14 consists of, in order from the object side to the image side, the front group GF having a positive refractive power, the aperture stop St, and the rear group GR having a negative refractive power. The front group GF consists of seven lenses including the lenses L11 to L17 in order from the object side to the image side. The rear group GR consists of four lenses including the lenses L21 to L24 in order from the object side to the image side. The imaging lens includes only two focus lens groups. Out of the two focus lens groups, the focus lens group on the object side consists of the lens L21, and the focus lens group on the image side consists of the lens L22. During the focusing from the infinite distance object to the short range object, the focus lens group on the object side moves to the image side, and the focus lens group on the image side moves to the object side.

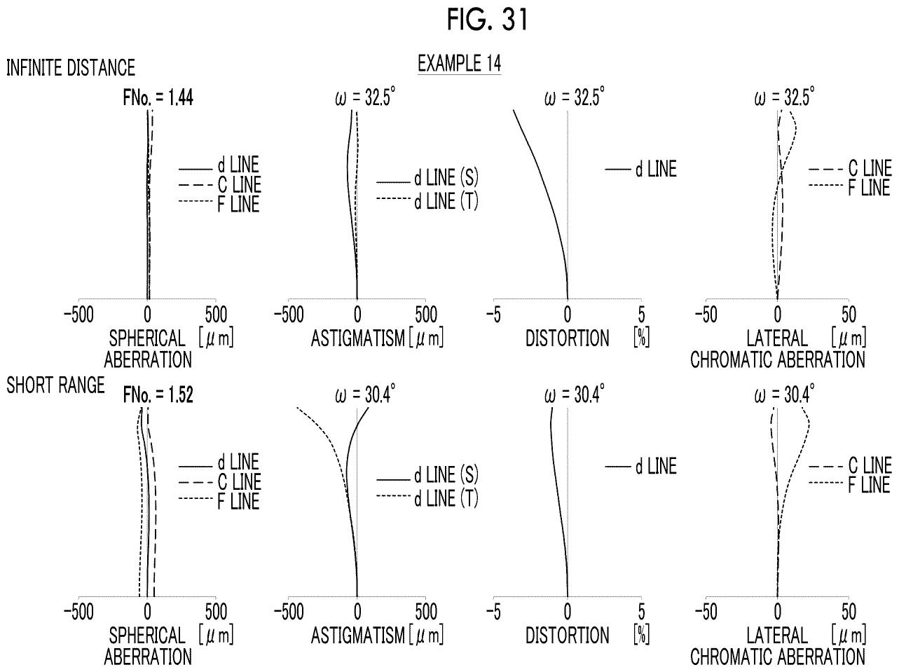

For the imaging lens of Example 14, Table 40 shows basic lens data, Table 41 shows specifications and a variable surface spacing, Table 42 shows aspherical coefficients, and FIG. 31 illustrates each aberration diagram.

TABLE 40
Example 14

| Sn | R | D | Nd | νd | Material | ED |
|---|---|---|---|---|---|---|
| 1 | 90.1377 | 5.5542 | 2.00272 | 19.32 | E-FDS2.HOYA | |
| 2 | −248.2368 | 1.2111 | 1.49700 | 81.54 | S-FPL51.OHARA | |
| 3 | 21.4210 | 15.0528 | | | | |
| *4 | −22.3608 | 4.7717 | 1.95150 | 29.83 | M-TAFD405.HOYA | |
| *5 | −43.1679 | 0.0498 | | | | |
| 6 | 442.7997 | 7.5075 | 1.59522 | 67.73 | S-FPM2.OHARA | |
| 7 | −29.9363 | 0.0499 | | | | |
| 8 | 66.8568 | 6.5749 | 1.88300 | 39.22 | H-ZLAF68N.CDGM | |
| 9 | −69.8167 | 0.5652 | | | | |
| 10 | −121.1977 | 0.9190 | 1.63980 | 34.47 | S-TIM27.OHARA | |
| 11 | 21.1973 | 12.5529 | 1.53775 | 74.70 | S-FPM3.OHARA | |
| 12 | −40.5722 | 1.1500 | | | | |
| 13 (St) | ∞ | DD[13] | | | | |
| *14 | 146.4695 | 0.6819 | 1.82115 | 24.06 | M-FDS910.HOYA | 26.31 |
| *15 | 25.7445 | DD[15] | | | | 25.40 |
| *16 | 67.1428 | 8.0372 | 1.95150 | 29.83 | M-TAFD405.HOYA | 38.00 |
| *17 | −42.0924 | DD[17] | | | | 38.38 |
| 18 | 62.3037 | 0.9418 | 1.84666 | 23.78 | S-TIH53W.OHARA | |
| 19 | 48.7518 | 8.1848 | | | | |
| *20 | −29.8728 | 0.9480 | 1.73077 | 40.51 | L-LAM69.OHARA | 35.96 |
| *21 | −147.0069 | 11.0000 | | | | 36.90 |

TABLE 41
Example 14

| | Infinite | Short Range |
|---|---|---|
| | Distance | 0.15 Times |
| Focal Length | 35.30 | — |
| Back Focus | 11.00 | 11.00 |
| Open F-Number | 1.44 | 1.52 |
| Maximum Full Angle of View [°] | 65.0 | 60.8 |
| DD[13] | 1.70 | 4.19 |
| DD[15] | 19.13 | 15.48 |
| DD[17] | 1.10 | 2.25 |

TABLE 42
Example 14

| Sn | 4 | 5 | 14 | 15 |
|---|---|---|---|---|
| KA | 1.0000000E+00 | 1.0000000E+00 | 1.0000000E+00 | 1.0000000E+00 |
| A4 | 1.8665670E−05 | 2.2083355E−05 | −1.8378516E−06 | −3.9393464E−06 |
| A6 | 2.5962433E−08 | 1.4361024E−08 | −2.4823174E−09 | −9.8629460E−09 |
| A8 | −1.2016831E−10 | −7.1202209E−11 | −4.6972448E−11 | −2.8272389E−11 |
| A10 | 2.7049116E−13 | 8.8375128E−14 | 1.4100195E−13 | 1.7399418E−14 |

| Sn | 16 | 17 | 20 | 21 |
|---|---|---|---|---|
| KA | 1.0000000E+00 | 1.0000000E+00 | 1.0000000E+00 | 1.0000000E+00 |
| A4 | 1.9839370E−07 | 6.3214807E−06 | 2.0428095E−05 | 5.3122070E−06 |
| A6 | −1.7001147E−09 | −7.3275129E−09 | −2.8433115E−08 | −2.8133870E−11 |
| A8 | 9.7839077E−12 | 1.8537271E−11 | 4.0041901E−11 | −1.1602464E−11 |
| A10 | −2.4506600E−14 | −2.8358946E−14 | 6.0212242E−14 | 7.8393349E−14 |

### Example 15

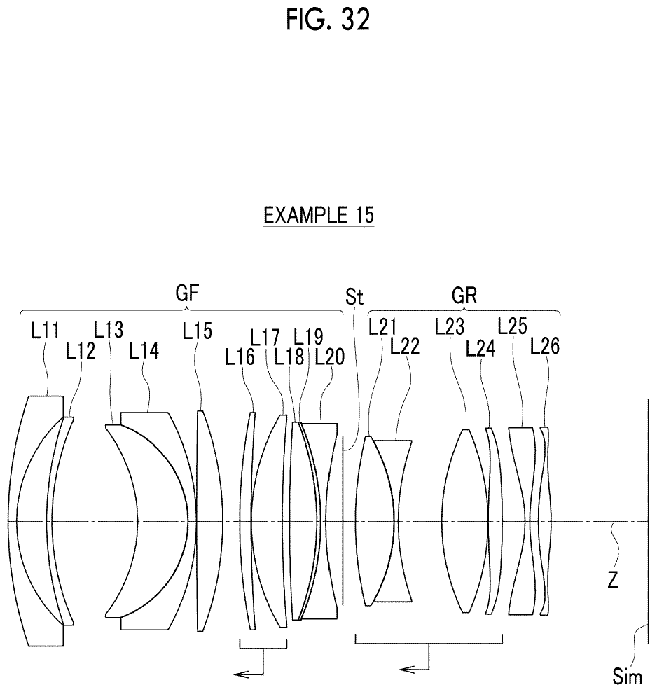

A cross-sectional view of a configuration of an imaging lens of Example 15 is illustrated in FIG. 32. The imaging lens of Example 15 consists of, in order from the object side to the image side, the front group GF having a positive refractive power, the aperture stop St, and the rear group GR having a positive refractive power. The front group GF consists of 10 lenses including lenses L11 to L20 in order from the object side to the image side. The rear group GR consists of six lenses including the lenses L21 to L26 in order from the object side to the image side. The imaging lens includes only two focus lens groups. Out of the two focus lens groups, the focus lens group on the object side consists of the lenses L16 and L17, and the focus lens group on the image side consists of the lenses L21 to L24. During the focusing from the infinite distance object to the short range object, the focus lens group on the object side and the focus lens group on the image side move to the object side by changing the mutual spacing.

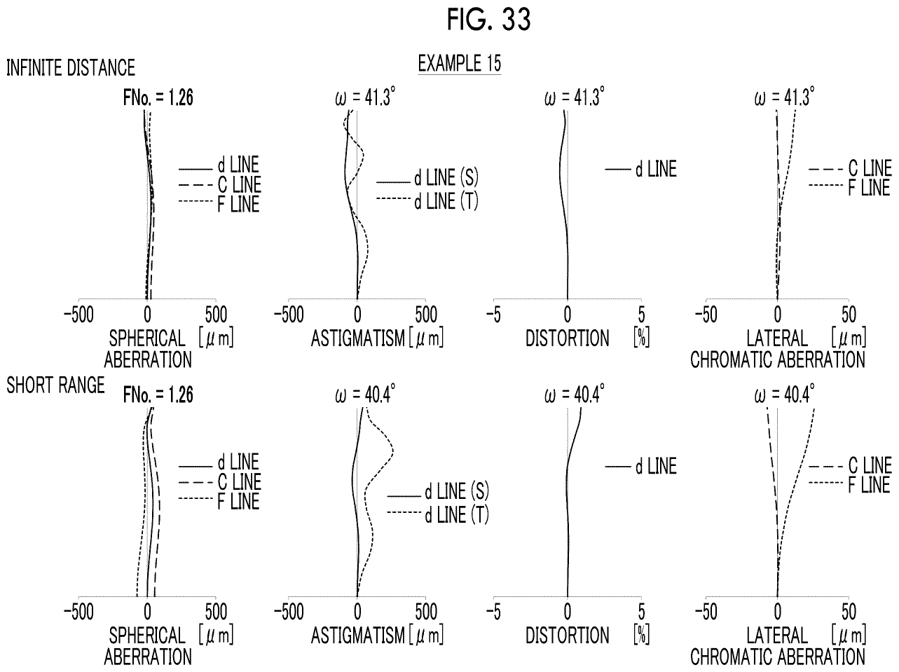

For the imaging lens of Example 15, Table 43 shows basic lens data, Table 44 shows specifications and a variable surface spacing, Table 45 shows aspherical coefficients, and FIG. 33 illustrates each aberration diagram.

TABLE 43
Example 15

| Sn | R | D | Nd | νd | Material | ED |
|---|---|---|---|---|---|---|
| 1 | 69.5854 | 1.5000 | 1.75500 | 52.32 | S-LAH97.OHARA | |
| 2 | 24.9071 | 5.3000 | | | | |
| 3 | 57.7418 | 0.9443 | 1.49700 | 81.54 | S-FPL51.OHARA | |
| 4 | 44.4537 | 15.1158 | | | | |
| 5 | −26.9969 | 8.8863 | 1.85026 | 32.27 | S-LAH71.OHARA | |
| 6 | −18.2740 | 1.4998 | 1.89286 | 20.36 | S-NPH4.OHARA | |
| 7 | −39.6221 | 0.0486 | | | | |
| 8 | 1291.3937 | 4.5884 | 2.00272 | 19.32 | E-FDS2.HOYA | |
| 9 | −56.0430 | DD[9] | | | | |
| 10 | 100.7133 | 1.9928 | 1.48749 | 70.24 | S-FSL5.OHARA | |
| 11 | 247.5084 | 0.0587 | | | | |
| 12 | 37.5975 | 5.4634 | 1.59522 | 67.73 | S-FPM2.OHARA | |
| 13 | 218.2567 | DD[13] | | | | |
| 14 | 293.5437 | 4.8034 | 1.88300 | 39.22 | H-ZLAF68N.CDGM | |
| 15 | −48.7760 | 0.7000 | 1.54493 | 25.30 | Plastic | |
| 16 | −45.2015 | 0.8764 | 1.69895 | 30.13 | S-TIM35.OHARA | |
| 17 | 63.0794 | 2.9185 | | | | |
| 18 (St) | ∞ | DD[18] | | | | |
| 19 | 63.8819 | 6.8283 | 1.43875 | 94.66 | S-FPL55.OHARA | |
| 20 | −29.5366 | 0.7407 | 1.71736 | 29.52 | S-TIH1.OHARA | |
| 21 | 42.7511 | 7.6733 | | | | |
| 22 | 37.6404 | 8.1665 | 1.49700 | 81.54 | S-FPL51.OHARA | |
| 23 | −40.9980 | 0.0494 | | | | |
| *24 | 103.7503 | 2.4778 | 1.95150 | 29.83 | MP-TAFD405.HOYA | 32.69 |
| *25 | −125.8967 | DD[25] | | | | 33.05 |
| *26 | −21.6215 | 0.8477 | 1.68948 | 31.02 | L-TIM28.OHARA | 33.01 |
| *27 | 35.8393 | 1.4910 | | | | 33.21 |
| *28 | 44.4228 | 2.2638 | 1.85135 | 40.10 | MC-TAFD305.HOYA | 32.84 |
| *29 | −40.5423 | 17.1700 | | | | 33.37 |

TABLE 44
Example 15

| | Infinite | Short Range |
|---|---|---|
| | Distance | 0.11 Times |
| Focal Length | 24.70 | — |
| Back Focus | 17.17 | 17.17 |
| Open F-Number | 1.26 | 1.26 |
| Maximum Full Angle of View [°] | 82.6 | 80.8 |
| DD[9] | 3.01 | 1.26 |
| DD[13] | 1.28 | 3.02 |
| DD[18] | 2.22 | 0.82 |
| DD[25] | 4.01 | 5.41 |

TABLE 45
Example 15

| Sn | 24 | 25 | 26 |
|---|---|---|---|
| KA | 1.0000000E+00 | 1.0000000E+00 | 1.0000000E+00 |
| A4 | −1.3089257E−05 | 2.2043297E−06 | 8.6369959E−05 |
| A6 | −1.1572400E−10 | −3.9995262E−08 | −1.1388032E−07 |
| A8 | −3.6518571E−10 | −1.8419654E−10 | −3.1649417E−12 |
| A10 | 7.7327800E−13 | 5.3483700E−13 | 4.4918349E−13 |

| Sn | 27 | 28 | 29 |
|---|---|---|---|
| KA | 1.0000000E+00 | 1.0000000E+00 | 1.0000000E+00 |
| A4 | −6.4981120E−05 | −1.2576024E−05 | 7.6104440E−05 |
| A6 | 1.0898205E−07 | −4.3006728E−08 | −5.8679620E−08 |
| A8 | −2.6776855E−10 | −2.7204086E−10 | −4.7939333E−10 |
| A10 | 3.5889645E−13 | 2.7976805E−13 | 7.6980060E−13 |

### Example 16

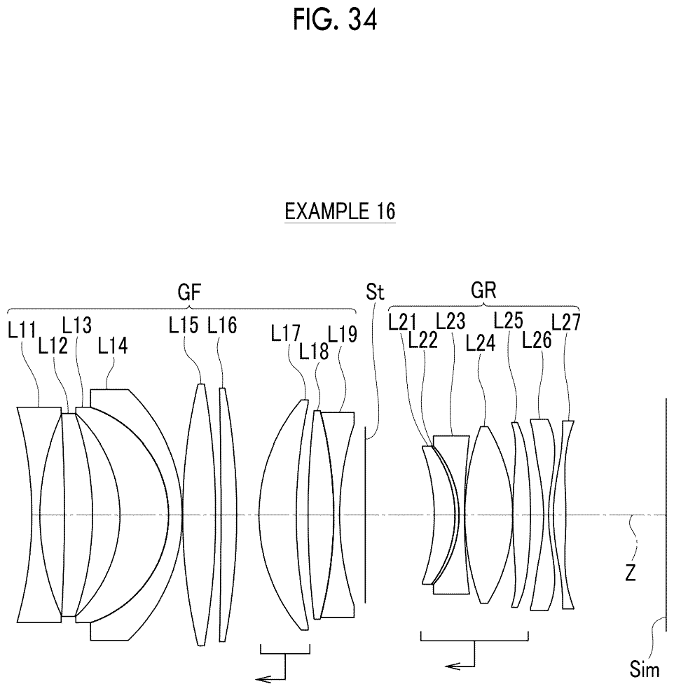

A cross-sectional view of a configuration of an imaging lens of Example 16 is illustrated in FIG. 34. The imaging lens of Example 16 consists of, in order from the object side to the image side, the front group GF having a positive refractive power, the aperture stop St, and the rear group GR having a positive refractive power. The front group GF consists of nine lenses including the lenses L11 to L19 in order from the object side to the image side. The rear group GR consists of seven lenses including the lenses L21 to L27 in order from the object side to the image side. The imaging lens includes only two focus lens groups. Out of the two focus lens groups, the focus lens group on the object side consists of the lens L17, and the focus lens group on the image side consists of the lenses L21 to L25. During the focusing from the infinite distance object to the short range object, the focus lens group on the object side and the focus lens group on the image side move to the object side by changing the mutual spacing.

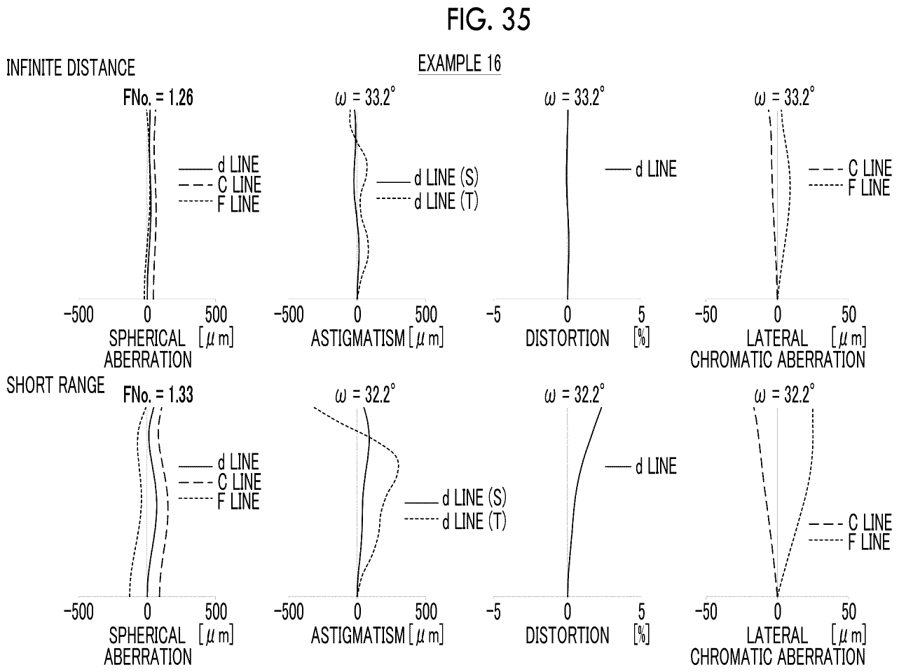

For the imaging lens of Example 16, Table 46 shows basic lens data, Table 47 shows specifications and a variable surface spacing, Table 48 shows aspherical coefficients, and FIG. 35 illustrates each aberration diagram.

TABLE 46
Example 16

| Sn | R | D | Nd | νd | Material | ED |
|---|---|---|---|---|---|---|
| 1 | −74.6496 | 1.5000 | 1.75500 | 52.32 | S-LAH97.OHARA | |
| 2 | 46.0650 | 4.5378 | | | | |
| 3 | −334.7958 | 5.1948 | 1.49700 | 81.54 | S-FPL51.OHARA | |
| 4 | −56.9187 | 5.0691 | | | | |
| 5 | −25.9639 | 9.0102 | 1.83400 | 37.21 | S-LAH60V.OHARA | |
| 6 | −21.1473 | 2.5002 | 1.89286 | 20.36 | S-NPH4.OHARA | |
| 7 | −32.3050 | 0.0998 | | | | |
| 8 | 105.7931 | 6.0883 | 1.75500 | 52.32 | S-LAH97.OHARA | |
| 9 | −142.8625 | 1.0000 | | | | |
| 10 | −1019.7165 | 2.9065 | 2.00272 | 19.32 | E-FDS2.HOYA | |
| 11 | −128.1731 | DD[11] | | | | |
| 12 | 33.2716 | 6.9021 | 1.43875 | 94.66 | S-FPL55.OHARA | |
| 13 | 99.9978 | DD[13] | | | | |
| 14 | 166.2353 | 4.7456 | 1.88300 | 39.22 | H-ZLAF68N.CDGM | |
| 15 | −76.6427 | 0.9886 | 1.69895 | 30.13 | S-TIM35.OHARA | |
| 16 | 54.4957 | 4.7389 | | | | |
| 17 (St) | ∞ | DD[17] | | | | |
| 18 | −36.8969 | 3.8234 | 1.53775 | 74.70 | S-FPM3.OHARA | |
| 19 | −21.3431 | 0.7498 | 1.60401 | 20.80 | Plastic | |
| 20 | −20.1461 | 1.0000 | 1.69895 | 30.13 | S-TIM35.OHARA | |
| 21 | 118.1878 | 0.0942 | | | | |
| 22 | 48.0550 | 8.8318 | 1.49700 | 81.54 | S-FPL51.OHARA | |
| 23 | −31.5506 | 0.0148 | | | | |
| *24 | 82.3108 | 3.2728 | 1.95150 | 29.83 | MP-TAFD405.HOYA | 33.98 |
| *25 | −103.4628 | DD[25] | | | | 34.43 |
| *26 | −31.6039 | 0.9123 | 1.68948 | 31.02 | L-TIM28.OHARA | 34.69 |
| *27 | 29.1264 | 0.8756 | | | | 35.56 |
| *28 | 34.3658 | 2.3306 | 1.85135 | 40.10 | MC-TAFD305.HOYA | 35.04 |
| *29 | −73.2382 | 18.5300 | | | | 34.85 |

TABLE 47
Example 16

| | Infinite | Short Range |
|---|---|---|
| | Distance | 0.17 Times |
| Focal Length | 33.03 | — |
| Back Focus | 18.53 | 18.53 |
| Open F-Number | 1.26 | 1.33 |
| Maximum Full Angle of View [°] | 66.4 | 64.4 |
| DD[11] | 4.12 | 0.02 |
| DD[13] | 2.17 | 6.28 |
| DD[17] | 12.78 | 9.73 |
| DD[25] | 2.45 | 5.50 |

TABLE 48
Example 16

| Sn | 24 | 25 | 26 |
|---|---|---|---|
| KA | 1.0000000E+00 | 1.0000000E+00 | 1.0000000E+00 |
| A4 | −1.7630140E−05 | −4.2589617E−06 | 5.4803038E−05 |
| A6 | 5.0573664E−08 | 1.3861251E−08 | −7.8251118E−08 |
| A8 | −4.6618619E−10 | −2.8175582E−10 | −5.0394369E−12 |
| A10 | 7.7327800E−13 | 5.3483700E−13 | −1.8891927E−14 |

| Sn | 27 | 28 | 29 |
|---|---|---|---|
| KA | 1.0000000E+00 | 1.0000000E+00 | 1.0000000E+00 |
| A4 | −7.9673132E−05 | −2.6283266E−05 | 6.5545511E−05 |
| A6 | 6.8983789E−08 | −1.1150141E−07 | −1.2712307E−07 |
| A8 | −3.1094137E−11 | 4.3139857E−10 | 1.8589123E−10 |
| A10 | −2.6375949E−14 | −4.4049510E−13 | −1.8534438E−13 |

Tables 49 to 52 show the corresponding values of Conditional Expressions (1) to (20) and values of Ryf and Ryr of the imaging lenses of Examples 1 to 16. Preferable ranges of the conditional expressions may be set using the corresponding values of the examples shown in Tables 49 to 52 as the upper limits and the lower limits of the conditional expressions.

TABLE 49

| Expression | | | | | |
|---|---|---|---|---|---|
| Number | | Example 1 | Example 2 | Example 3 | Example 4 |
| (1) | TL/(f × tan ωm) | 4.728 | 4.989 | 4.810 | 4.771 |
| (2) | Fno/tan ωm | 1.787 | 1.639 | 1.376 | 1.645 |
| (3) | Bf/(f × tan ωm) | 0.518 | 0.592 | 0.877 | 0.741 |
| (4) | dFSt/TL | 0.582 | 0.567 | 0.536 | 0.509 |
| (5) | fR/fF | 0.514 | 0.563 | 0.852 | 1.240 |
| (6) | f/fF | 0.202 | 0.277 | 0.421 | 0.659 |
| (7) | (TL × Fno)/(f × tan ωm) | 8.747 | 7.185 | 6.927 | 6.871 |
| | Ryf | −37.393 | −27.350 | −45.575 | −62.084 |
| | Ryr | −81.798 | −26.638 | 87.876 | 103.464 |
| (8) | \|(1/Rcf − 1/Rcr)/(l/Ryf − 1/Ryr)\| | 1.068 | 6.334 | 1.243 | 1.613 |
| (9) | \|ff1/ff2\| | — | — | 3.635 | 1.850 |
| (10) | f/ffR | −0.001 | 0.079 | −0.166 | −0.199 |
| (11) | (RL1r − RL1f)/(RL1r + RL1f) | −0.394 | −0.298 | −0.528 | −0.756 |
| (12) | Fno | 1.85 | 1.44 | 1.44 | 1.44 |
| (13) | ωm | 46.00 | 41.30 | 46.30 | 41.20 |
| (14) | fL1m/f | −2.718 | −2.207 | −1.848 | −1.401 |
| (15) | vdL1m | 64.06 | 49.10 | 41.24 | 52.32 |
| (16) | f/ffF | 0.202 | 0.277 | 0.303 | 0.265 |
| (17) | f/fRp | 0.588 | 0.978 | 0.726 | 0.660 |
| (18) | νdRp | 81.54 | 25.46 | 40.38 | 29.83 |
| (19) | dAsI/TL | 0.153 | 0.119 | 0.182 | 0.155 |
| (20) | Ndp2 + 0.01 × νdp2 | — | — | — | 1.798 |

TABLE 50

| Expression | | | | | |
|---|---|---|---|---|---|
| Number | | Example 5 | Example 6 | Example 7 | Example 8 |
| (1) | TL/(f × tan ωm) | 4.853 | 4.483 | 4.515 | 4.522 |
| (2) | Fno/tan ωm | 2.127 | 2.125 | 1.804 | 2.294 |
| (3) | Bf/(f × tan ωm) | 0.895 | 0.507 | 0.507 | 0.507 |
| (4) | dFSt/TL | 0.541 | 0.613 | 0.674 | 0.688 |
| (5) | fR/fF | 1.723 | 2.441 | 0.730 | 1.152 |
| (6) | f/fF | 0.806 | 0.572 | 0.422 | 0.572 |
| (7) | (TL × Fno)/(f × tan ωm) | 6.989 | 8.339 | 6.502 | 6.556 |
| | Ryf | −98.753 | −32.866 | 51.377 | 112.788 |
| | Ryr | 54.452 | 161.352 | 304.590 | −738.316 |
| (8) | \|(1/Rcf − 1/Rcr)/(1/Ryf − 1/Ryr)\| | 1.148 | 0.537 | 0.704 | 0.320 |
| (9) | \|ff1/ff2\| | 2.848 | − | 1.031 | 0.761 |
| (10) | f/ffR | −0.485 | −0.153 | 0.160 | 0.058 |
| (11) | (RL1r − RL1f)/(RL1r + RL1f) | −2.418 | −0.504 | −0.745 | −1.720 |
| (12) | Fno | 1.44 | 1.86 | 1.44 | 1.45 |
| (13) | ωm | 34.10 | 41.20 | 38.60 | 32.30 |
| (14) | fL1m/f | — | −1.664 | −1.283 | — |
| (15) | νdL1m | — | 64.06 | 37.10 | — |
| (16) | f/ffF | 0.412 | 0.572 | −0.244 | −0.240 |
| (17) | f/fRp | 0.751 | 0.720 | 0.933 | 1.101 |
| (18) | νdRp | 29.83 | 81.54 | 39.22 | 42.74 |
| (19) | dAsI/TL | 0.184 | 0.194 | 0.112 | 0.112 |
| (20) | Ndp2 + 0.01 × νdp2 | 1.812 | — | — | — |

TABLE 51

| Expression | | | | | |
|---|---|---|---|---|---|
| Number | | Example 9 | Example 10 | Example 11 | Example 12 |
| (1) | TL/(f × tan ωm) | 5.027 | 5.396 | 4.645 | 4.645 |
| (2) | Fno/tan ωm | 1.784 | 1.410 | 1.765 | 1.775 |
| (3) | Bf/(f × tan ωm) | 0.946 | 0.646 | 1.298 | 1.325 |
| (4) | dFSt/TL | 0.686 | 0.675 | 0.604 | 0.647 |
| (5) | fR/fF | −0.798 | −0.566 | 0.434 | −0.287 |
| (6) | f/fF | −0.559 | −0.357 | 0.197 | −0.164 |
| (7) | (TL × Fno)/(f × tan ωm) | 9.351 | 7.933 | 8.640 | 8.687 |
| | Ryf | −19.079 | −54.897 | 310.528 | 124.949 |
| | Ryr | −74.964 | 41.308 | 25.646 | 21.806 |
| (8) | \|(1/Rcf − 1/Rcr)/(1/Ryf − 1/Ryr)\| | 0.273 | 0.437 | 0.339 | 0.367 |
| (9) | \|ff1/ff2\| | 0.290 | 0.383 | 0.302 | 0.077 |
| (10) | f/ffR | −0.210 | −0.125 | 0.470 | 0.428 |
| (11) | (RL1r − RL1f)/(RL1r + RL1f) | −0.539 | −0.655 | −0.158 | −0.371 |
| (12) | Fno | 1.86 | 1.47 | 1.86 | 1.87 |
| (13) | ωm | 46.20 | 46.20 | 46.50 | 46.50 |
| (14) | fL1m/f | −1.821 | −1.797 | −6.921 | −2.277 |
| (15) | νdL1m | 70.24 | 70.24 | 60.08 | 61.15 |
| (16) | f/ffF | −1.173 | −0.901 | −1.475 | −1.443 |
| (17) | f/fRp | 0.535 | 0.514 | 0.658 | 0.622 |
| (18) | νdRp | 74.70 | 74.70 | 67.73 | 67.73 |
| (19) | dAsI/TL | 0.188 | 0.188 | 0.279 | 0.285 |
| (20) | Ndp2 + 0.01 × νdp2 | 1.798 | — | — | — |

TABLE 52

| Expression | | | | | |
|---|---|---|---|---|---|
| Number | | Example 13 | Example 14 | Example 15 | Example 16 |
| (1) | TL/(f × tan ωm) | 5.099 | 4.788 | 5.204 | 5.424 |
| (2) | Fno/tan ωm | 1.586 | 2.260 | 1.434 | 1.925 |
| (3) | Bf/(f × tan ωm) | 0.713 | 0.489 | 0.791 | 0.857 |
| (4) | dFSt/TL | 0.640 | 0.480 | 0.478 | 0.475 |
| (5) | fR/fF | 0.020 | −86.412 | 1.477 | 1.622 |
| (6) | f/fF | 0.010 | 1.273 | 0.699 | 0.819 |
| (7) | (TL × Fno)/(f × tan ωm) | 8.465 | 6.895 | 6.557 | 6.834 |
| | Ryf | −17.373 | −65.312 | −32.296 | −1297.140 |
| | Ryr | −29.478 | 139.551 | −164.299 | 50.483 |
| (8) | \|(1/Rcf − 1/Rcr)/(1/Ryf − 1/Ryr)\| | 1.702 | 1.187 | 1.896 | 2.077 |
| (9) | \|ff1/ff2\| | 1.062 | 1.352 | 1.779 | 2.687 |
| (10) | f/ffR | 0.109 | −0.830 | −0.167 | −0.238 |
| (11) | (RL1r − RL1f)/(RL1r + RL1f) | −0.493 | 2.140 | −0.473 | −4.223 |
| (12) | Fno | 1.66 | 1.44 | 1.26 | 1.26 |
| (13) | ωm | 46.30 | 32.50 | 41.30 | 33.20 |
| (14) | fL1m/f | −1.938 | — | −2.111 | — |
| (15) | νdL1m | 52.32 | — | 52.32 | — |
| (16) | f/ffF | 0.010 | 1.273 | 0.113 | 0.508 |
| (17) | f/fRp | 0.723 | 1.252 | 0.980 | 1.190 |
| (18) | νdRp | 94.66 | 29.83 | 40.10 | 40.10 |
| (19) | dAsI/TL | 0.140 | 0.102 | 0.152 | 0.158 |
| (20) | Ndp2 + 0.01 × νdp2 | — | — | 1.798 | 1.812 |

Any of the imaging lenses of Examples 1 to 16 has an F-number smaller than 1.9. Particularly, a part of the imaging lenses of the examples has an F-number smaller than 1.5. In addition, any of the imaging lenses of Examples 1 to 16 has a maximum half angle of view of 30 degrees or more in the state where the infinite distance object is in focus and is configured to have a wide angle. Particularly, a part of the imaging lenses of the examples has a maximum half angle of view of 40 degrees or more. Furthermore, any of the imaging lenses of Examples 1 to 16 is configured to be reduced in size and maintains high optical performance by favorably correcting various aberrations.

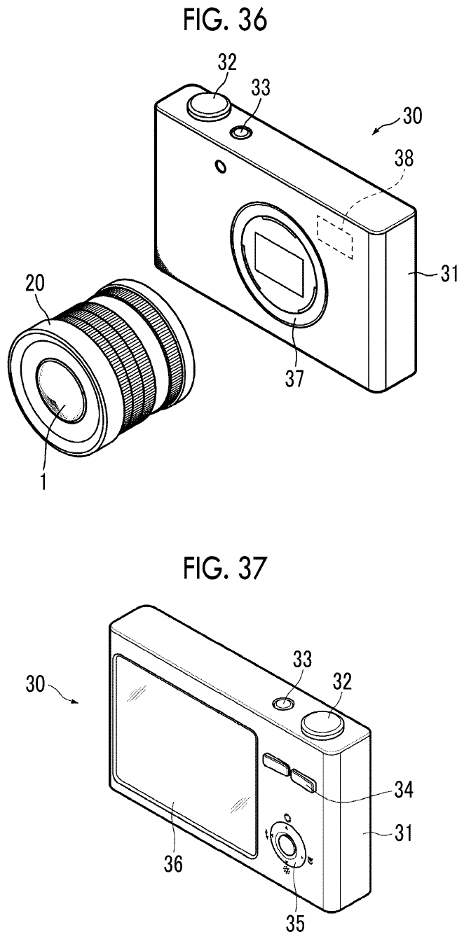

Next, an imaging apparatus according to the embodiment of the present disclosure will be described. FIGS. 36 and 37 illustrate external views of a camera 30 that is the imaging apparatus according to one embodiment of the present disclosure. FIG. 36 illustrates a perspective view of the camera 30 seen from its front surface side, and FIG. 37 illustrates a perspective view of the camera 30 seen from its rear surface side. The camera 30 is a so-called mirrorless type digital camera on which an interchangeable lens 20 can be attachably and detachably mounted. The interchangeable lens 20 is configured to include an imaging lens 1 according to one embodiment of the present disclosure accommodated in a lens barrel.

The camera 30 comprises a camera body 31. A shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before imaging.

An imaging aperture on which light from an imaging target is incident is provided in a center portion of a front surface of the camera body 31. A mount 37 is provided at a position corresponding to the imaging aperture, and the interchangeable lens 20 is mounted on the camera body 31 through the mount 37.

An imaging element 38 is provided in the camera body 31. The imaging element 38 outputs an imaging signal corresponding to a subject image formed by the interchangeable lens 20. For example, a charge coupled device (CCD) or a complementary metal oxide semiconductor (CMOS) is used as the imaging element 38. A signal processing circuit (not illustrated), a recording medium (not illustrated), and the like are provided in the camera body 31. The signal processing circuit generates an image by processing the imaging signal output from the imaging element 38. The generated image is recorded on the recording medium. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples and can be subjected to various modifications. For example, the curvature radius, the surface spacing, the refractive index, the Abbe number, and the aspherical coefficient of each lens are not limited to the values shown in each example and may have other values.

In addition, the imaging apparatus according to the embodiment of the present disclosure is not limited to the above example and can have various aspects of, for example, a camera of a type other than a mirrorless type, a film camera, a video camera, and a security camera.

The following appendices are further disclosed with respect to the embodiment and the examples described above.

### Appendix 1

An imaging lens consisting of, in order from an object side to an image side, a front group, an aperture stop, and a rear group, in which the rear group includes one or two focus lens groups that move along an optical axis during focusing, a distance on the optical axis from a lens surface of the front group closest to the object side to an image plane is invariant during the focusing, and in a case where a sum of a back focus of an entire system as an air conversion distance and a distance on the optical axis from the lens surface of the front group closest to the object side to a lens surface of the rear group closest to the image side in a state where an infinite distance object is in focus is denoted by TL, a focal length of the entire system in the state where the infinite distance object is in focus is denoted by f, a maximum half angle of view in the state where the infinite distance object is in focus is denoted by ωm, an open F-number in the state where the infinite distance object is in focus is denoted by Fno, and the back focus of the entire system as the air conversion distance in the state where the infinite distance object is in focus is denoted by Bf, Conditional Expressions (1), (2), and (3) are satisfied, which are represented by

$$2.3 < TL / ( f \times tan ω m ) < 7 \qquad ( 1 )$$

$$1.15 < Fno / tan ω m < 3.5 \qquad ( 2 )$$

$$0.3 < Bf / ( f \times tan ω m ) < 1.5 . \qquad ( 3 )$$

### Appendix 2

The imaging lens according to Appendix 1, in which Conditional Expression (1-1) is satisfied, which is represented by

$$3.5 < TL / ( f \times tan ω m ) < 5.6 . \qquad ( 1 - 1 )$$

### Appendix 3

The imaging lens according to Appendix 1, in which Conditional Expression (1-2) is satisfied, which is represented by

$$4.4 < TL / ( f \times tan ω m ) < 5.2 . \qquad ( 1 - 2 )$$

### Appendix 4

The imaging lens according to any one of Appendices 1 to 3, in which Conditional Expression (2-1) is satisfied, which is represented by

$$1.3 < Fno / tan ω m < 2.7 . \qquad ( 2 - 1 )$$

### Appendix 5

The imaging lens according to any one of Appendices 1 to 4, in which, in a case where a distance on the optical axis from the lens surface of the front group closest to the object side to the aperture stop in the state where the infinite distance object is in focus is denoted by dFSt, Conditional Expression (4) is satisfied, which is represented by

$$0.43 < dFSt / TL < 0.75 . \qquad ( 4 )$$

### Appendix 6

The imaging lens according to any one of Appendices 1 to 5, in which, in a case where a focal length of the front group in the state where the infinite distance object is in focus is denoted by fF, and a focal length of the rear group in the state where the infinite distance object is in focus is denoted by fR, Conditional Expression (5) is satisfied, which is represented by

$$- 2 < fR / fF < 4. \qquad ( 5 )$$

### Appendix 7

The imaging lens according to any one of Appendices 1 to 6, in which, in a case where a focal length of the front group in the state where the infinite distance object is in focus is denoted by fF, Conditional Expression (6) is satisfied, which is represented by

$$- 1 < f / fF < 2. \qquad ( 6 )$$

### Appendix 8

The imaging lens according to any one of Appendices 1 to 7, in which Conditional Expression (7) is satisfied, which is represented by

$$6 < ( TL \times Fno ) / ( f \times tan ω m ) < 11. \qquad ( 7 )$$

### Appendix 9

The imaging lens according to any one of Appendices 1 to 7, in which Conditional Expression (7-1) is satisfied, which is represented by

$$6.3 < ( TL \times Fno ) / ( f \times tan ω m ) < 9.5 . \qquad ( 7 - 1 )$$

### Appendix 10

The imaging lens according to any one of Appendices 1 to 9, in which the front group includes one focus lens group that moves along the optical axis during the focusing.

### Appendix 11

The imaging lens according to any one of Appendices 1 to 10, in which the rear group includes two focus lens groups that move by changing a mutual spacing during the focusing.

### Appendix 12

The imaging lens according to any one of Appendices 1 to 11, in which at least one lens that has a convex surface facing the object side in a paraxial region and that has, on a lens surface on the object side, an inflection point at which a convex or concave shape changes in a middle of the lens surface from a position on the optical axis to an edge part is disposed in the rear group.

### Appendix 13

The imaging lens according to any one of Appendices 1 to 12, in which at least one lens that has a concave surface facing the object side in a paraxial region and that has, on a lens surface on the object side, an inflection point at which a convex or concave shape changes in a middle of the lens surface from a position on the optical axis to an edge part is disposed in the rear group.

### Appendix 14

The imaging lens according to any one of Appendices 1 to 13, in which at least one lens that has a convex surface facing the image side in a paraxial region and that has, on a lens surface on the image side, an inflection point at which a convex or concave shape changes in a middle of the lens surface from a position on the optical axis to an edge part is disposed in the rear group.

### Appendix 15

The imaging lens according to any one of Appendices 1 to 14, in which at least one lens that has a concave surface facing the image side in a paraxial region and that has, on a lens surface on the image side, an inflection point at which a convex or concave shape changes in a middle of the lens surface from a position on the optical axis to an edge part is disposed in the rear group.

### Appendix 16

The imaging lens according to any one of Appendices 1 to 15, in which the imaging lens includes a three-piece cemented lens in which a first positive lens, a second positive lens, and a negative lens are cemented in this order.

### Appendix 17

The imaging lens according to Appendix 16, in which a surface of the second positive lens on a side closer to the first positive lens has a concave surface facing the side closer to the first positive lens.

### Appendix 18

The imaging lens according to any one of Appendices 1 to 17, in which the rear group includes at least one aspherical lens, and in a case where an aspherical lens closest to the image side among aspherical lenses included in the rear group is referred to as a most image side aspherical lens, a paraxial curvature radius of a surface, on the object side, of the most image side aspherical lens is denoted by Rcf, a curvature radius, at a position of a maximum effective diameter, of the surface, on the object side, of the most image side aspherical lens is denoted by Ryf, a paraxial curvature radius of a surface, on the image side, of the most image side aspherical lens is denoted by Rcr, and a curvature radius, at a position of a maximum effective diameter, of the surface, on the image side, of the most image side aspherical lens is denoted by Ryr, Conditional Expression (8) is satisfied, which is represented by

$$0.2 < \vert ( 1 / Rcf - 1 / Rcr ) / ( 1 / Ryf - 1 / Ryr ) \vert < 4. \qquad ( 8 )$$

### Appendix 19

The imaging lens according to any one of Appendices 1 to 18, in which the number of focus lens groups included in the imaging lens is two, and in a case where a focal length of the focus lens group on the object side out of the two focus lens groups included in the imaging lens is denoted by ff1, and a focal length of the focus lens group on the image side out of the two focus lens groups included in the imaging lens is denoted by ff2, Conditional Expression (9) is satisfied, which is represented by

$$0.2 < \vert ff 1 / ff 2 \vert < 5. \qquad ( 9 )$$

### Appendix 20

The imaging lens according to any one of Appendices 1 to 19, in which, in a case where a combined focal length of all lenses closer to the image side than the focus lens group closest to the image side among the focus lens groups included in the imaging lens is denoted by ffR, Conditional Expression (10) is satisfied, which is represented by

$$- 1.5 < f / ffR < 1.5 . \qquad ( 10 )$$

### Appendix 21

An imaging apparatus comprising the imaging lens according to any one of Appendices 1 to 20.

What is claimed is:

1. An imaging lens consisting of, in order from an object side to an image side, a front group, an aperture stop, and a rear group,
wherein the rear group includes one or two focus lens groups that move along an optical axis during focusing,
a distance on the optical axis from a lens surface of the front group closest to the object side to an image plane is invariant during the focusing, and
in a case where a sum of a back focus of the imaging lens as an air conversion distance and a distance on the optical axis from the lens surface of the front group closest to the object side to a lens surface of the rear group closest to the image side in a state where an infinite distance object is in focus is denoted by TL,
a focal length of the imaging lens in the state where the infinite distance object is in focus is denoted by f,
a maximum half angle of view in the state where the infinite distance object is in focus is denoted by ωm,
an open F-number in the state where the infinite distance object is in focus is denoted by Fno, and
the back focus of the imaging lens as the air conversion distance in the state where the infinite distance object is in focus is denoted by Bf,
Conditional Expressions (1), (2), and (3) are satisfied, which are represented by
$$2.3 < TL / ( f \times tan ω m ) < 7 \qquad ( 1 )$$
$$1.15 < Fno / tan ω m < 3.5 \qquad ( 2 )$$
$$0.3 < Bf / ( f \times tan ω m ) < 1.5 . \qquad ( 3 )$$

2. The imaging lens according to claim 1,
wherein, in a case where a distance on the optical axis from the lens surface of the front group closest to the object side to the aperture stop in the state where the infinite distance object is in focus is denoted by dFSt,
Conditional Expression (4) is satisfied, which is represented by
$$0.43 < dFSt / TL < 0.75 . \qquad ( 4 )$$

3. The imaging lens according to claim 1,
wherein, in a case where a focal length of the front group in the state where the infinite distance object is in focus is denoted by fF, and
a focal length of the rear group in the state where the infinite distance object is in focus is denoted by fR,
Conditional Expression (5) is satisfied, which is represented by
$$- 2 < fR / fF < - 4. \qquad ( 5 )$$

4. The imaging lens according to claim 1,
wherein, in a case where a focal length of the front group in the state where the infinite distance object is in focus is denoted by fF,
Conditional Expression (6) is satisfied, which is represented by
$$- 1 < f / fF < 2. \qquad ( 6 )$$

5. The imaging lens according to claim 1,
wherein Conditional Expression (7) is satisfied, which is represented by
$$6 < ( TL \times Fno ) / ( f \times tan ω m ) < 11. \qquad ( 7 )$$

6. The imaging lens according to claim 1,
wherein the front group includes one focus lens group that moves along the optical axis during the focusing.

7. The imaging lens according to claim 1,
wherein the rear group includes two focus lens groups that move by changing a mutual spacing during the focusing.

8. The imaging lens according to claim 1,
wherein at least one lens that has a convex surface facing the object side in a paraxial region and that has an inflection point on a lens surface on the object side is disposed in the rear group.

9. The imaging lens according to claim 1,
wherein at least one lens that has a concave surface facing the object side in a paraxial region and that has an inflection point on a lens surface on the object side is disposed in the rear group.

10. The imaging lens according to claim 1,
wherein at least one lens that has a convex surface facing the image side in a paraxial region and that has an inflection point on a lens surface on the image side is disposed in the rear group.

11. The imaging lens according to claim 1,
wherein at least one lens that has a concave surface facing the image side in a paraxial region and that has an inflection point on a lens surface on the image side is disposed in the rear group.

12. The imaging lens according to claim 1,
wherein the imaging lens includes a three-piece cemented lens in which a first positive lens, a second positive lens, and a negative lens are cemented in this order.

13. The imaging lens according to claim 12,
wherein a surface of the second positive lens on a side closer to the first positive lens has a concave surface facing the side closer to the first positive lens.

14. The imaging lens according to claim 1,
wherein Conditional Expression (1-1) is satisfied, which is represented by
$$3.5 < TL / ( f \times tan ω m ) < 5.6 . \qquad ( 1 - 1 )$$

15. The imaging lens according to claim 1,
wherein Conditional Expression (2-1) is satisfied, which is represented by
$$1.3 < Fno / tan ω m < 2.7 . \qquad ( 2 - 1 )$$

16. The imaging lens according to claim 15,
wherein Conditional Expression (1-1) is satisfied, which is represented by
$$3.5 < TL / ( f \times tan ω m ) < 5.6 . \qquad ( 1 - 1 )$$

17. The imaging lens according to claim 16,
wherein Conditional Expression (7) is satisfied, which is represented by
$$6 < ( TL \times Fno ) / ( f \times tan ω m ) < 11. \qquad ( 7 )$$

18. The imaging lens according to claim 17,
wherein the imaging lens includes a three-piece cemented lens in which a first positive lens, a second positive lens, and a negative lens are cemented in this order.

19. The imaging lens according to claim 18,
wherein a surface of the second positive lens on a side closer to the first positive lens has a concave surface facing the side closer to the first positive lens.

20. The imaging lens according to claim 17,
wherein the front group includes one focus lens group that moves along the optical axis during the focusing.

21. The imaging lens according to claim 20,
wherein at least one lens that has a convex surface facing the object side in a paraxial region and that has an inflection point on a lens surface on the object side is disposed in the rear group.

22. The imaging lens according to claim 17,
wherein the rear group includes two focus lens groups that move by changing a mutual spacing during the focusing.

23. The imaging lens according to claim 22,
wherein at least one lens that has a convex surface facing the object side in a paraxial region and that has an inflection point on a lens surface on the object side is disposed in the rear group.

24. The imaging lens according to claim 17,
wherein at least one lens that has a concave surface facing the object side in a paraxial region and that has an inflection point on a lens surface on the object side is disposed in the rear group.

25. The imaging lens according to claim 17,
wherein Conditional Expression (1-2) is satisfied, which is represented by
$$4.4 < TL / ( f \times tan ω m ) < 5.2 . \qquad ( 1 - 2 )$$

26. The imaging lens according to claim 25,
wherein Conditional Expression (7-1) is satisfied, which is represented by
$$6.3 < ( TL \times Fno ) / ( f \times tan ω m ) < 9.5 . \qquad ( 7 - 1 )$$

27. The imaging lens according to claim 26,
wherein at least one lens that has a convex surface facing the image side in a paraxial region and that has an inflection on a lens surface on the image side is disposed in the rear group.

28. The imaging lens according to claim 17,
wherein at least one lens that has a concave surface facing the image side in a paraxial region and that has an inflection on a lens surface on the image side is disposed in the rear group.

29. The imaging lens according to claim 1,
wherein the rear group includes at least one aspherical lens, and
in a case where an aspherical lens closest to the image side among aspherical lenses included in the rear group is referred to as a most image side aspherical lens,
a paraxial curvature radius of a surface, on the object side, of the most image side aspherical lens is denoted by Rcf,
a curvature radius, at a position of a maximum effective diameter, of the surface, on the object side, of the most image side aspherical lens is denoted by Ryf,
a paraxial curvature radius of a surface, on the image side, of the most image side aspherical lens is denoted by Rcr, and
a curvature radius, at a position of a maximum effective diameter, of the surface, on the image side, of the most image side aspherical lens is denoted by Ryr,
Conditional Expression (8) is satisfied, which is represented by
$$0.2 < \vert ( 1 / Rcf - 1 / Rcr ) / ( 1 / Ryf - 1 / Ryr ) \vert < 4. \qquad ( 8 )$$

30. The imaging lens according to claim 1,
wherein the number of focus lens groups included in the imaging lens is two, and
in a case where a focal length of the focus lens group on the object side out of the two focus lens groups included in the imaging lens is denoted by ff1, and
a focal length of the focus lens group on the image side out of the two focus lens groups included in the imaging lens is denoted by ff2,
Conditional Expression (9) is satisfied, which is represented by
$$0.2 < \vert ff 1 / ff 2 \vert < 5. \qquad ( 9 )$$

31. The imaging lens according to claim 1,
wherein, in a case where a combined focal length of all lenses closer to the image side than the focus lens group closest to the image side among the focus lens groups included in the imaging lens is denoted by ffR,
Conditional Expression (10) is satisfied, which is represented by
$$- 1.5 < f / ffR < 1.5 . \qquad ( 10 )$$

32. An imaging apparatus comprising:
the imaging lens according to claim 1.
